(19) United States
(12) Patent Application Publication
(10) Pub. No.: US 2007/0285797 A1
(43) Pub. Date: Dec. 13, 2007

(54) IMAGING APPARATUS

(76) Inventor: Bridget Osetinsky, Everett, WA (US)

Correspondence Address: AXIOS LAW GROUP. PLLC, 1525 FOURTH AVENUE, SUITE 800, SEATTLE, WA, 98101, US

(21) Appl. No.: 11/680,469

(22) Filed: Feb. 28, 2007

Related U.S. Application Data
(60) Provisional application No. 60/767,051, filed on Feb. 28, 2006.

(51) Int. Cl. G02B 27/12; G02B 27/14

(52) U.S. Cl. 359/639; 359/618

(57) ABSTRACT

Various light converging methods and apparatuses for imaging, viewing and/or projecting images/radiation are shown and described herein.

### RELATED APPLICATIONS

This application is a non-provisional claiming the benefit of U.S. Provisional Patent Application No. 60/767,051, entitled IMAGING APPARATUS, with the named inventor Bridget Osetinsky, filed on Feb. 28, 2006, which is hereby incorporated in its entirety by reference.

### FIELD

The present invention generally relates to optics and more particularly, to converging light to a particular focal depth via reflection or refraction.

### BACKGROUND

New surgical techniques and equipment have revolutionized refractive eye surgery over the past decade. People who had been confined to vision by optical correction are achieving uncorrected visual acuities of 20/20. But while the successes of this procedure are far reaching, many complications develop during the healing of the epithelial layer.

Refractive surgery uses a laser to reshape the cornea. The cornea is able to heal faster when the reshaping of the cornea is performed below the surface layer. This is currently achieved by making an incision into the cornea, creating an epithelial flap. After performing the surgery at that depth, the epithelial flap is returned to promote healing of the cornea.

There are many drawbacks to this method. When a cut is made into the cornea the nerves to that entire section of the eye are severed. They do not begin to grow back for 1-3 months causing irritated dry eyes and decreased tear production. Additionally it is easier to cause a corneal abrasion post procedure when the patient has decreased nerve sensations to their cornea. More notably, the flap can heal with vision impairing scar tissue development. The flap can wrinkle or return misaligned causing a vision impairing complication. It is hard to create the flap in patients with deep set or small eyes because the machines rely on suction. The suction to form the flap is hazardous to glaucoma patients who cannot tolerate elevated eye pressure. As a result, glaucoma patients are often unable to receive refractive surgery.

In an endless attempt to improve the part of the procedure that is still contributing to refractive eye surgery complications, the IntraLase Corp. of Irvine, Calif. developed a laser method of forming the flap in the epithelial layer.

While laser incision can regulate uncertainty and minimize complications relating to a misshapen flap, both laser and knife incisions can excessively damage the cornea and heighten the possibility of scar tissue development and corneal haze. One solution would be to perform the surgery at the desired depth within the cornea without the incision and removal of the top layer for surgery.

By use of techniques and technologies described in this patent, a Controlled Convergence Laser could be created, allowing refractive surgeons to perform the procedure within the cornea without creating a flap. Such a method could open the procedure to glaucoma patients, better the results for people with deep set and small eyes, universally reduce complications relating to the flap creation and reduce healing time and the possibility for scar tissue development and dry eyes. In total the procedure will likely cause less harm to the eye and offer the surgeon greater control in performing the surgery than currently known methods.

Unlike the single focus lens-laser apparatuses currently utilized for eye surgery, a Controlled Convergence Laser would use a multi-focal lens. Through the use of a black and clear, concentric pixeled LCD, portions of the lens of varying strength can be chosen to vary the focal depth.

A Controlled Convergence Laser would enable refractive surgeons to perform surgery at the desired depth within the cornea without creating a flap by allowing ablation to occur at the depth of convergence as opposed to the surface of laser-corneal contact. The CCL, as it relies on a convergence to reach damaging intensity, reduces the collateral damage to the surrounding eye and reduces unwanted ocular side effects that can occur during the healing process.

### BRIEF DESCRIPTION OF THE DRAWINGS

FIG. 1 is an illustration of a single reflective convergent device, in accordance with one embodiment.

FIG. 2 is an illustration of spherical aberration, in accordance with one embodiment.

FIG. 3 is an illustration of a prolate spheroid converging mirror, in accordance with one embodiment.

FIG. 4 is an illustration of an oblate ellipsoid, in accordance with one embodiment.

FIG. 5 is an illustration of a frontal face of a slice of a spheroid, in accordance with one embodiment.

FIG. 6 is an illustration of a slant converging ellipsoid, in accordance with one embodiment.

FIG. 7 is an illustration of cylinders, cut perpendicularly and at an angle, in accordance with one embodiment.

FIG. 8 is an illustration of an angled ellipsoid reflective converging device, in accordance with one embodiment.

FIG. 9 is an illustration of the effects of rotating an ellipsoid, in accordance with one embodiment.

FIG. 10 is an illustration of an equipotential ring causing convergence at a particular point, in accordance with one embodiment.

FIG. 11 is an illustration of an equipotential ring causing stronger convergence at a particular point, in accordance with one embodiment.

FIG. 12 is an illustration in greater depth of the phenomenon described in FIG. 11, in accordance with one embodiment.

FIG. 13 is an illustration of conical convergence, in accordance with one embodiment.

FIG. 14 is an illustration of a series of equipotential rings causing convergence to different focal points, in accordance with one embodiment.

FIG. 15 is an illustration of an aperture used to isolate aspects of a reflecting surface, in accordance with one embodiment.

FIG. 16 is an illustration of an absorbent obstruction used to isolate aspects of a reflecting surface, in accordance with one embodiment.

FIG. 17 is an illustration of a travelling absorption cone used to isolate aspects of a reflecting surface, in accordance with one embodiment.

FIG. 18 is an illustration of an aperture built from reflective prismatic convergent devices, in accordance with one embodiment.

FIG. 19 is an illustration of total internal reflection in a prismatic convergent device, in accordance with one embodiment.

FIG. 20 is an illustration of a reflective convergent device composed of prisms, in accordance with one embodiment.

FIG. 21 is an illustration of refraction through a prism, in accordance with one embodiment.

FIG. 22 is an illustration of refraction through a prism when light enters and exits a prism perpendicularly to the prism faces, in accordance with one embodiment.

FIG. 23 is an illustration of a non-reflective tinting allowing for only perpendicular light to enter and exit a prism, in accordance with one embodiment.

FIG. 24 is an illustration of parallel light reflecting from a spheroid of prisms, in accordance with one embodiment.

FIG. 25 is an illustration of slant-approaching parallel light reflecting from an ellipsoid, in accordance with one embodiment.

FIG. 26 is an illustration of the term “beta,” used to refer to the rotation of the prism faces in an oblate ellipsoid, in accordance with one embodiment.

FIG. 27 is an illustration that alpha rotation is initially zero, in accordance with one embodiment.

FIG. 28 illustrates that the principal ellipsoid radius increases to maintain the desired surface area as an ellipsoid is rotated about its center, in accordance with one embodiment.

FIG. 29 is an illustration of a cylinder of light reflecting off a converging ellipsoid, rotated to theta m past the vertical axis, in accordance with one embodiment.

FIG. 30 is an illustration of a converging ellipsoid is rotated such that it is normal to the midline between the oncoming light and the desired convergence horizon, in accordance with one embodiment.

FIG. 31 is an illustration of slant incoming parallel light approaching symmetrically along the X axis, in accordance with one embodiment.

FIG. 32 is an illustration of incoming parallel light approaching non-symmetrically along the X axis an illustration of and Y axis, in accordance with one embodiment.

FIG. 33 is an illustration of a polarizing device used to manipulate convergence points, in accordance with one embodiment.

FIG. 34 illustrates that obstructing the reflective surface will isolate specific regions of the surface for reflection from a reflecting convergent device, in accordance with one embodiment.

FIG. 35 illustrates that oval equipotentials are not preserved in a ninety degree rotation, in accordance with one embodiment.

FIG. 36 is an illustration of a convergent device made with a symmetric face of circular equipotentials, in accordance with one embodiment.

FIG. 37 is an illustration of a polarizing filter wheel, in accordance with one embodiment.

FIG. 38 is an illustration of piecewise ring rotation, in accordance with one embodiment.

FIG. 39 illustrates how a double convex lens of a certain thickness can be formed with the curvatures of two overlapping spheres, in accordance with one embodiment.

FIG. 40a illustrates that double refraction causes parallel approaching light entering a lens to converge to a focal point, in accordance with one embodiment.

FIG. 40b is the represents the lensmaker's equation, in accordance with one embodiment.

FIG. 41a is an illustration of a thick ‘overlapping’ distance double convex lens, in accordance with one embodiment.

FIG. 41a is an illustration of a thin ‘overlapping’ distance double convex lens, in accordance with one embodiment.

FIG. 41 is an illustration of a color corrector that is the inverse of the shape of the converging lens, in accordance with one embodiment.

FIG. 41 is an illustration of a thinner color corrector used for a spherical lens with a distant focus, in accordance with one embodiment.

FIG. 42 is an illustration of a spherical lens causing spherical aberration, in accordance with one embodiment.

FIG. 43 is an illustration of a prolate spheroid, which corrects spherical aberration, in accordance with one embodiment.

FIG. 44 is an illustration of a double convex prolate spheroid, in accordance with one embodiment.

FIG. 45 is an illustration of an ellipse rotated about its minor axis to form an oblate spheroid, in accordance with one embodiment.

FIG. 46 is an illustration of a double convex oblate spheroid lens, in accordance with one embodiment.

FIG. 47 is an illustration of a double convex oblate spheroid lens causing a continuous line of convergence, in accordance with one embodiment.

FIG. 48 is an illustration of a simple way to manipulate the oblate convex lens, in accordance with one embodiment.

FIG. 49 is an illustration of a double concave oblate spheroid used as a color corrector, in accordance with one embodiment.

FIG. 50 is an illustration of light symmetrically reflected into refractive convergent devices arranged on a plane, in accordance with one embodiment.

FIG. 51 is an illustration of symmetric faces with correcting plates, in accordance with one embodiment.

FIG. 52 is an illustration of one centrally located source at the bottom from behind prospective images, where the vertical path redirection has already been accounted for, in accordance with one embodiment.

FIG. 53 is an illustration of an illusion of a light mixture (blended by the eye) in a region of two- dimensional space, in accordance with one embodiment.

FIG. 54 is an illustration of an illusion of a light mixture (blended by the eye) in a region of three-dimensional space, in accordance with one embodiment.

FIG. 55 is an illustration of a laser triplet reflected off of an ellipsoidal converging mirror to illuminate a colored convergence point, in accordance with one embodiment.

FIG. 56 is an illustration of color produced by a ratio of red, green, and blue, in accordance with one embodiment.

FIG. 57 is an illustration of intensity increasing and decreasing along the axis between white and black, in accordance with one embodiment.

FIG. 58 illustrates that black and white pictures can be composed by combining colors, as by laser light reflected from an ellipsoidal converging mirror, in accordance with one embodiment.

FIG. 59 is an illustration of concert haze reflecting a light beam into the eyes of spectators, in accordance with one embodiment.

FIG. 60 is an illustration of a screen of convergent devices placed on a horizontal axis, in accordance with one embodiment.

FIG. 61 illustrates that excited electrons can emit frequency-dependent colored light, in accordance with one embodiment.

FIG. 62 is an illustration of a possible screen formation, in accordance with one embodiment.

FIG. 63 is an illustration of any laser triplets bedded together and used as potential source, in accordance with one embodiment.

FIG. 64 is an illustration of light reflected from an ellipsoidal converging mirror to a focal point determined by the position of the absorption cone, in accordance with one embodiment.

FIG. 65 illustrates that a convergence device can run cyclically, creating different focal points at different points in time, in accordance with one embodiment.

FIG. 66 is an illustration of an Eiffel Planar multi-focal lens, in accordance with one embodiment.

FIG. 67 is an illustration of a double cone multi-focal lens, in accordance with one embodiment.

FIGS. 68a-y show multiple sources, converging apparatuses, arbitrators, dispersion apparatuses and other tools used in various combinations, in accordance with various embodiments.

FIG. 69 is an illustration of parallax created by subtracting two images made by cameras in different positions, in accordance with one embodiment.

FIG. 70 is an illustration of an Eidophor System (prior art).

FIG. 71 is an illustration of a stereoscopic projection system using polarized glasses (prior art).

FIG. 72 is an illustration of an LCD used to isolate convergence points, in accordance with one embodiment.

FIG. 73 is an illustration of a source reflected by a convex mirror to enter the optical device from different angles to create convergence points throughout the X-Y axis, in accordance with one embodiment.

FIG. 74 is an illustration of an optical device outfitted with small, closely spaced holes so that it can handle high energy waves, in accordance with one embodiment.

FIG. 75 is an illustration of a multi-focal converging apparatuses used to converge sources from various depths to the same plane, in accordance with one embodiment.

FIG. 76 is an illustration of a cone causing multiple convergence points, in accordance with one embodiment.

FIG. 77 is an illustration of a wide-open cone causing multiple convergence points further away, in accordance with one embodiment.

FIG. 78 is an illustration of a cone angled to reflect slant incoming light, in accordance with one embodiment.

FIG. 79 is an illustration of a cone producing a uniform distribution of the convergence points, in accordance with one embodiment.

FIG. 80 is an illustration of a convex closed funnel causing multiple convergence points, in accordance with one embodiment.

FIG. 81 is an illustration of a controlled convergence laser apparatus used for refractive eye surgery, in accordance with one embodiment.

FIG. 82 is an illustration of a rotated diamond lens with a small a, in accordance with one embodiment.

FIG. 83 is an illustration of a rotated diamond lens with a large a, in accordance with one embodiment.

### DESCRIPTION

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined without limiting the scope to the embodiments disclosed herein.

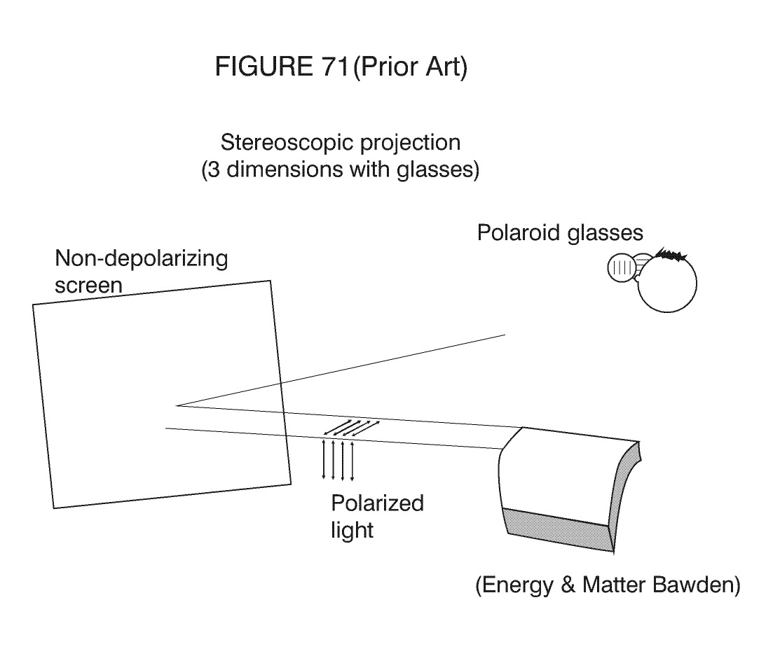

The human brain processes image depth as the total relation of light order as it enters each eye. Assuming light speed is constant in an open medium, light reflecting from a near object will be significantly closer to one eye and have proportionality much further to travel to the other, than light from a distant object, which must travel relatively the same distance to each eye, closer to the left or right by only a very slight bit. The order in which composite light is received dictates the depth structures we understand. This is parallax, the mechanism behind three dimensionality illustrated in FIG. 71 (prior art), previously recreated by the use of polarized light projection 7110a, 710b and Polaroid glasses 7105, which limited the information each eye could receive. While this does produce images that the brain interprets to be three dimensional, the glasses, a component necessary to isolate the two different stems of information 7110a, 7110b which give the depth dimension to those models, are cumbersome and very rarely of the quality that can produce the sort of imaging depth that occurs in life. Newer techniques of regulated shutter systems in development also produce images that have been termed three dimensional (“3D”). They still typically lack life like quality in that they are comparable to images in the mirror. The eye will respond with the image according to parallax but, because it is not a real image, viewers are more likely to experience motion sickness. It is also incapable of creating complete profiles for the viewer that can change according to angle perception as the viewer moves across the room because the image is inlaid within, or virtually behind the screen. A third option is being conceived using a series of holograms, which would produce three dimensional images. This option is problematic because holographic images are currently solely monochromatic and production of a number of images would be exceedingly expensive. These methods lack a real convergence of light; as a result, in addition to appearing less realistic, virtual images are also not able to interact with other mediums for such purposes as heating and ablation.

There is an alternate way to create images coded in three special dimensions. The process centers on the variability of convergence points to the desired level of depth. The variability is made possible by manipulating the usable surface of an oblate ellipsoidal convergent device. The oblate ellipsoid emphasizes rather than reduces spherical aberration, to the point that a reflective convergent device in the shape of an oblate ellipsoid 610 and a refractive convergent device in the shape of a double convex ellipsoid 4605 will cause a line of convergence referred to hereafter as the convergence horizon 305. By altering the usable surface area of the convergent device, particular points of focus can be chosen from the line of focus. The manipulatable object generates points or a point of convergence that can be made at variable points of depth chosen by isolating portions of the converging apparatus that will create the desired focal points. If this convergence is to be visible, it will rely on a specific interaction with a final medium.

The alterability of convergence by various methods of controlling the usable surface of the convergence apparatus or usable sections of light, to dictate points of depth in a medium with an electromagnetic wave can be used for creating images in the three spatial dimensions for television, computers, medical research, architecture, prototype modeling, scientific uses, decoration, governmental, and otherwise unmentioned. It can also be used directly interacting with another medium, i.e. laser ablation at a prescribed depth for eye surgery. It will be discussed how this technique produces images, however the technique can also be used as a source of luminescence, a precision cutting tool, and for constructing light saber toys. So the usage extends to all devices capable of creating variable points of convergence for several purposes and specifically for the purpose of producing images in the three dimensions of space.

With regard to various embodiment, below is described how a conical convergence to a specific point in a medium will dictate a real image with depth, and furthermore, that it is one method of producing a three dimensional picture. Several new points, from the several old, will allow the picture to move, and it is a picture made of real images with profiles. These can be in color or not, by preference.

The methods allow the light to meet different surfaces, which causes incoming light to reflect to specific convergence points 120 in the appropriate mediums. Conical like convergence of light, contracting as a result of transmission through specifically shaped second mediums is also discussed, like the converging behavior of a lens. To see the specific points of light convergence 120 the light must be reflected to our eye or emit diffusely from that depth. This happens if the waves finally converge in a medium causing phosphorescence or reflective interaction. Light sources, screen, and medium possibilities will be detailed, as will various ways of real and non-real surface alteration that isolate particular equipotentials for conical-like convergence. The collection of convergent light points summates to a visible image when it appropriately interacts with a phosphorescent or reflective viewing medium. Changes made in where the light converges to results in changes in the various, particular depths of light convergence, which, in essence, summates to a new picture. Mobility to change the depth, in addition to variable X and Y coordinates, is the concept of real, moving images in three-space. When all useful energies of the given electromagnetic wave are made available to the convergent devices comprising some screen, (such as that of red blue and green, but in actuality these may be medium specific) the images can be produced and associated with color.

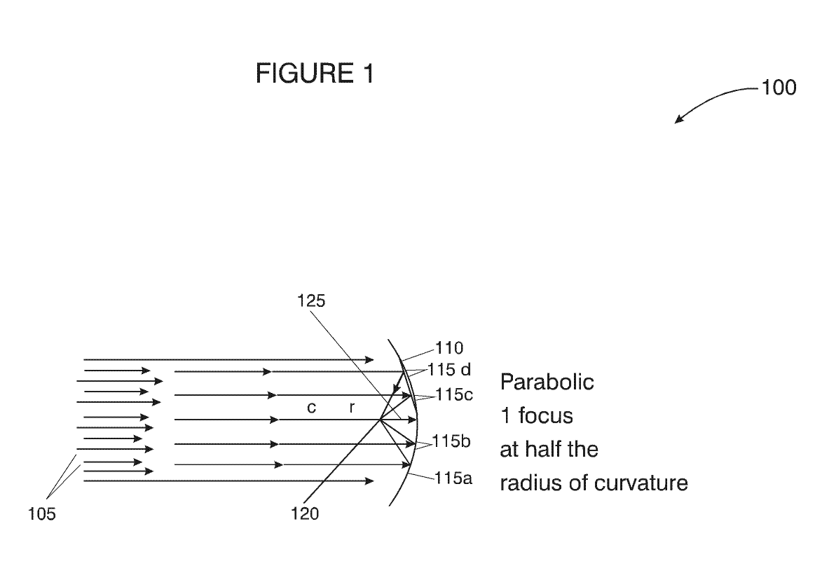

FIG. 1 illustrates a single reflective convergent device. In alternative embodiments, there could be a screen of these devices. In optics, parallel light 105 reflected from a parabolic converging mirror 110 has one convergence point 120 at half the radius of curvature. The radius of curvature is found by extending a line from the middle of the mirror to the center of curvature 125. The angle of incidence 115 is the same as the angle of refraction 115 at every reflecting interface as a property of light reflection.

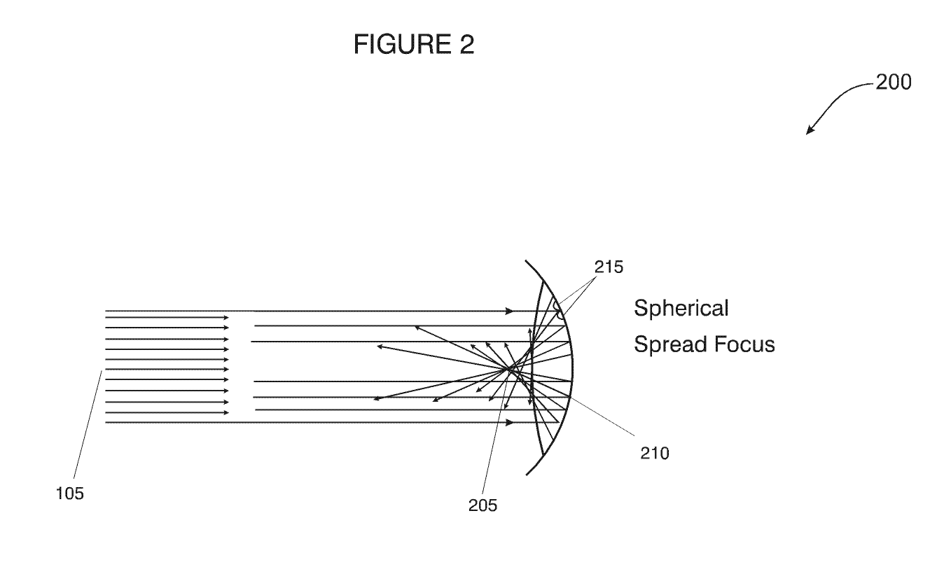

In FIG. 2, incoming parallel light 105 reflected from a spherical converging mirror 210 has a longitudinal spread focus known as spherical aberration 205. The angles of incidence and refraction 215 are similar to 115.

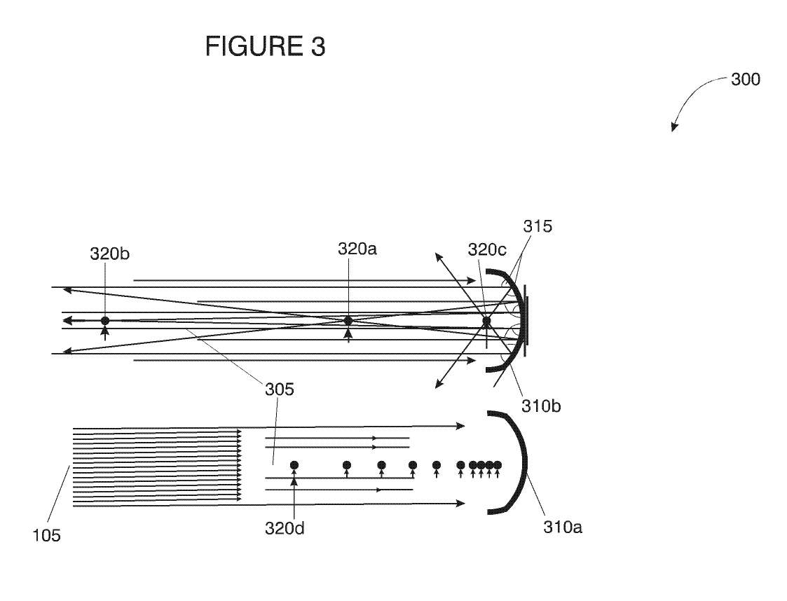

Likewise, as shown in FIG. 3, if parallel light 105 is reflected from an ellipsoid, or in this symmetric case, prolate spheroid converging mirror 310a, 310b, it 310 converges to a line of continuous focus 305, characterized by a series of focal points 320a-c at different distances. The line of continuous focus will be referred to as the horizon of convergence, or simply, horizon 305. The angles of incidence and refraction 315 are similar to 115.

Because spherical reflecting surfaces have aberration, parabolic shaped surfaces were adopted in astronomy and the like to clarify the focus point. Conversely, to enunciate and further isolate distinct portions and points of focus, an ovular shape known as a oblate ellipsoid, collapsed rather than elongated along the incoming axis, causes light to converge to points depending on the particular region along the surface from which the light was reflected.

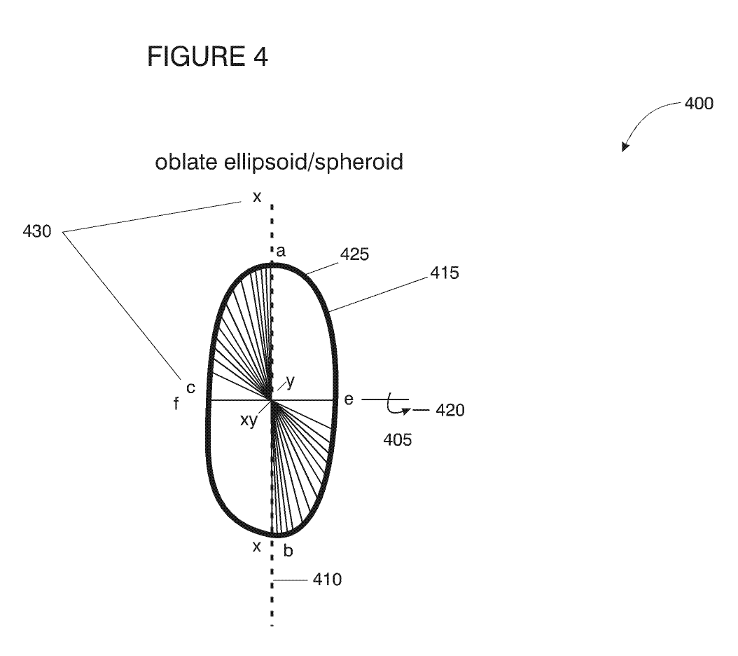

FIG. 4 shows that ellipsoids 425 (similar to 310) are intentionally composed of many, varying radii 405 in the X-Z plane 430. An oblate ellipsoid is created by rotating an ellipse 415 about its minor axis 420, as opposed to its major axis 410. If the incoming light is normal to the plane of the reflecting surface, a spheroid (an ellipsoid in which two sides are the same) will allow incoming light symmetry via the Z axis.

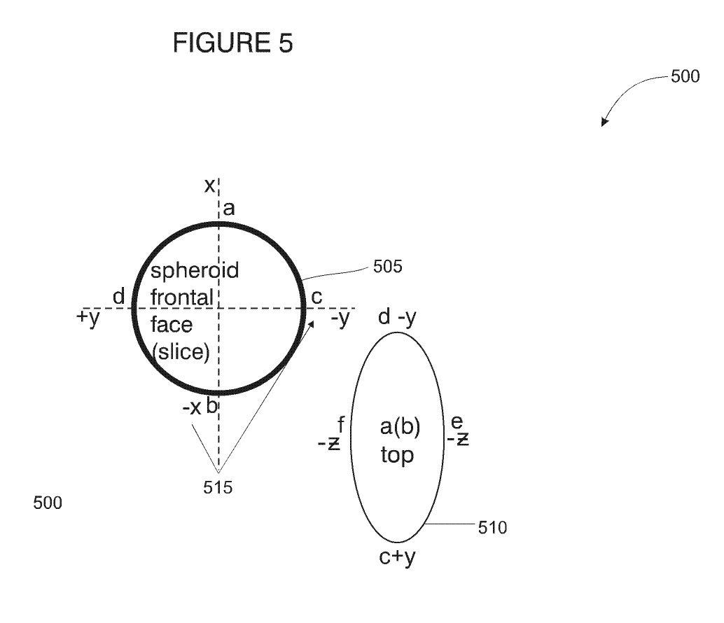

FIG. 5 shows that the frontal face of a slice, or of the entire spheroid, makes a circle 505 in the X-Y plane 515 (similar to 410), much like a tire. The top view of a full spheroid makes an oval, extending long in the X directions and shorter in the Z 510 (similar to 415). Unaided, is not the likely setup if the images are to be viewed. The light would either need to be reflected into Z axis symmetry with the convergence causing device, or it will enter the convergence causing device at an angle.

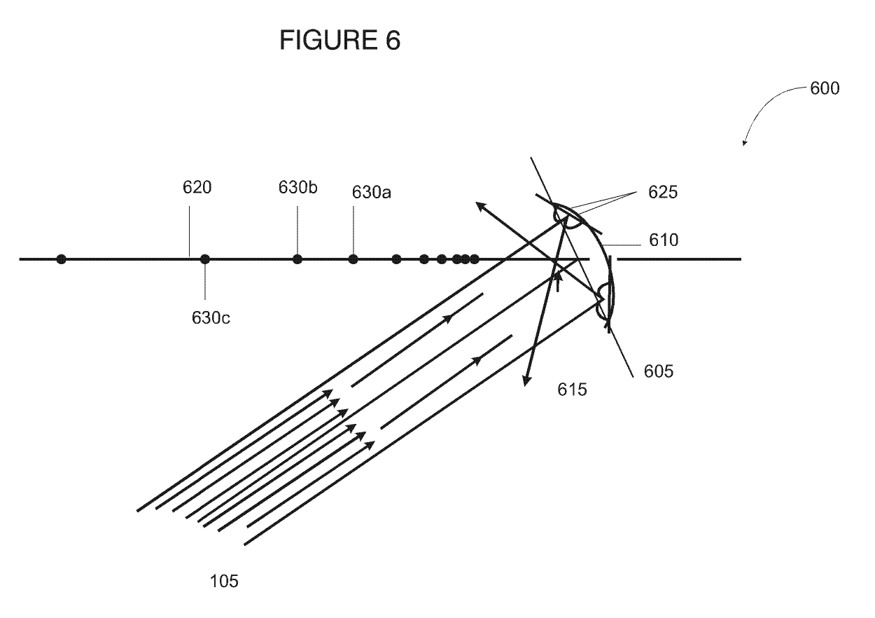

In FIG. 6, incoming light 105 that is not on the same plane as the focal horizon 620 (similar to 305) will be termed slant incoming light, though the light within the slant is still assumed to be traveling parallel to each other. A converging ellipsoid 610 is now the shape that will focus the whole of the incoming light to a line of continuous focal points 630a-c (similar to 120) along the horizon 620 because the ellipsoid, unlike the spheroid, has an oval face 615. The axis of the converging ellipsoid mirror 605 will prove to be normal to the mid-line between the focal horizon 620 and incoming light 105. The angles of incidence and refraction 625 are similar to 115.

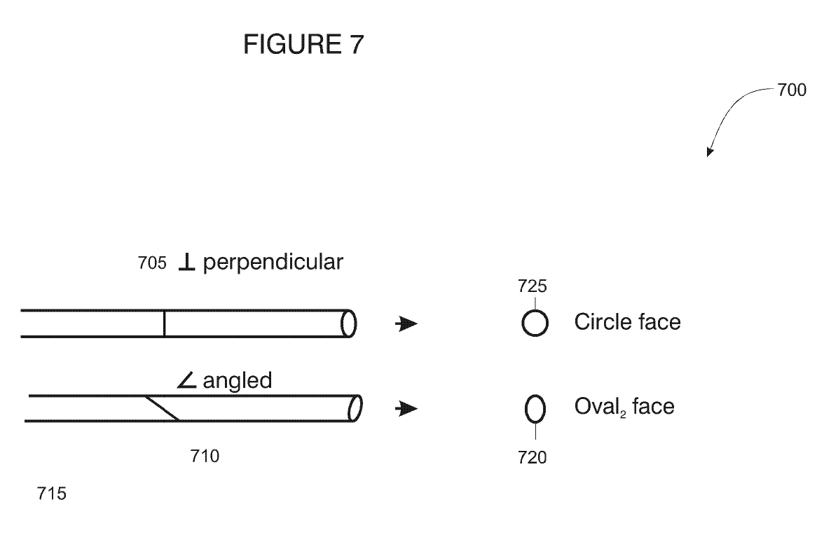

In FIG. 7 when a cylinder 715 is cut perpendicularly 705, as the interrupted incoming light roughly models, the opened face is a circle 725, but when it is cut at an angle 710, the face is an oval 720.

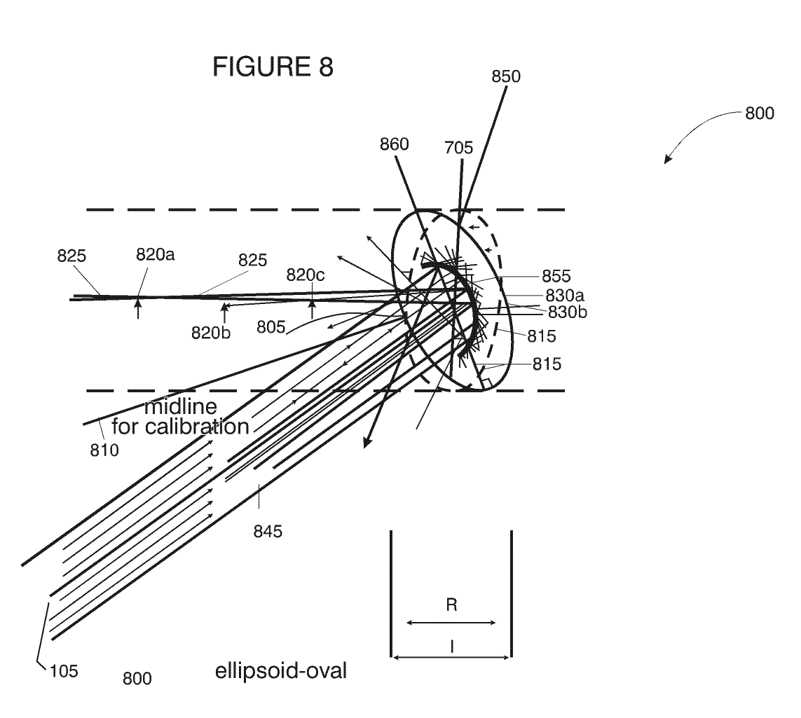

Illustrated in FIG. 8, when the cylinder of incoming light 845 is on a different plane than the desired convergence horizon 825 (similar to 305) the convergent device can no longer be perpendicular 705 to the horizon, but must face the mid-line 810, between the horizon 825 and incoming light 105, to reflect the light (the angles of incidence and refraction 855 are similar to 115) such that all convergence points 820a-c (similar to 120) lie along the horizon 825. A device which is normal to the midline 810 is no longer normal to the oncoming light 105; hence the light cylinder 845 will the interrupted at an angle 860, opening an oval face 840 (similar to 615). The oval faced ellipsoid 830 can properly receive and reflect slant incoming light 105. (The face appearing from the top is a circle 850.) The angle made, as an imaginary line is drawn through the center of the incoming light 105 to the center most point on the converging device, the point on a parallel to the plane of the device 815 (similar to 310), and back along the mid line 810 is theta m 805, the mid-point angle theta.

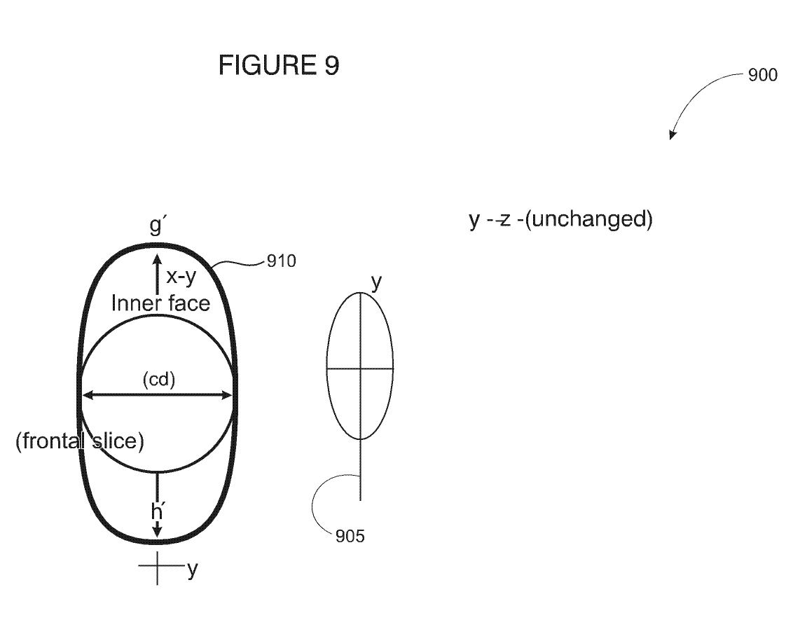

FIG. 9 shows both the inner face 910 (similar to 615) and top view 905 change in accordance with the degree of theta m; the greater the theta m value is, the more ovular the frontal face 910 will be, while the top view 905 will lean towards appearing more circular depending on the Y and Z relationship.

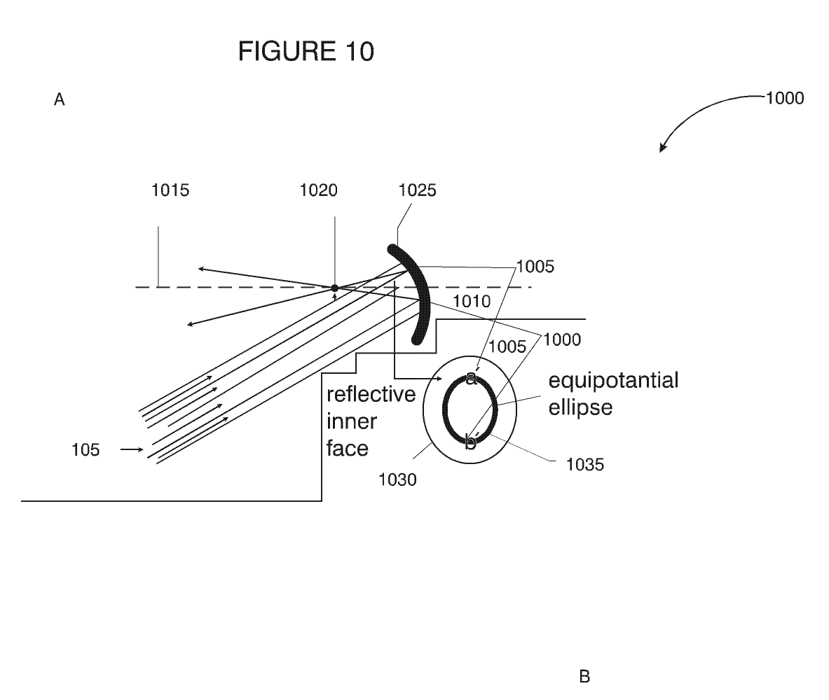

IN FIG. 10, equipotential rings 1035 (similar to 1105) comprise the surface of a reflecting convergent device 1025 (similar to 610). An equipotential ring 1035, in this instance states that all light reflecting from the same ring will converge to the same point on the convergence horizon 1015 (similar to 305). In the case of slant incoming light 105, the equipotential rings 1035 will be ovals 1030 (similar to 615). FIG. 10 shows that any two points, A 1005 and B 1010, along the equipotential ring 1035 will cause convergence at that ring's particular convergence point 1020 (similar to 120).

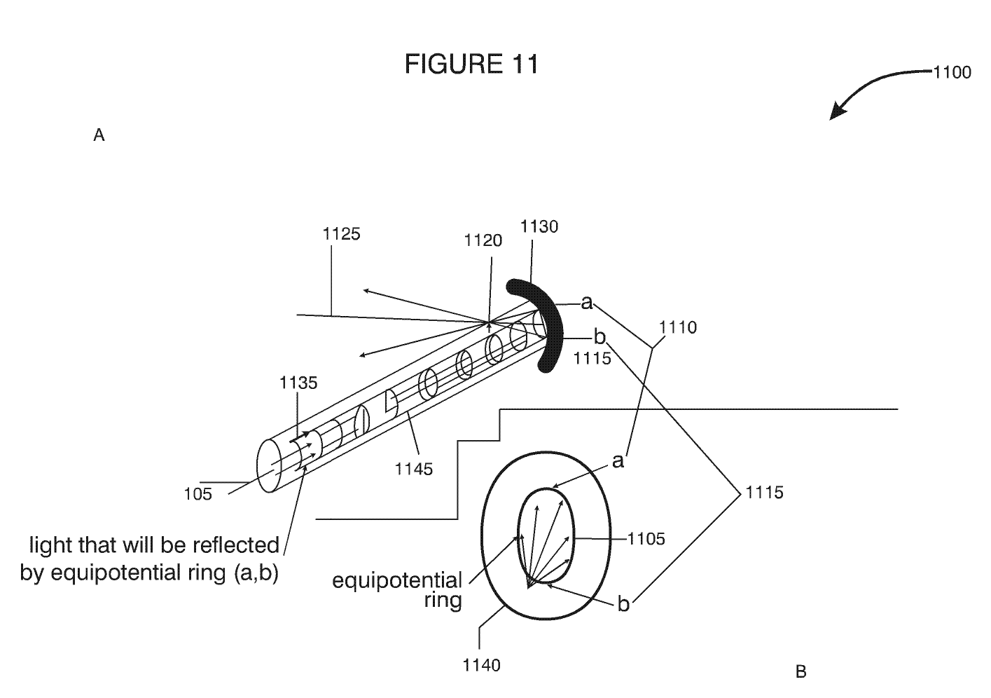

In FIG. 11, A converging ellipsoid 1130 (similar to 610) with an oval face 1140 (similar to 615) focuses the incoming light 105, approximated as a cylinder 1145 of particular radius “r,” corresponding to the equipotential ring 1105 containing “a” 1110 (similar to 1005) and “b” 1115 (similar to 1010), which will reflect a portion 1135 of the incoming light 105. A stronger convergence point 1120 (similar to 120) is made when more of the original incoming light 105 source converges into focus, or in this case, when light is reflected from every point along the equipotential 1105, to converge conically 1205 to the single point of convergence located on the horizon 1125 (similar to 305).

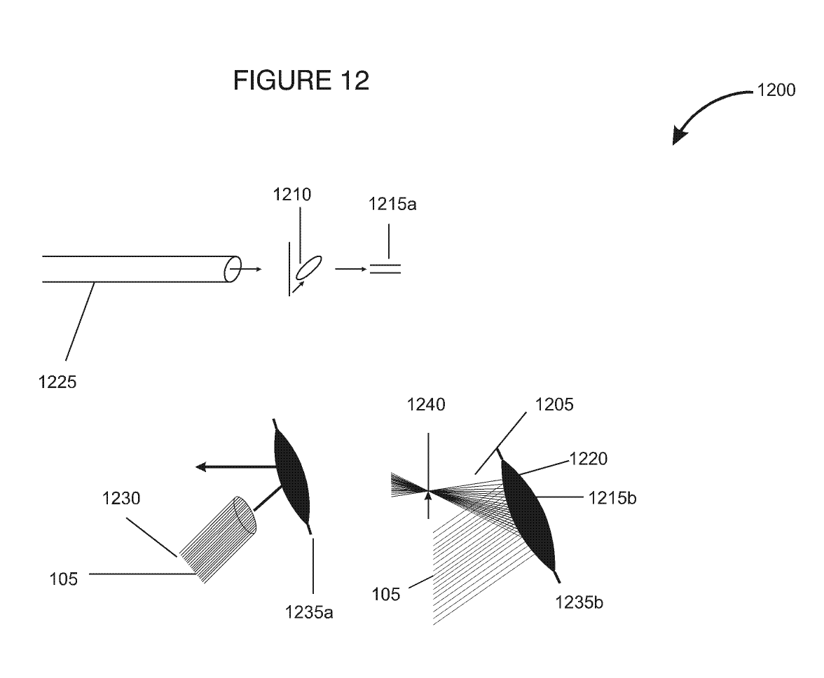

Shown in more detail in FIG. 12, when a cylinder of light 1225 (similar to 715) is reflected off of a slant surface plane 1210, an oval-cylinder 1215a is returned, extended along the plane of interaction 1235a- b (similar to 605). The oval-cylinder 1215a now travels a path according to incidence/reflection laws. When the light cylinder 1230 (similar to 715) is instead reflected off an equipotential ring 1220, comprised of angles to reflect the light to a convergence point as opposed to the reflection from a single slant plane, immediately after reflection, the oval-cylinder 1215b converges in a conical way 1205 towards a single convergence point 1240 (similar to 1206).

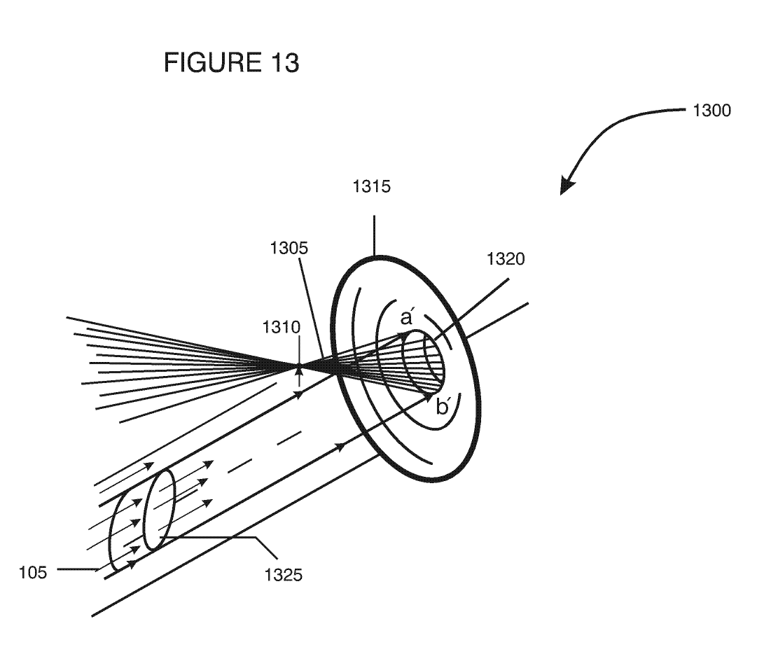

Shown in FIG. 13, if many, even all, points along the equipotential ring 1320 (similar to 1105) are allowed to be reflected and participate in conical convergence 1305, an intense convergence point 1310 is created from a single source and reflecting surface. An approaching cylinder 1325 (similar to 715) of incoming parallel light 105 will reflect conically 1305 from its equipotential 1320 component of the face of a converging ellipsoid mirror 1315 (similar to 610) to its convergence point 1310 (similar to 120).

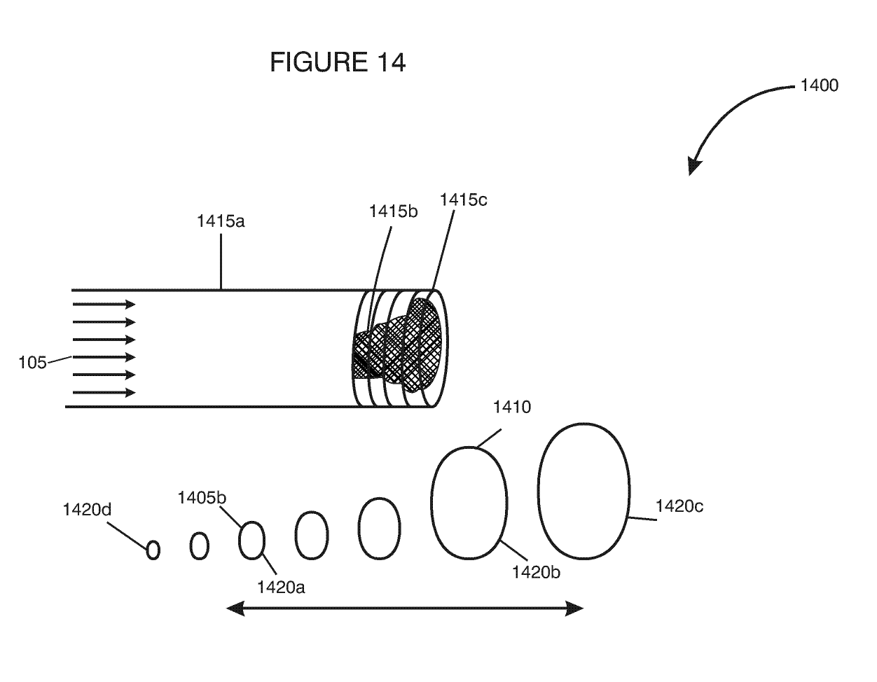

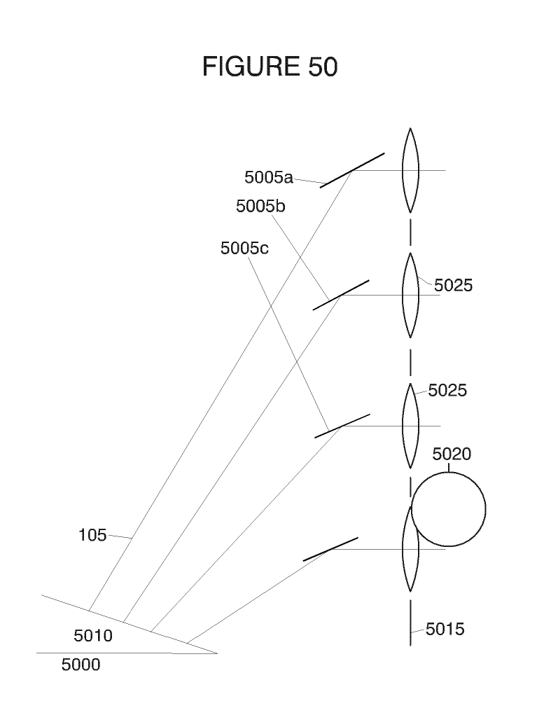

Shown in FIG. 14, there are a number of methods that will isolate the surface so that only the desired equipotential 1420 components of the original light cylinder 1415 (similar to 715) reflect. The small, inner equipotential rings 1420a (similar to 715), 1405, nearly parallel to the mid-plane can converge at a point very distant from the surface (nearer to the viewer, if this is a component of a back screen). If only the larger- extremity 1420b (similar to 715), equipotential rings 1410, nearly perpendicular to the mid-plane were to allow light reflection, convergence would fall very near the surface (further from the viewer if the screen were positioned vertically as the back 5015 as pictured in FIG. 50).

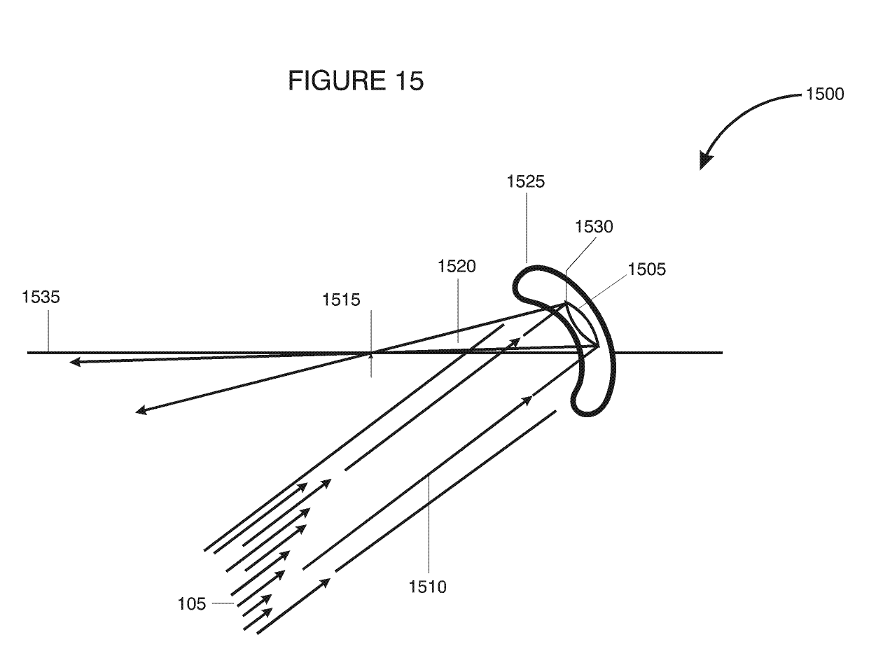

FIG. 15 shows that slant, parallel incoming light 105, approaching a converging ellipsoid mirror 1525 (similar to 610) angled between the convergence horizon 305 and the incoming light cylinder 1510 (similar to 715), can be separated so that only a unique equipotential or set of equipotential rings 1530 (similar to 1105), are reflected into elliptic-conical convergence 1520 to their respective points 1515 (similar to 120) by a method of aperture 1505. Any method of creating an aperture 1505 can isolate aspects of the reflecting surface. The remainder then converges at a particular depth dictated by the size of the aperture 1505.

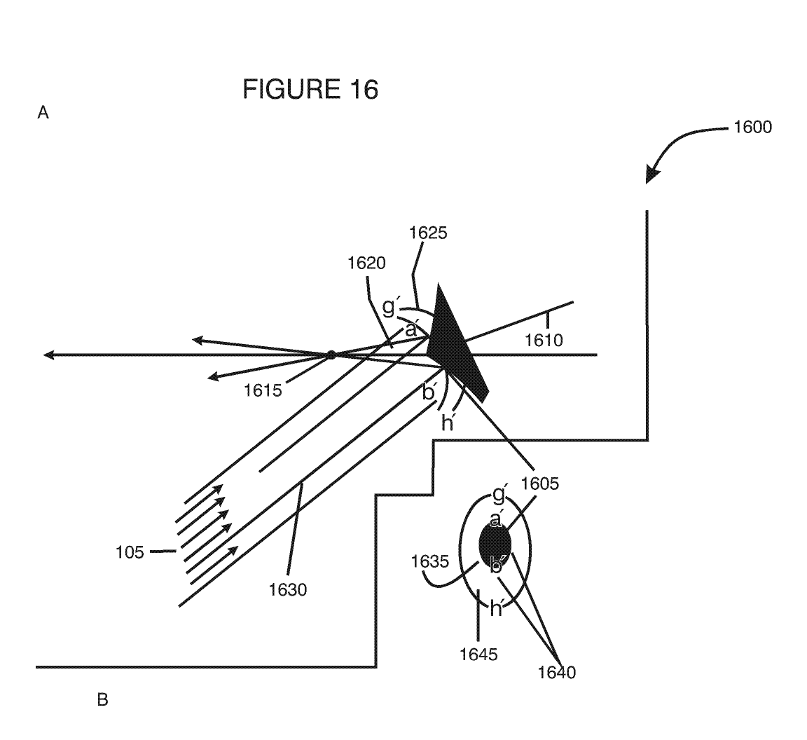

FIG. 16 shows how a method of obstruction 1605 (absorbing light that is not to be reflected) will also cause conic convergence 1620 (similar to 1205) from only particular aspects of the surface. When the surface is obstructed 1605 along equipotentials 1635 it eliminates the light that would converge at a further depth, leaving behind a light cylinder 1630 that converges 1620 to particular depths. Even if the surface is not broken along an equipotential, the fact remains that surface equipotentials 1635 (similar to 1410) cause convergence 1620 to various particular points 120. Only when two points 1640 on the same equipotential 1635 exist will a convergence 1620 begin to be noticed. The convergence 1620 becomes stronger as light is reflected from more complete equipotentials 1635 or as the intensity of the oncoming light is increased. Slant, parallel, incoming light 105, approaching a converging ellipsoid mirror 1625, can be separated by a method of light obstruction 1605 which interrupts the reflective surface of a converging ellipsoid mirror 1625. In the instance of slant, incoming light 105, the obstructer travels 1610 into the surface of the converging device along the midline. It creates a region of light absorption 1605 out of the reflective face 1645 of the converging device. The light absorption boundary can be an equipotential 1635 of the converging devices surface.

A large equipotential obstructing region of light absorption 1605, (e.g., as shown in FIG. 16) whose motion is directed along the midline, will reflect from the remaining surface to a convergence point 1615 near the face of the convergent device.

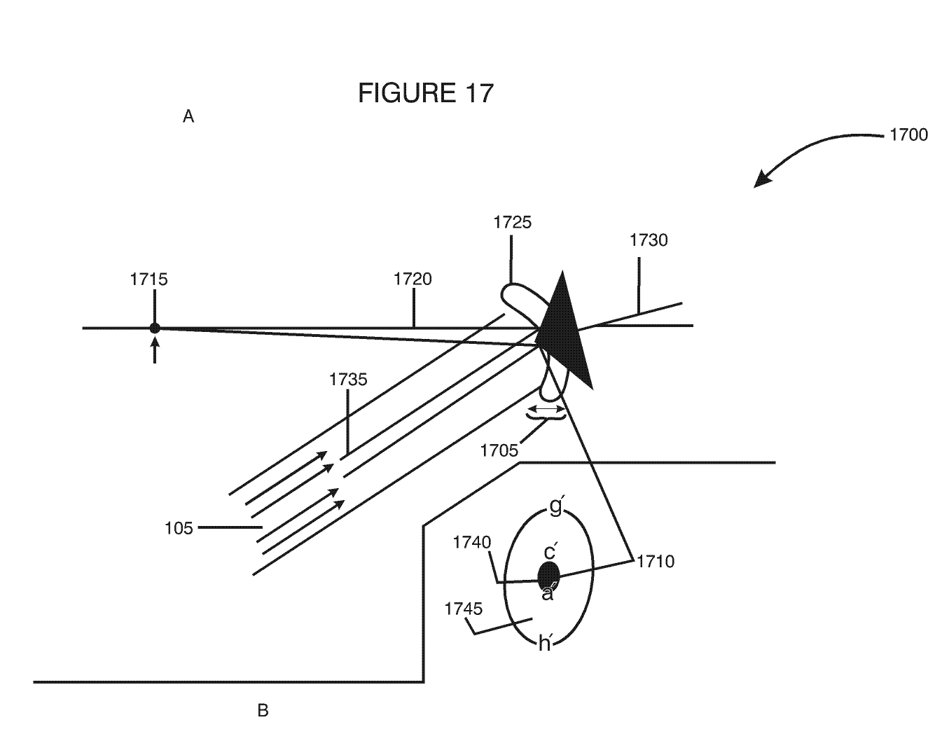

In FIG. 17, the absorption cone can travel 1730 (similar to 1610) throughout a range 1705, creating an oval 1745 (similar to 615) equipotential ring 1740 (similar to 1105) of varying size. If only a small obstructing region of light absorption 1710 (similar to 1605) is made, absorbing only the innermost equipotential fraction of the light cylinder 1735 (similar to 715), then the focal point 1715 (similar to 120) of the conic convergence 1720 (similar to 1205) reflecting off of the converging ellipsoid 1725 (similar to 610) will be further from the reflecting face.

One distinction between aperture and obstruction is the function of light transmission verses light absorption. In the first case transmitted, non-reflected light is still available for further use in its immediate form, albeit on the opposite side of the original screen, but the light has been absorbed in the second.

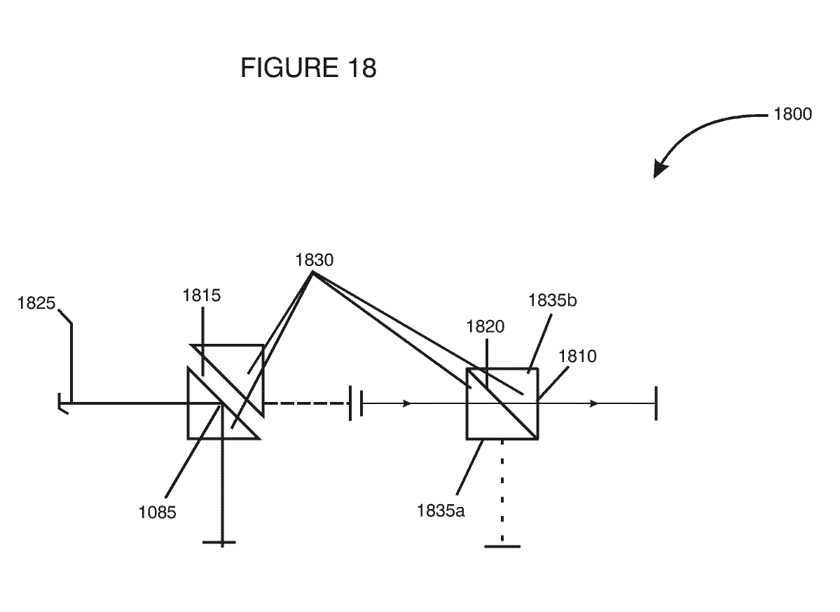

As shown in FIG. 18, to build an aperture from a reflective prismatic convergent device, limit the spacing 1815 between the pairs of straight edged prisms 1830 that are to be components of the aperture, so that they may transmit 1810 rather than reflect 1805 light at the prism interface 1820. When the photon is in the medium 1835a of the prism 1830, the scenario can be approximated like a finite square well. The consequence of this scenario is tunneling, a certain probability that the photon's location will leak outside of the prism walls 1820. A second prism medium 1835b, new or the same, needs to be set up appropriately near the first for it to be worthwhile for the photon's energy in the first medium 1835a to gap the two mediums with considerable probability, light, or an electron, to be detected to transmit 1810 through the mediums. Conversely, when the second medium 1835b is spread 1815 to a distance where bridging the two is unlikely, reflection 1805 is detected.

When an electromagnetic wave 1825 is sent through the perpendicular face of the first prism 1830 towards the second, it will either reflect off 1805 the back wall or be transmitted 1820 through the second prism 1830 as a function of the prism material 1835, the spacing gap 1815, and the energy of the wave. For simplicity, two prisms 1830 of the same medium 1835 are being discussed. It is assumed that this medium 1835 allows the transmittance separation 1815 to be very small. There are several possible mediums.

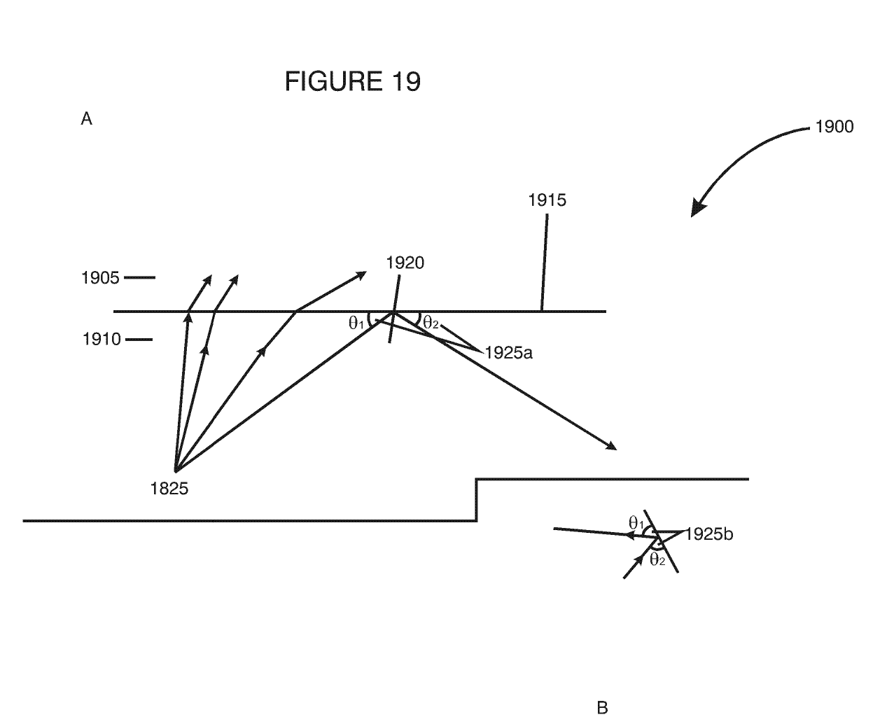

FIG. 19 demonstrates total internal reflection. The reflection 1920 (similar to 1805) of the electromagnetic wave 1825 at the prism interface 1915 (similar to 1820), when the two prisms are appropriately spread to support reflection 1920 from the barrier of this medium 1910 and its surrounding 1905, there is a total internal reflection 1920, which obeys incidence and refraction equality laws 1925 (similar to 1115).

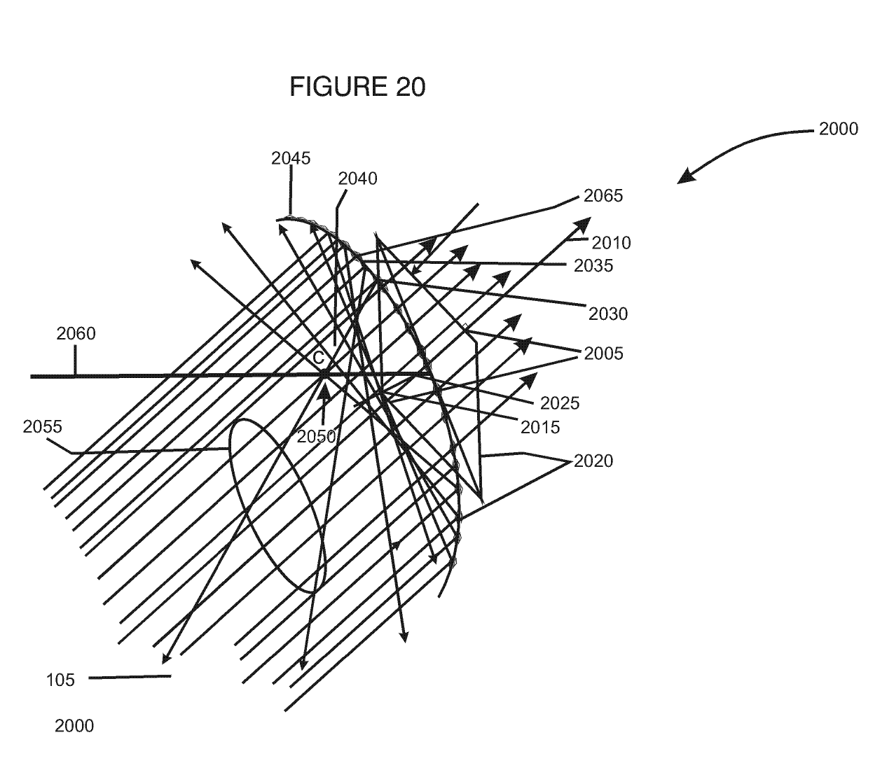

FIG. 20 is one exemplary embodiment of a reflective convergent device comprised of prisms, which have been exaggerated in the figure to emphasize angles. In order that the light reflection 2065 by the prisms is convergent to points 120 along the convergence horizon 305, the reflecting interface 2035 (similar to 1820) between the prisms forms the converging equipotentials that together form an ellipsoid 2045 (similar to 610). The reflective prism ellipsoid 2045 is still angled at the mid-line 2015 in the case of unaided slant, light approach 105. Light perpendicular to face of the prism 2005 is reflected at an angle theta m 2025 (similar to 805). A number of prism pairs 2020 (similar to 1830) arranged as an ellipsoid 2045, is fully reflective 2065 (similar to 1805) when every prism pair is spaced 2030 (similar to 1815), and transitive 2010 when they are near. The transmitted 2010 verses reflected 2065 light again, isolates equipotential regions for particular convergence from a potentially wholly reflective surface, the same as other aperture methods. If conic convergence 2040 (similar to 1205) is desired not beyond point c 2050, the entire light cylinder 2055 (similar to 715) spanning from a to b gets transmitted 2010 (similar to 1810) at the prism made ellipsoid 2045, and only those prisms 2020 comprising exterior equipotentials will be close enough to allow light reflection 2065.

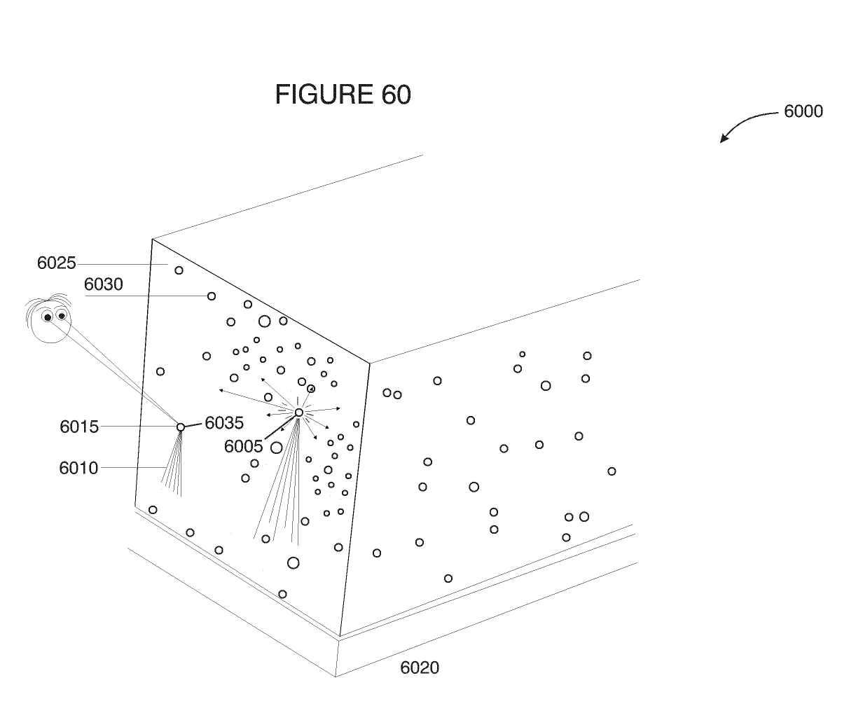

The potential benefit to a reflective convergent device made of prisms is that the straight edged prisms might be easier to produce although there are many prism pairs per convergent device. The second benefit to prisms is the ease with which the surface dictates a single equipotential region and nothing beyond, and is even able to choose multiple equipotential rings for poly-select convergence. This is especially useful when the screen of convergent devices 6020 is placed on a horizontal axis, a case demonstrated in FIG. 60. Considering a common picture, it is very often that some image like a dog and a bird might coexist at different points along the same vertical axis, necessitating at least two distinct convergence points.

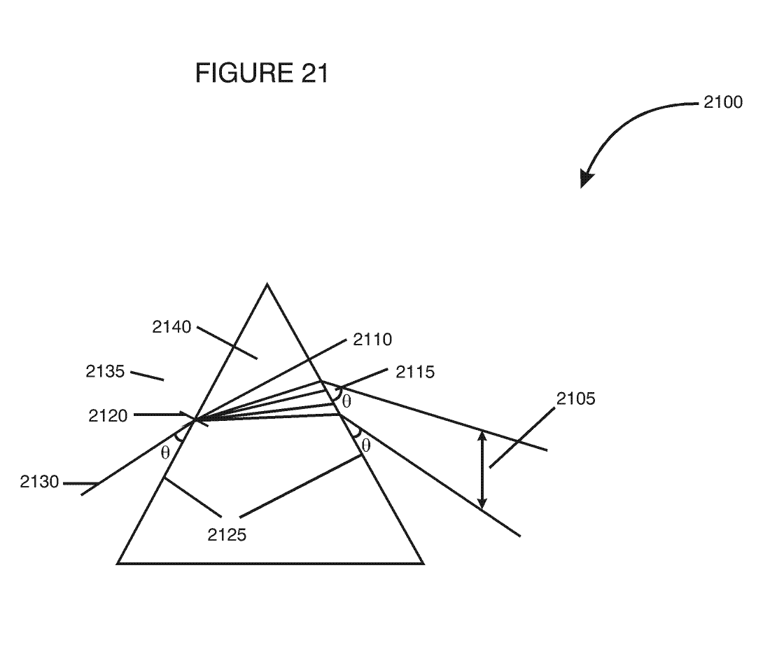

When an oncoming light source 2130 travels from one medium 2135 into another 2140, it is refracted, as shown by FIG. 21. If light could travel faster in the first medium than in the second, at the barrier 2125 between the two mediums the light will refract towards the normal plane 2120 of the second medium. This is the FST (Fast to Slow, Towards Normal) principal of refraction and is what happens when light travels from air through a prism of greater index of refraction. At the interface between the air and the prism medium, the beam of light will refract towards the plane normal 2120 to the surface of the prism. Higher frequencies, with their shorter wave lengths, are more sensitive to the angle of the interface 2125. Longer wave-lengthened reds are less refracted, while the path blues and violets get pretty bent 2115. This spreading 2105 of light into its components creates what is known as the light spectrum.

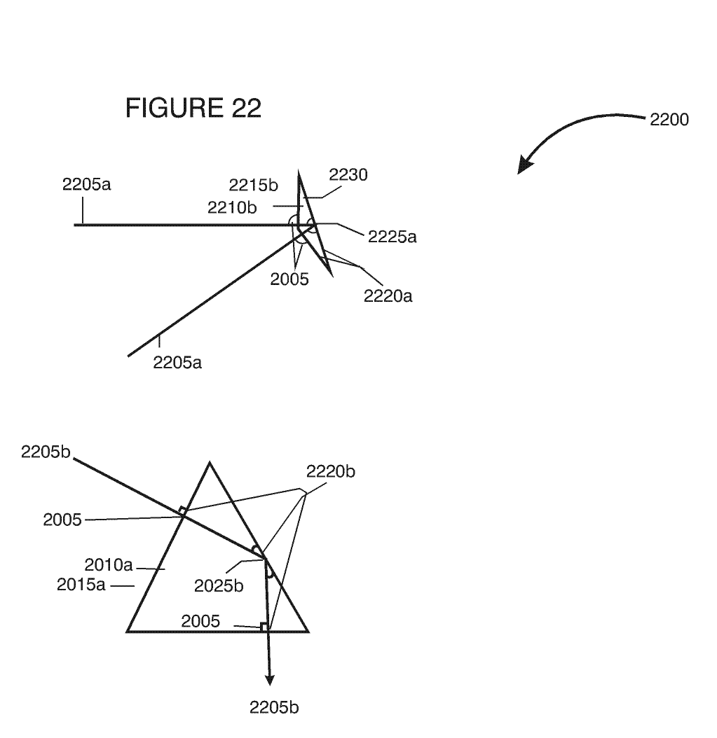

When composite white light 2205a-b (similar to 2130) is instead sent from one medium 2215 to another 2210a, 2210b normal 2205a, 2205b to the interface 2220a-b (similar to 1820) between the two mediums, because all frequencies were equally and already normal to the surface, the entire light path will continue straight as if it weren't refracted, as shown in FIG. 22. Composite white light 2205a, 2205b that both enters and exits a prism 2230 (similar to 1830) perpendicularly 2205a, 2205b, or normal 2005 to its surfaces 2220a, 2220b, will remain intact as a composite beam of white light 2205a, 2205b rather than being spread into its spectral components. The angles of incidence and refraction 2225a-b are similar to 1 15.

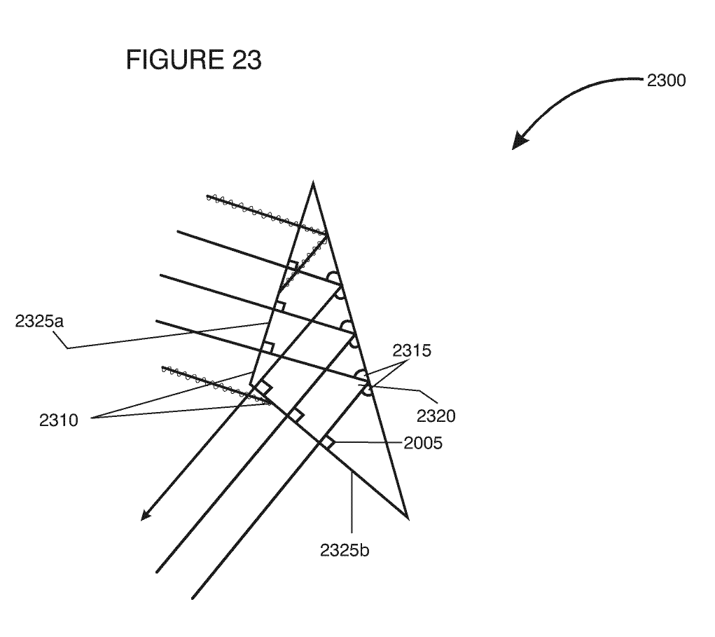

To allow light to enter and exit the prisms perpendicularly 2005, the entry face 2325a (similar to 1820) of every prism, is to be normal 2005 to the oncoming light, while the face 2325b (similar to 1820) of exit is the normal 2005 of the ray extending towards convergence. A non-reflective tinting 2310, on the outside of the exiting face 2325b, and the inside of the entry face 2325a allows for only perpendicular light interaction by ‘blocking’ reflections 2320 (similar to 1920) -that are not perpendicular to the face as shown in FIG. 23. The angles of incidence and refraction 2315 are similar to 115.

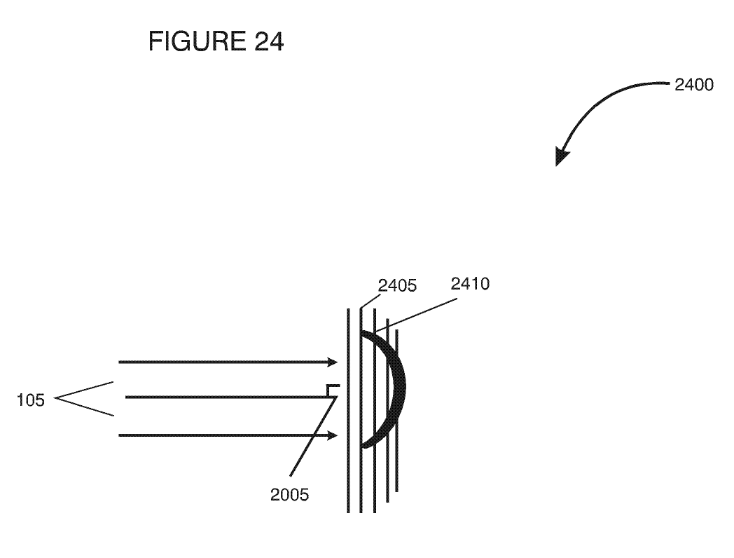

In FIG. 24, directly approaching parallel light 105, symmetric along the vertical axis, reflecting from a spheroid 2410 (similar to 310) of prisms, enters the first face of the prism pairs at a perpendicular 2005 if all first faces align with a vertical 2405.

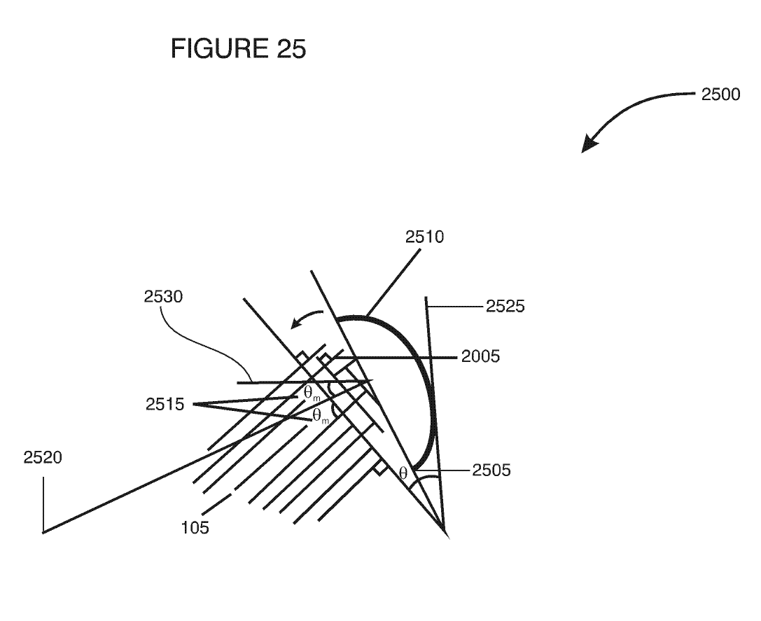

In FIG. 25, slant approaching parallel light 105, anti-symmetric along the vertical axis, reflecting from an ellipsoid 2510 (similar to 610) of prisms, enters the first face of the prism pairs at a perpendicular 2005 if every first face aligns with planes two theta m 2515 (similar to 815) 2505 past the vertical 2525 (similar to 2405), normal to the midline 2520 (similar to 810) between the incoming light 105 and the convergence horizon 2530 (similar to 305).

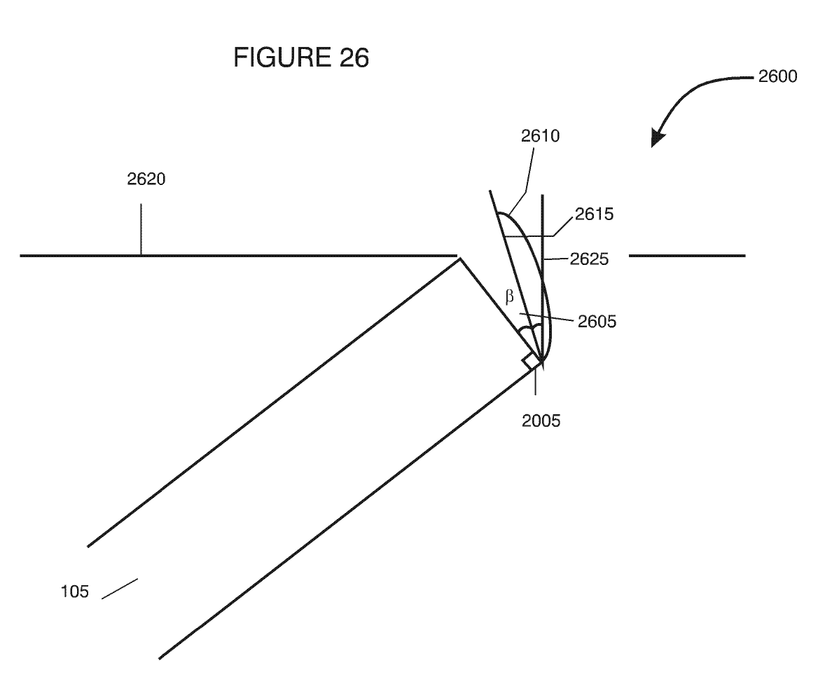

The term “beta” 2625 will refer to the rotation of the prism faces in an oblate ellipsoid 2610 (similar to 610) so that the axis 2615 (similar to 605) is normal to the midline between vertical 2625 (similar to 2405) and the convergence horizon 2620 (similar to 305) (a rotation, hinging about the X axis), shown in FIG. 26. Beta 2605 is initially equal to two-theta m for all slant approaching light, anti-symmetric along the Y-axis.

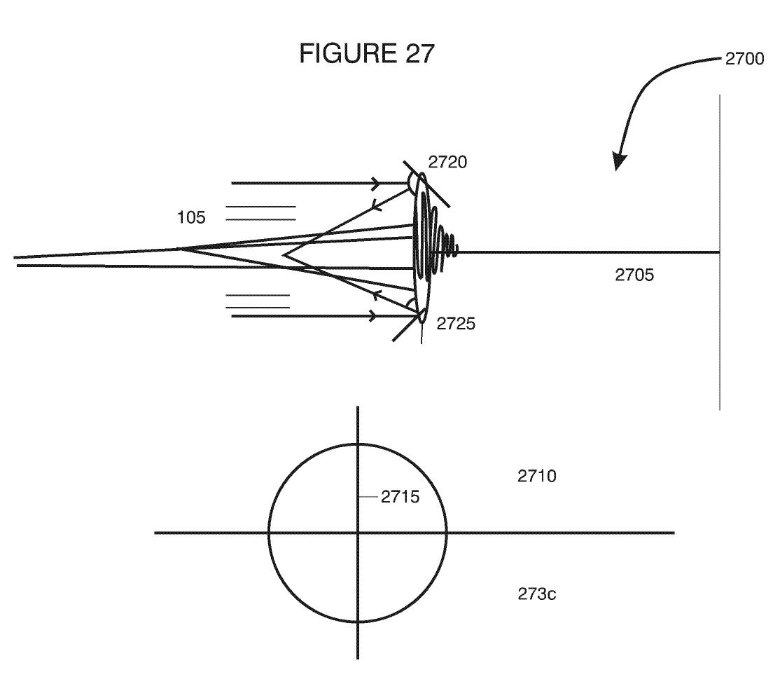

As FIG. 27 shows, the alpha rotation 2710 (the Y axis hinge) is initially zero, unless there is anti-symmetry in the light approach along the X axis, and then this will compensate in the same manner as the beta.

Again, the angle of the reflecting/transitive interface coincides with the shape of the convergent device. The beta rotation 2730 of the reflective exit surface of the prism pairs relates to the pair's particular location in the converging device. For symmetrically approaching parallel light 105, the exiting face of the prism pairs making up the spheroid will graduate from a large angle beta 2730 at the vertical extremas to a null beta angle along the plane of the convergence horizon 2705 (similar to 305). The Alpha rotation 2710 will graduate from a large angle alpha 2710 at the horizontal extremas, to a null angle alpha 2710, along the vertical axis 2715 originating from and normal to the convergence horizontal. In general beta 2730 and alpha 2710 rotations subtend with decreasing row 2720 (similar to 115) and as the sine or cosine of theta 2725 respectively.

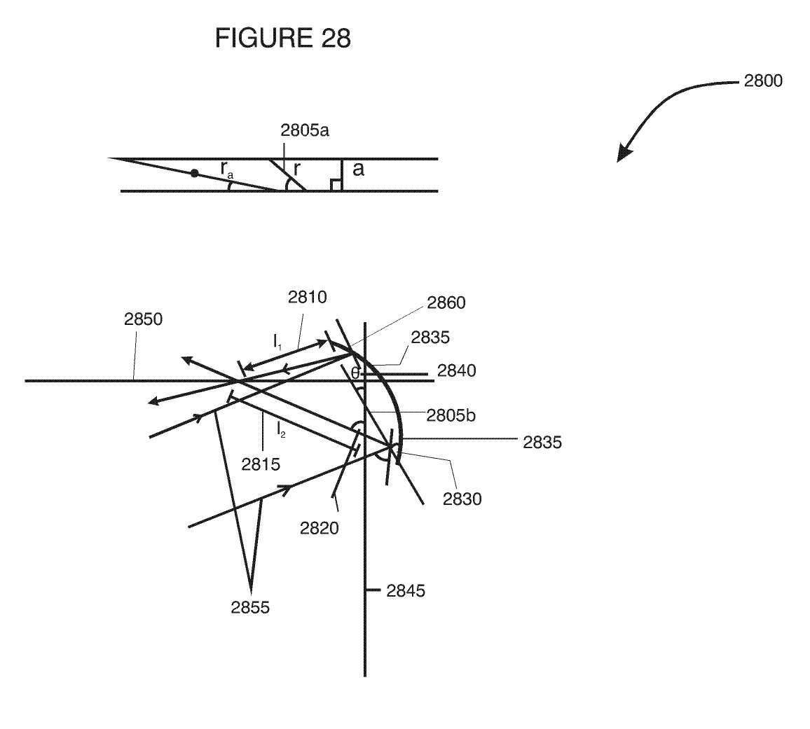

The principal ellipsoid radius, “r” 2805, increases to maintain the desired surface area, as the ellipsoid 2835 is rotated about its center, as illustrated in FIG. 28. In this rotation, prism pairs at the upper end of the ellipsoid 2835 are advantaged in their nearness to the convergence point, and thus will have more severe alpha and beta rotations than their lower counter parts 2820. The reason for this is that lower prism pairs 2820 (similar to 2605) have now been extended further 2815 from the convergence point, and will be able to make a more gently angled 2820 ray 2815 to eventually meet a point, of the same absolute value, from the center axis. The angle of incidence is the same as the angle of refraction 2830 (similar to 115). Planes that are normal to these more gently sloping rays 2815 will be less rotated from the vertical 2845 (similar to 2405) or horizontal 2850 (similar to 305) than their northern counterparts 2810. The dead center prism of a prism-made- ellipsoid 2835 (similar to 610), rotated towards its mid-line, will be composed of one face normal to the cylinder 2855 (similar to 715) of oncoming light 105. This first face has a beta rotation angle of two theta m 2840 (similar to 805) from the vertical 2845. It then has a reflective face, because it is at the center, angled directly towards the mid line, rotated one theta m from the vertical 2845, and, because the center will reflect a ray on the convergence horizon 2850 (similar to 305), a final face, aligning with the vertical 2845.

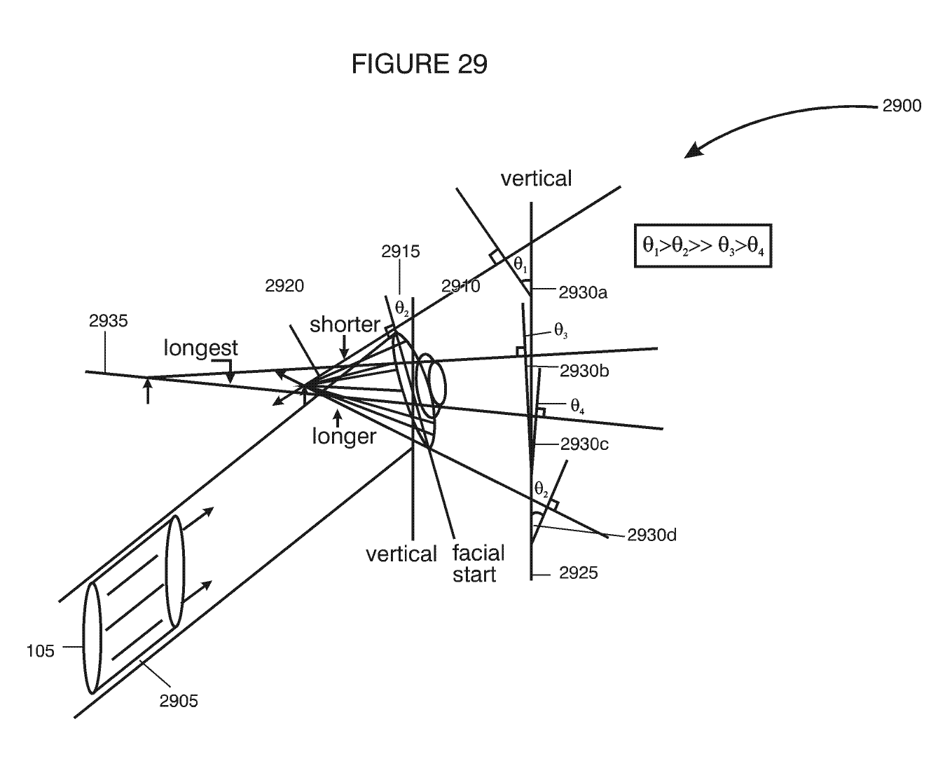

FIG. 29 shows a cylinder 2905 (similar to 715) of light reflecting off a converging ellipsoid 2910 (similar to 610), rotated to theta m 2915 (similar to 805) past the vertical axis 2925 (similar to 2715). The light 2905 will intersect the ellipsoid 2910 at different angles 2930a-d, resulting in convergence rays 2920, 2935 of differing lengths, such that the longer the convergence ray 2920 (similar to 1205 but with various cone angles, here the longer ray has a smaller cone angle, while the shorter ray would have a larger convergence cone angle; these are not right cones) and the closer it is to the convergence horizontal 2935 (similar to3O5), the smaller beta final.

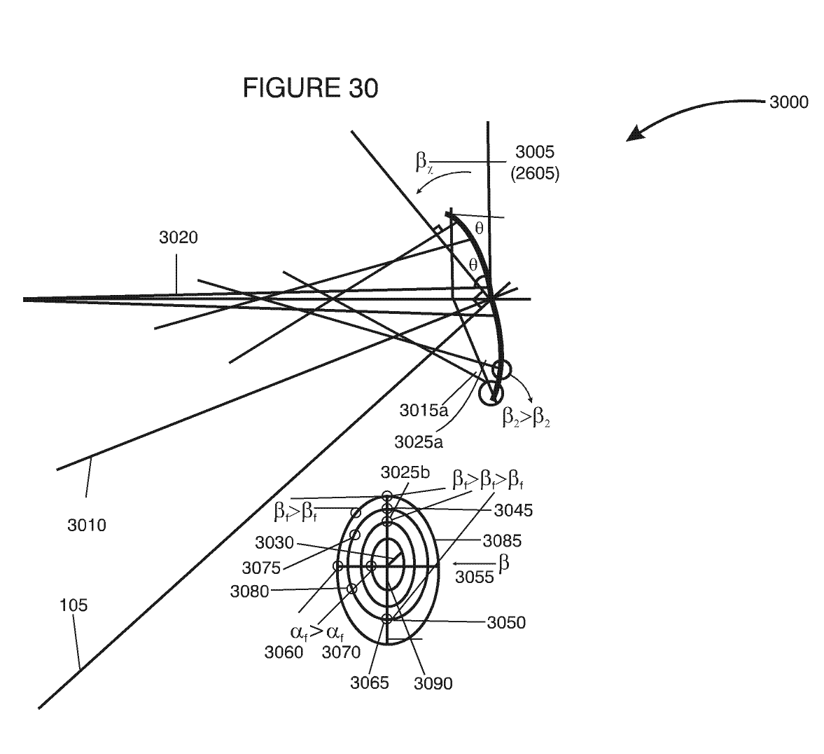

In FIG. 30, a converging ellipsoid is rotated 3005 (similar to 2605) such that it is normal to the midline 3010 (similar to 810) between the oncoming light 105 and the desired convergence horizon 3020. It can be seen in FIG. 30 that the outer 3015a equipotentials have a greater beta final, than inner 3025a, 3025b equipotentials 3085 (similar to 1105) of equal angle phi 3030 from the horizontal 3020 (similar to 305) and the top 3045 outer points are greater still, than bottom 3050 outer points. This result is in agreement to the ray length, angle correlation illustrated in FIG. 29.

In FIG. 30, points of an equipotential, falling right on the horizontal 3020 will have no beta 3055 component to their rotation at all. On the other hand, they will have an alpha component graduating from most rotated at the exterior 3060 and horizontal 3060 and lessening towards the interior 3070 and vertical 3065. Again the upper 3075 portion will have the comparatively greater alpha component than the lower 3080 portion. Points of an equipotential falling on the vertical 3090 will have no alpha component to their rotation. α₁=0 unless the light source comes in with a horizontal symmetry.

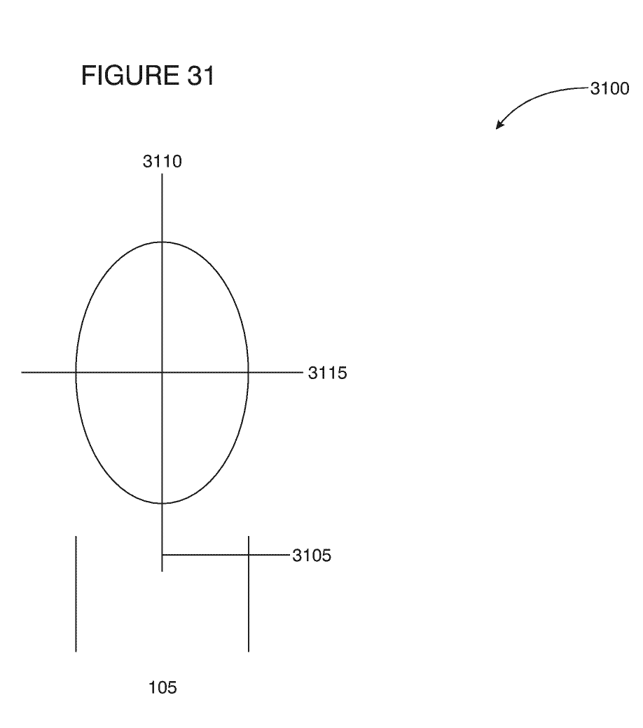

For slant incoming parallel light 105 that approaches symmetrically 3105 along the X axis 3115, as in FIG. 31, the prismatic face rotations 3110 will only need to be accounted for as mentioned in FIG. 30.

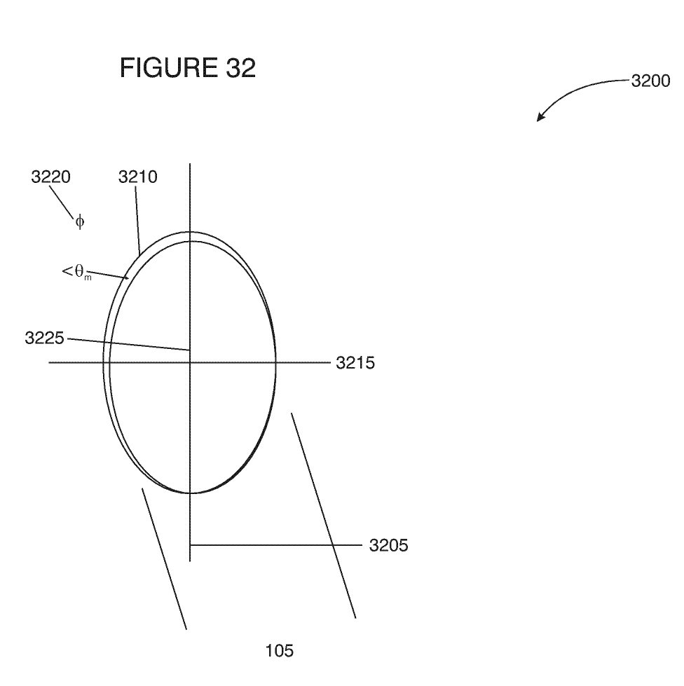

In FIG. 32, when the incoming parallel light 105 approaches non-symmetrically along the X axis 3215 and Y axis 3205, the prism faces accommodate with an initial alpha 3210, rotated an additional phi m 3220 beyond the reflective convergent device, which is two phi m 3220 from the horizontal, where phi m 3220 is the mid angle along the X axis 3215, between the incoming light 105 and the intended line of convergence 3225.

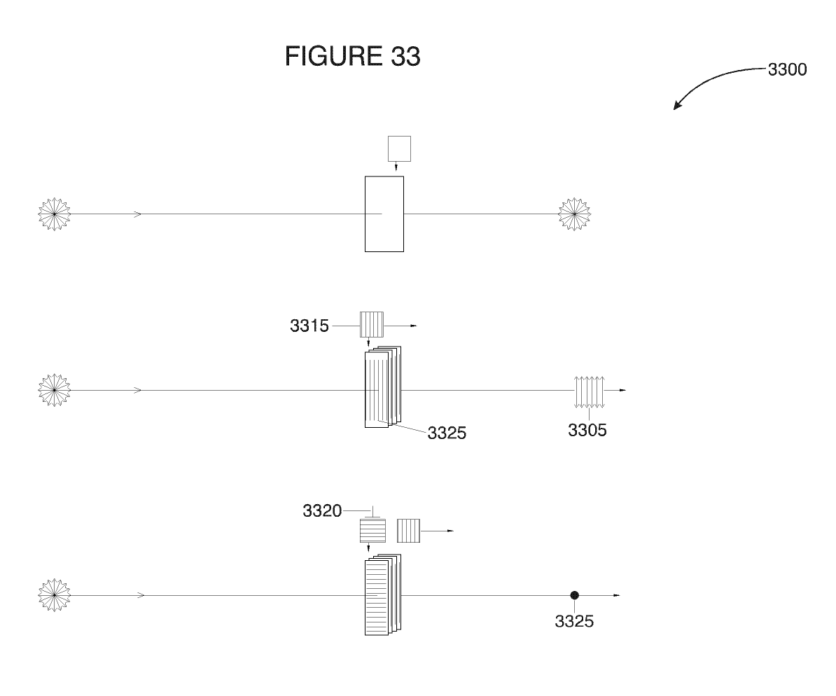

Polarizing devices can also be used to manipulate convergence points. Unpolarized 3330 light propagates perpendicular to the direction of travel, as shown in FIG. 33. When it is sent through a polarizer 3315, some material which fixes the direction of the electric field, like a plane of glass, a charged glass of water in which the molecules have aligned, or a dichroic polarizer, material with electronic conductivity in two perpendicular directions, linearly polarizes the light in the direction of the field 3305. For dichroic polarizes, this direction will be symbolized as the particular plane of polarization 3325. When light is sent through two dichroic polarizes, perpendicular 3320 to one another, the immediately perpendicular 3320 planes of polarization 3325 will block 3310 all light transmission.

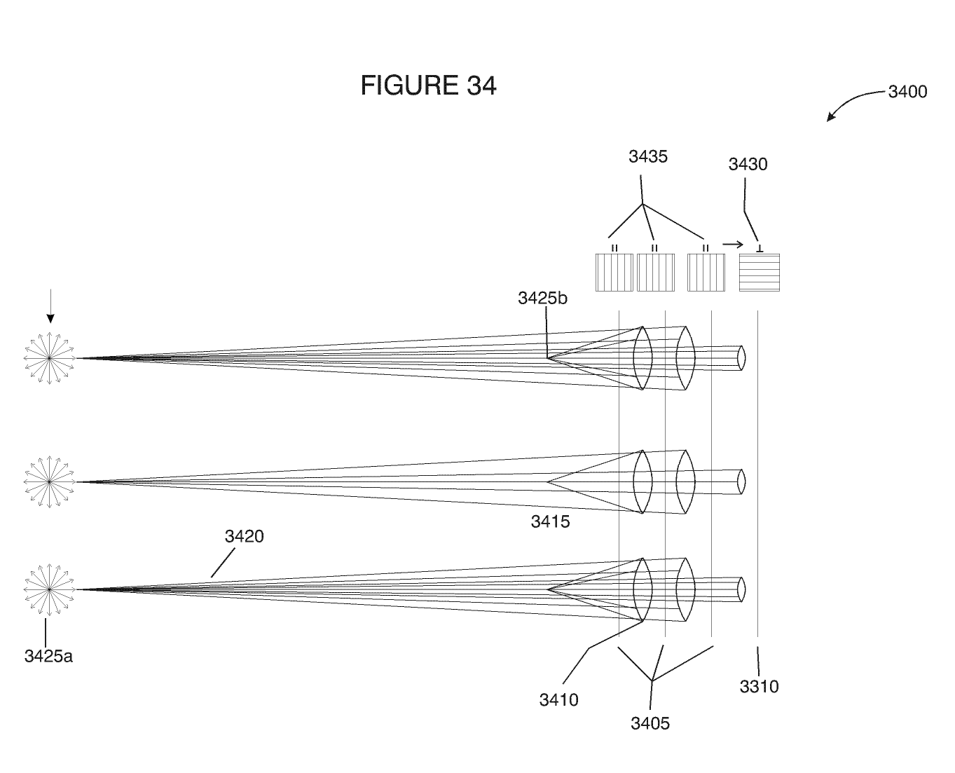

Obstructing the reflective surface, very similarly to the way the obstructing device functions, will isolate specific regions of the surface for reflection from a reflecting convergent device. FIG. 34 suggests that if the surface of an ellipsoid can be divided along its equipotentials 3410, it will reflect from all equipotential 3410 (similar to 1105) levels, except where two polarizing planes run perpendicular 3430 (similar to 3320) to one another. Where polarizing planes are parallel 3435 (similar to 3315), the polarized light 3405 (similar to 3305) will conically converge 3415 (similar to 1205) to a point 3420 on the convergence horizon 3420 (similar to 305) at the depth illuminated 3425a (similar to 120).

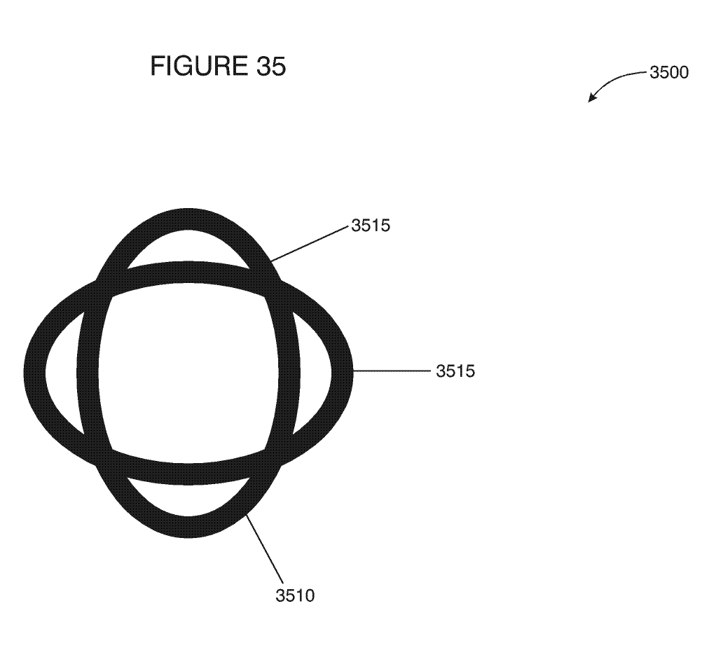

There are two issues with this arrangement. Many polarizers, even in parallel with one another, reduce the light transmission to some effect, and oval equipotentials 3515 (similar to 1105) are not preserved 3505 in a ninety degree rotation 3510, as shown in FIG. 35, a symmetric total ring rotation.

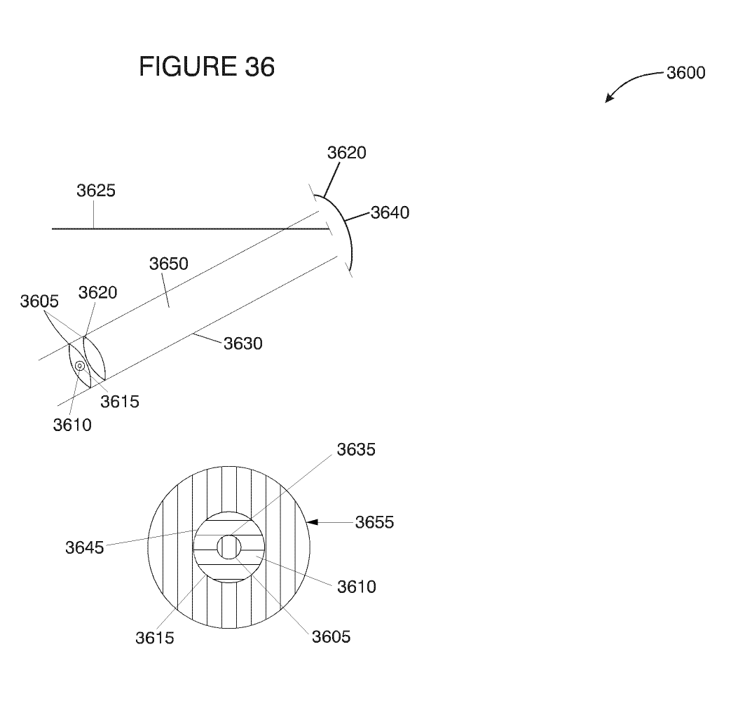

FIG. 36. If the light can be reflected symmetrically into the convergent device, without later causing interference, then the convergent device can be made with a symmetric face of circular equipotentials, which preserve themselves in any rotation. But if that symmetry is not found in the face of the reflective convergent device, polar symmetry still exists about the axis of the light cylinder 3630 (similar to 715). Different radii of the light cylinder 3630 correspond to the ovular equipotentials 3640 that comprise the surface of the converging device. The circular components of “a slice” of the cylinder 3630, by its nature of radial symmetry (as shown in FIG. 36), can be manipulated, the same as manipulating the face of a reflection. For a cylindrically symmetric slant approaching parallel light source 3650, the polarizing devices can be brought right into the path of the light cylinder 3630, obstructing the potentially reflectable light and successfully isolating particular convergence points along the convergence horizon 3625 (similar to 305). Then, to reduce the loss of light transmission, polarizing rings 3605, rather than polarizing sheet 3615, interferes with only the desired equipotentials 3640, and limits the screens light must pass through.

In one instance the circular rings 3605 in a standard polarizing screen 3655 can be made each to overlap the only the next level such that upon ninety degree rotation 3635 (similar to 3510) of one level, in which the other remained stationary, the overlapping fraction could perpendicularly obstruct 3610. This can work as a continuous method of obstruction 3610 in the previous levels if previously perpendicular levels continue rotation 3635 with the highest rotating 3635 level such as in a latch system. The system where the first 3605a will rotate ninety degrees 3635 until it latches onto the second 3605b, and then the first and second rotate ninety degrees 3635 to latch onto the third 3605c, and then the first, second, and third rotate ninety degrees 3635 together to latch onto the fourth 3605d, unlatching in a similar unfolding manner of ring 3605 by ring level progressively transmitting light 3645. This can allows for just two light intensity obstructions.

Another, possibly simpler method, works by letting one full sheet 3615 remain stationary as the ruling 3620 (similar to 610) plane of polarization, individual rings 3605 can rotate 3635 parallel or perpendicular 3610 (similar to 1105, 3320) to the ruling 3620 plane thus allowing or not allowing light to pass to their equipotentials 3640 (similar to 1105).

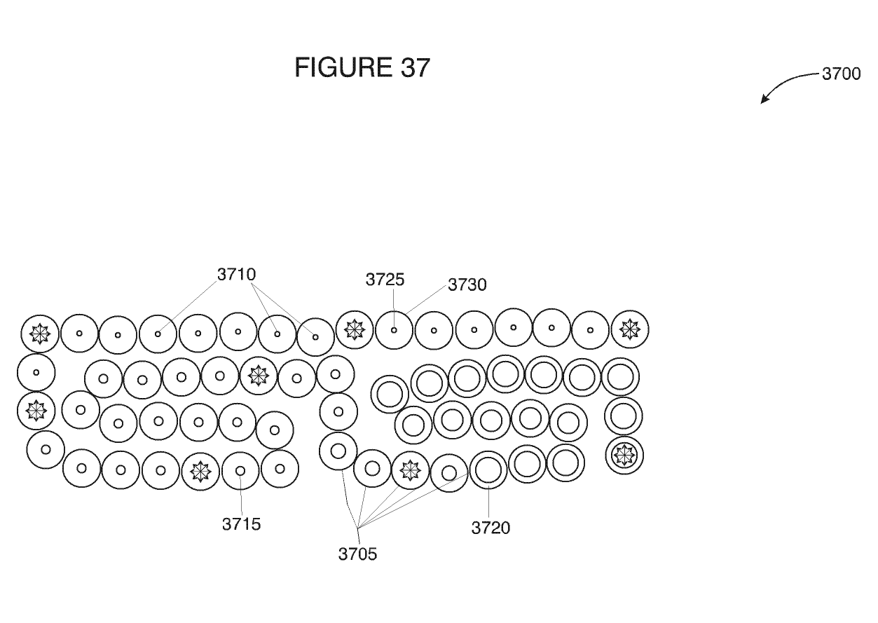

A polarizing filter wheel 3705, like the one shown in FIG. 37 can be made with the rings of the parallel 3725 and perpendicular 3730 possibilities, either behind or in front of the ruling plane. A large enough polarizing wheel 3705 can even be shared among light sources, although they also all need access to the ruling plane, either individually, or large enough that it interrupts all sources relying on it. It should also be noted that only the perpendicular 3730 components need be present to cause the obstruction. The polarizing wheel 3705 can be made of a sheet perpendicular 3730 to the ruling plane, allowing for ringed space gaps where the parallel incoming unpolarized light will pass through only the polarizing sheet of the ruling plane, singularly polarized and unobstructed. The resulting equipotentials 3710 (similar to 1105, 3605) can focus either near 3720 or far 3715.

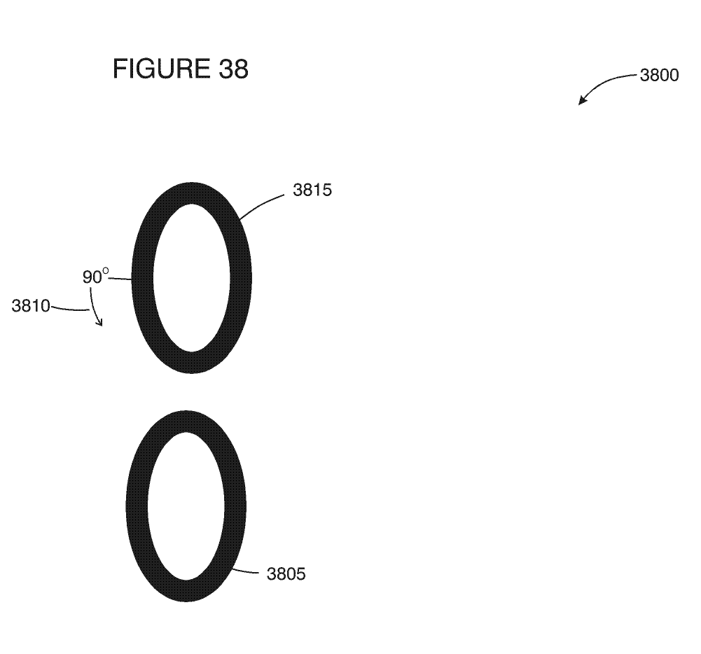

FIG. 38 shows piecewise ring rotation. The individual rings 3605 in the path of the light cylinder as shown in FIG. 36, can rotate as a ring because the circle is preserved. A polarizing ring can also be made up of components that each rotate (e.g., at least ninety degrees) individually 3810. Both ninety degree component 3810, as illustrated in FIG. 38, and total ring rotation achieve the purpose of rotation. The benefit to component ring composition is that it can be carried over to the ovular equipotentials 3815 (similar to 1105), because component rotation 3810 still preserves 3805 the polarizing cover of an ovular equipotential 3815. A lens refracts light in such a way that it will either converge or appear to diverge from a point depending upon the shape of the lens.

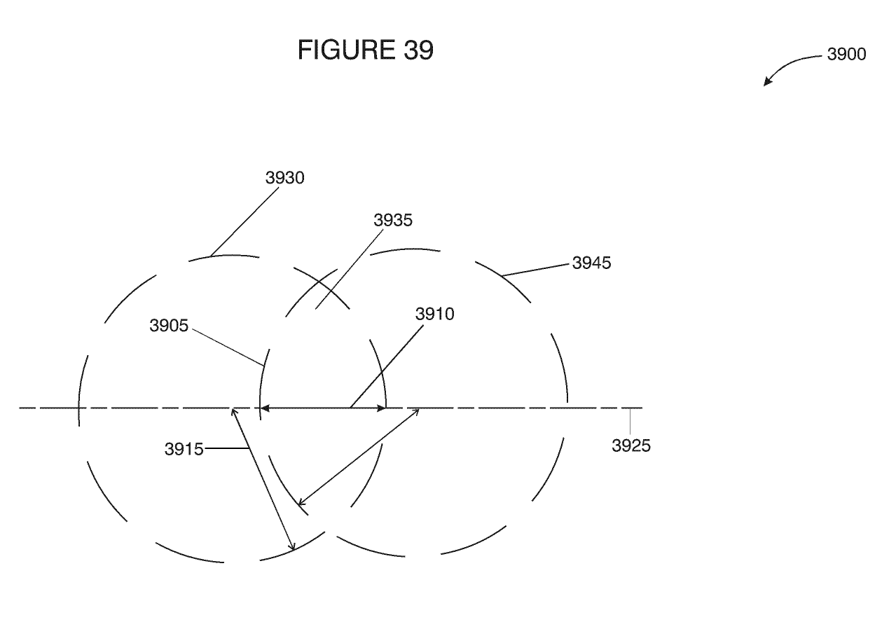

FIG. 39 illustrates how a double convex lens 3905 of a certain thickness 3910 can be formed with the curvatures of two overlapping spheres 3945 of radiuses “R1” 3915 and “R2” 3920 arranged on the principal axis 3925. Parallel light 105 is refracted towards the interface normal when passing from air 3930 (similar to 1905), which has a refractive index of “n′,” into the lens′ medium 3935 (similar to 1910), which has a refractive index of “n,” and then away from the interface normal as it passes from the lens medium 3905 back to the air 3930.

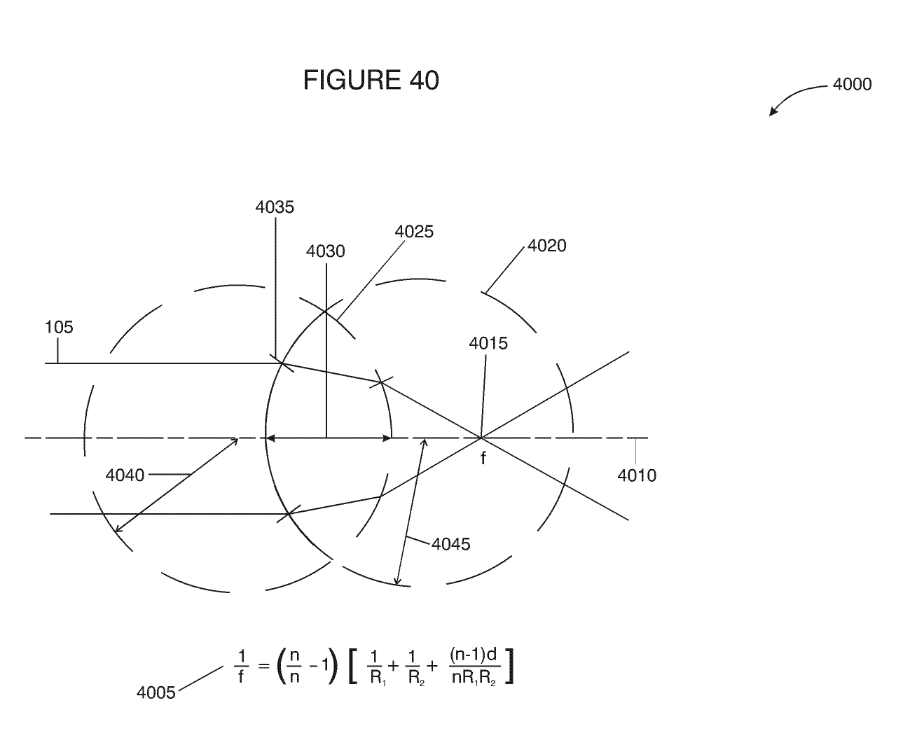

This double refraction causes parallel approaching light 105 entering the lens 4025 (similar to 3905) to refract towards the normal plane 4035 (similar to 2120) of the lens 4025 (similar to 3905) to converge to a focal point 4015, shown in FIG. 40a, as determined by the lensmaker's equation 4005 (FIG. 40b). The focal point 4015 (similar to 120) is dependent upon the radius of the first 4040 (similar to 3915) and second 4045 (similar to 3920) circles 4020 (similar to 3945), as well as the distance 4030 of the two circles on the principal axis 4010 (similar to 3925, 305) which have overlapped at the middle. The overlap 4030 (similar to 3910) is the lens thickness.

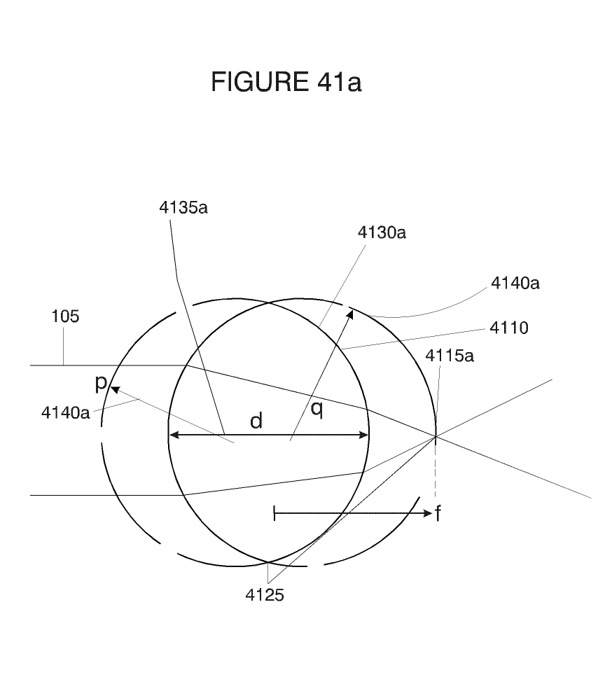

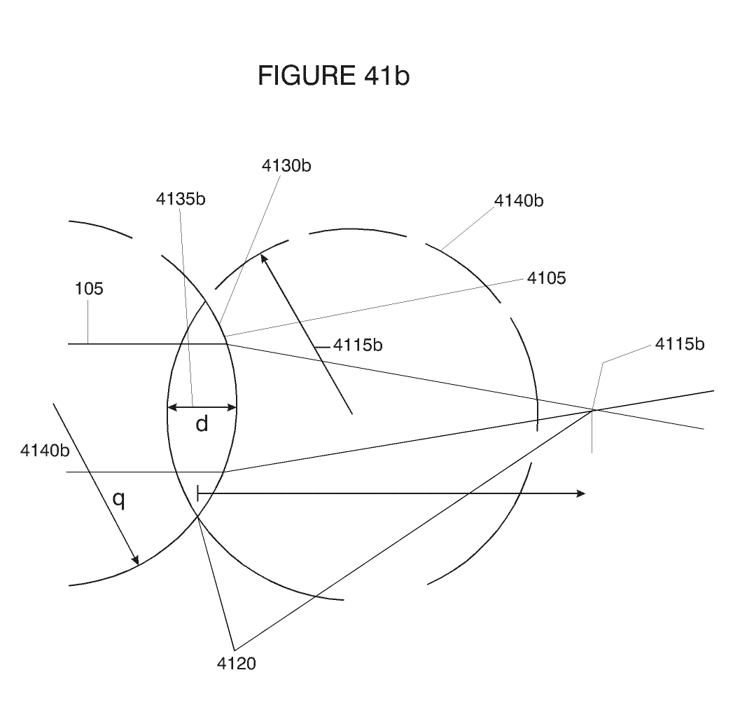

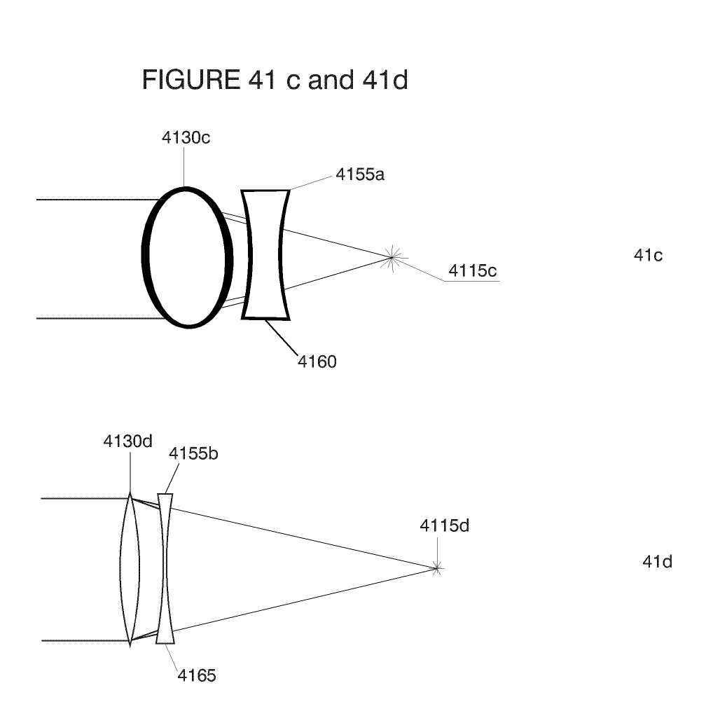

FIG. 41a shows a thick ‘overlapping’ distance 4135a (similar to 3910) double convex lens 4130a (similar to 3905), of small radii 4140a (similar to 3915), 4145a (similar to 3920), will converge 4115a (similar to 120) very near 4125 to the lens. Its curvature is made of higher gradients 4110 than a double convex lens 4130b (similar to 3905), of larger radii 4140b (similar to 3935) 4145b (similar to 3920), and thinner overlapping distance 4135b (similar to 3910), of which converges 4115b (similar to 120) to a point further 4120 from the lens, shown in FIG. 41b.

FIG. 41c. Color correctors 4160 are the inverse of the shape of the converging lens 4130c (similar to 3905), designed to cause negative aberration. Higher frequency light is more strongly converged than light of lower frequencies. To correct for this a second lens, which can be made out of a material like flint, is used to disperse the light, but again it is the blue that is dispersed better than the red, so after convergence and dispersion, the color aberration is decreased. A thicker color corrector 4160 is used for a spherical lens with a near focus 4115c (similar to 120).

FIG. 41d. A thinner color corrector 4165 is used for a spherical lens 4130d (similar to 3905) with a distant focus 4115d (similar to 120)

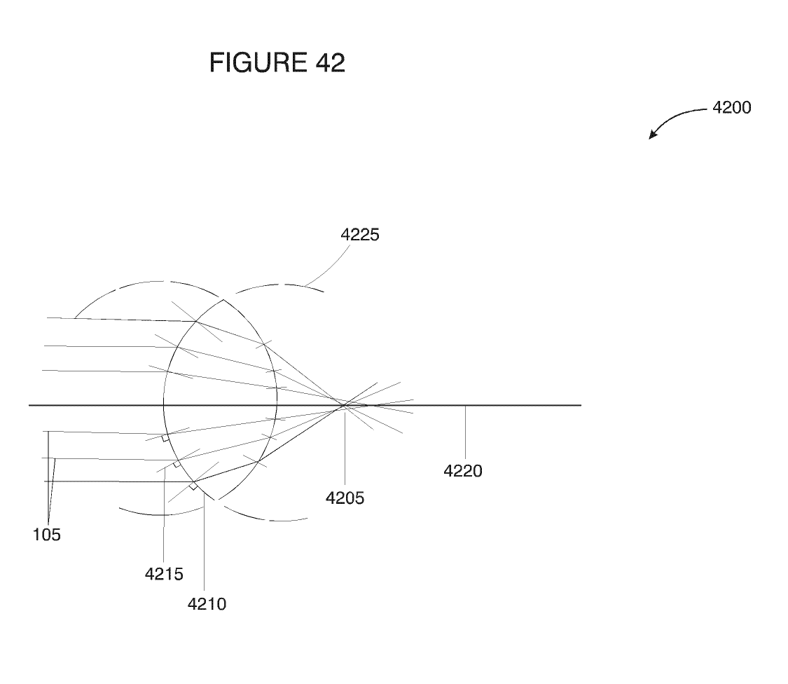

But the spherical lens 4210 (similar to 3905), which is formed by the intersection of two spheres 4225 (similar to 3935), is known to cause spherical aberration 4205 (similar to 205), a longitudinal spread along the principal axis 4220 (similar to 3925) of the convergence point illustrated in FIG. 42, because the incident light 105 will bend towards the surface normal 4215 (similar to 2120).

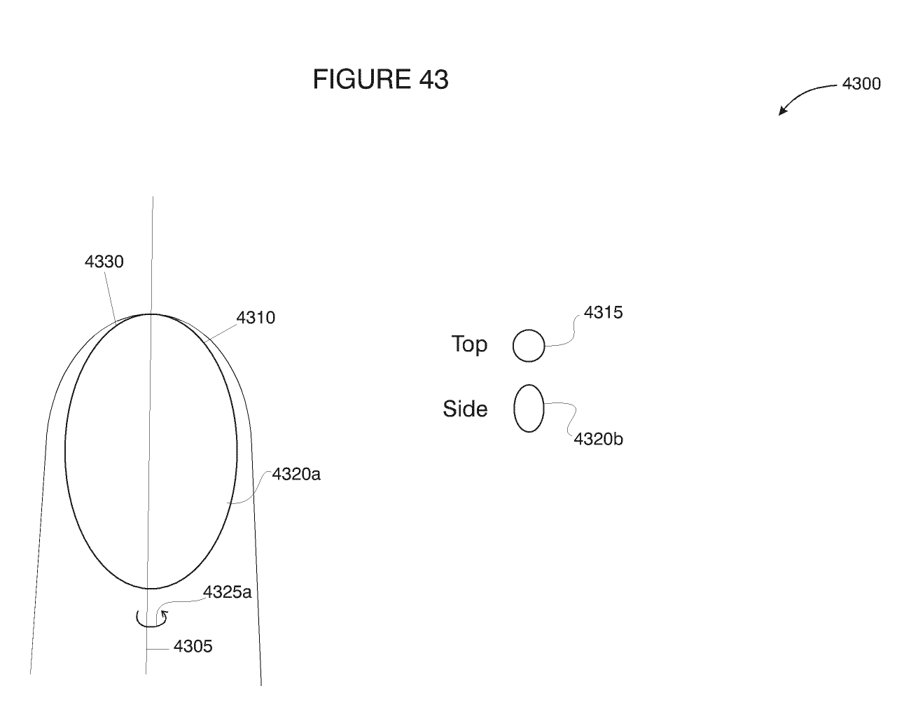

A parabolic shaped curvature 4330 ameliorates this problem by introducing negative spherical aberration. The major axis poles of a prolate spheroid 4310, the shape created when an ellipse 4320a (similar to 415) is rotated 4325 (similar to 420) about its major axis 4305, can be approximated by a parabola 4330, as shown in FIG. 43. A prolate spheroid is a circle when viewed from the top 4315 (similar to 505), but is an ellipse when viewed from the side 4320b (similar to 415).

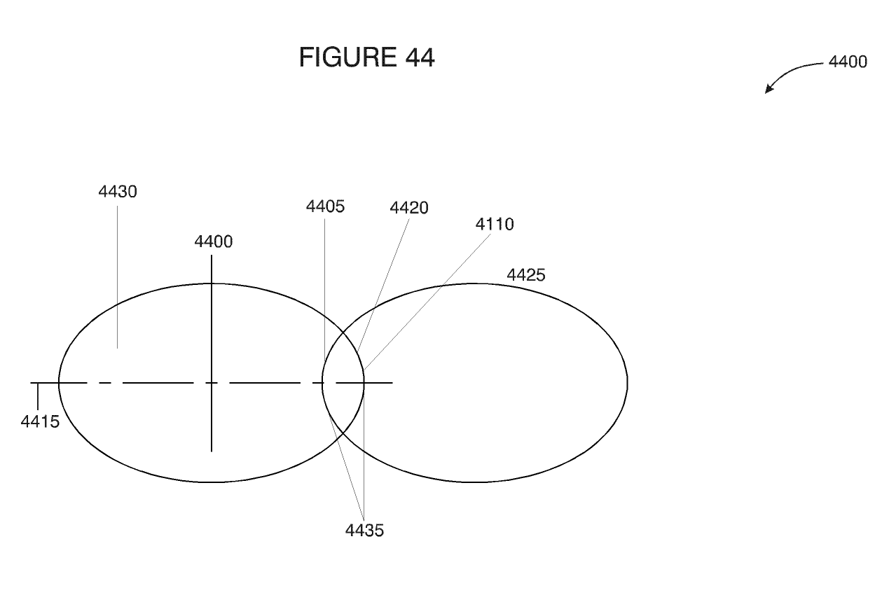

So, the major axis 4415 (similar to 4305) overlap of two prolate spheroids 4430, illustrated in FIG. 44, is ruled by this parabolic curvature about its poles 4435, now aligning with the principal axis 4410 (similar to 3925). The gradients of a double convex prolate spheroid 4405 graduate from high gradients 4425 nearest to the principal axis 4410 to lower 4420 (similar to 4105) ones near the minor axis equator 4440 of the prolate spheroid 4430 (similar to 4310). The outer regions of a double convex prolate spheroid lens 4405 closer to the minor axis equator 4440 converge further from the lens than they had under the spherical formation, while more central light converges more immediately than it did spherically. This brings the spherical aberration back to a tight focus.

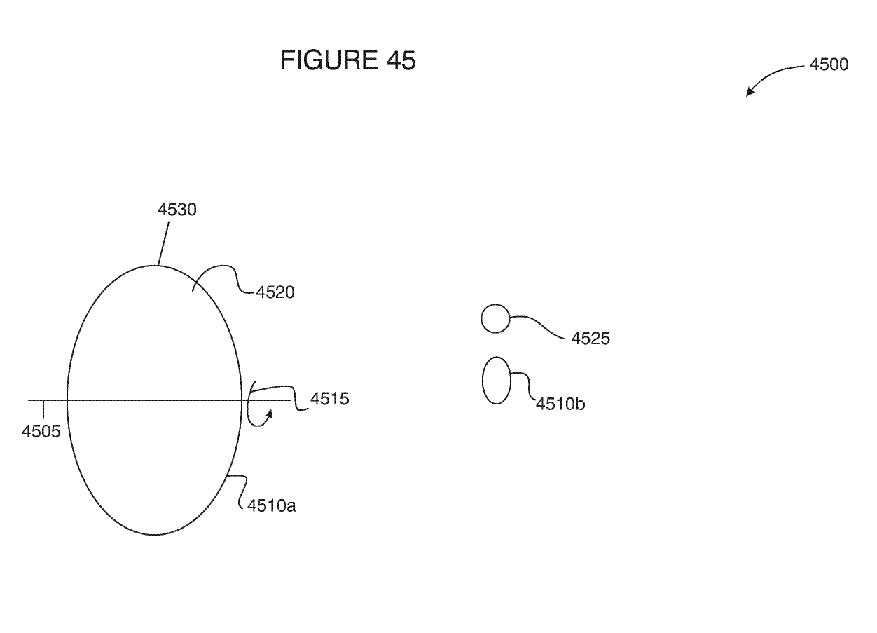

Again, seeking the converse of this situation, and paralleling the steps taken to create continuous convergence from the reflective device, the longitudinal spread of convergence can be enunciated by the use of a device whose gradients graduate from lowest about the principal axis to higher around the exterior. In FIG. 45, an ellipse 4510a-b (similar to 415) rotated 4515 (similar to 420) about its minor axis 4505 forms an oblate spheroid 4520 (similar to 310), whose gradients graduate from low around the minor axis 4505 to higher near the major axis poles 4530. An oblate spheroid 4520 is an ellipse 4510b when viewed from the top, but is a circle 4525 (similar to 505) when viewed from the side.

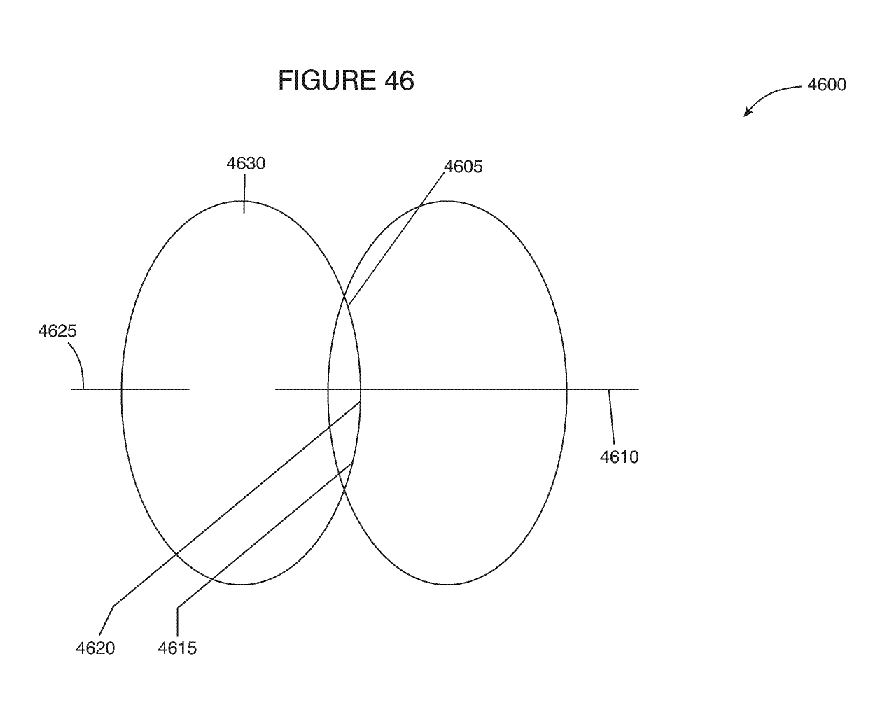

In FIG. 46, a double convex oblate spheroid lens 4605 is made by overlapping two shapes whose curvature can be approximated by oblate spheroids 4630 (similar to 310) over the minor axis 4625 (similar to 4505). The ellipse is rotated around the minor axis 4625 to become an oblate ellipsoid. All of the convergence points will fall on the principal axis 4610. A double convex oblate spheroid lens 4605 has areas of high curvature 4615 (similar to 4110) (as if made by a thick lens of small radius) and areas of low curvature 4620 (similar to 4105) (as if made by a thin lens of large radius).

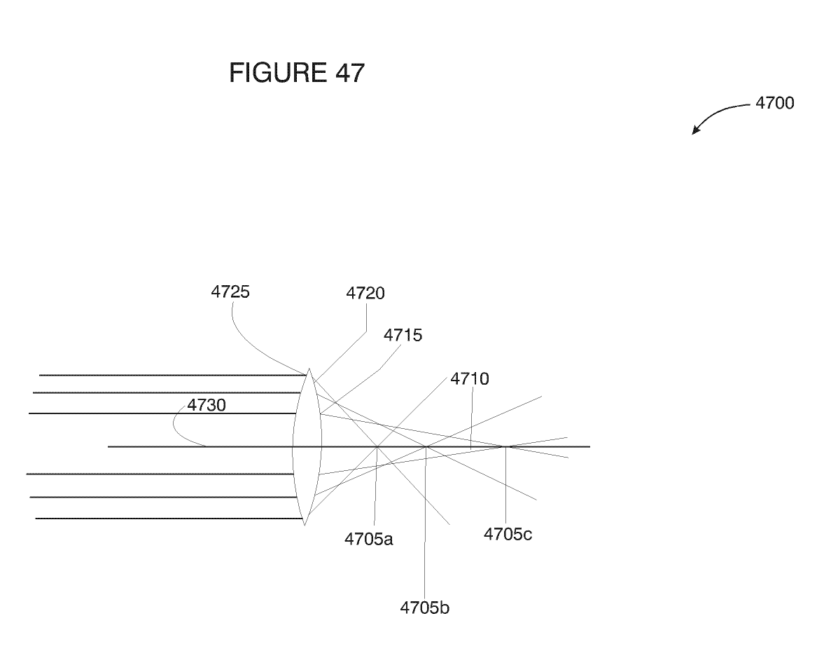

In FIG. 47, a double convex oblate spheroid lens 4725 (similar to 4605) causes a continuous line of convergence 4710 (similar to 305). Light passing from the outer regions of higher curvature 4720 (similar to 1410) of the double convex oblate spheroid lens 4725 converge 4705a (similar to 120) nearer to the device than light passing from the middle regions with lower curvature 4715 (similar to 1405) of the lens, which converges to points further 4705c along the principal axis 4730 (similar to 3925). Light passing between these two regions 4720, 4715 converges to a mid-point 4705b.

The line of convergence 4710 is produced on the opposite side of the refractive convergent device 4725, from the incoming light 105. This is generally different from reflective convergence whose convergence horizontal was on the same side of the device as the incoming parallel light 105.

FIG. 50 shows that this two sided formation allows for light from one or many sources 5010 to be symmetrically reflected 5005a, 5005b, 5005c into refractive convergent devices 5025 arranged on a plane 5015, which means that the lens does not need to account for any slant approaching parallel light 105 thereby simplifying the lens shape to axial symmetric 5020 (similar to 505).

The useful surface of the lens can then be manipulated by methods similar as those described for the reflective convergent device. Perpendicular polarizing planes will still cause an obstruction, but the axial symmetry of the device now makes it possible to place those polarizers either in the path of the light cylinder, or before or immediately after the refractive, symmetric convergent device. Before is an easier location to obstruct than immediately after the device, because before convergence the light can still be approximated by a cylinder. Afterwards it converges conically from the various equipotentials.

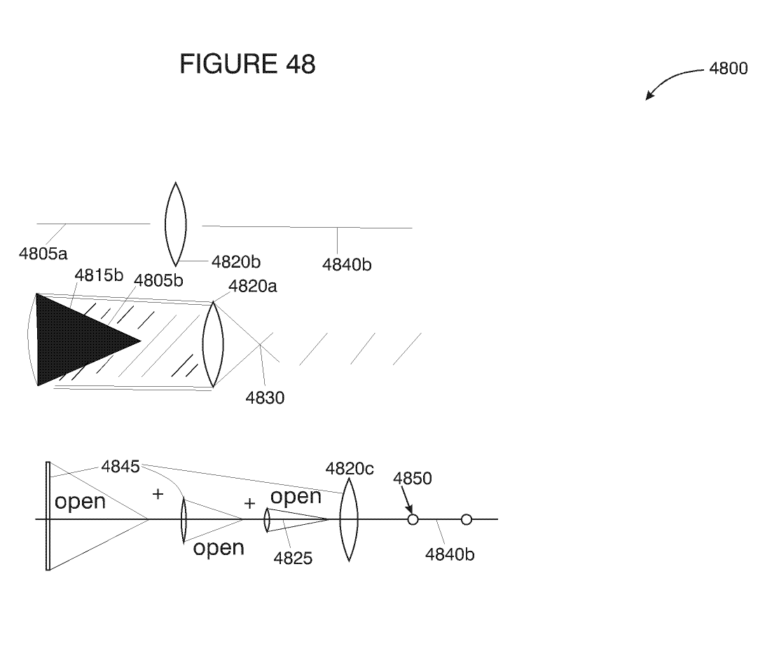

FIG. 48 shows a simple way to manipulate the oblate convex lens is the method of absorption. Instead of interrupting the actual surface, an umbrella 4805b can contract or expand 4815 to cover the surface. In its most lax position, when the umbrella 4805b is fully expanded 4815, light will only be able to pass from the outer regions of the refractive convergent device 4820a-c (similar to 4605) to converge to a point 4830 very near the device. When the umbrella is fully contracted 4825, approximating a short thin line 4805a, light converges from all unobstructed regions of the lens 4820 to a line of convergence 4840a.

Like the absorption cone, the absorption umbrella 4805, FIG. 48, lacks the ability to isolate more than one point of convergence, seeking more of a maximum depth, beyond which light does not converge.

The umbrella 4805b could alternately be formed by independent equipotential rings 4845, each able to contract and expand to cover their ring independently. In this umbrella method 4845, each equipotential can individually be raised to obstruct the converging apparatus, resulting in points of disrupted convergence 4850. The independent equipotential rings 4845 are spread in FIG. 48 to illustrate the components, not to signify any necessity for spatial spreading. This umbrella 4805b would have the ability to isolate more than one area of the surface for convergence 4840b. Umbrella 4805 absorption can obstruct the light path prior to reflective convergent devices as well. By various methods of useful-surface augmentation, convergent points can be isolated and varied from along the convergence horizontal.

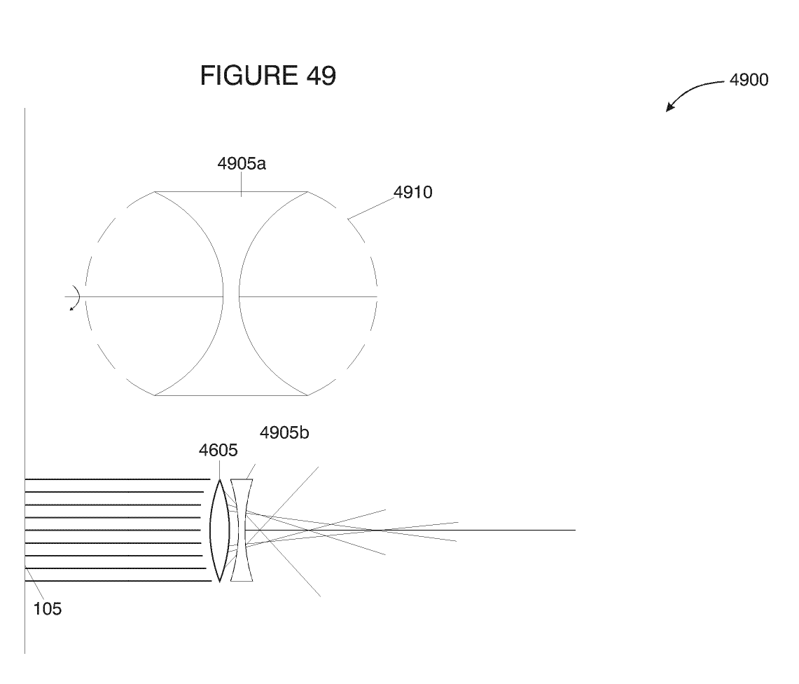

Chromatic aberration will still have to be accounted for when sending non-monochromatic light through the double convex oblate spheroid lens 4605. FIG. 49 shows that a double oblate concave 4905a lens made of something like flint is one possible solution. A double concave oblate spheroid is constructed of ellipses 4910 (similar to 310) rotated about their minor axes (oblate spheroids). A double concave oblate spheroid used as a color corrector 4905b will be preceded by a double convex oblate spheroid lens 4605.

To use fewer light sources one could have a mobile light source or be able to accommodate the incoming light from an angle such that it still produces the various points of convergence along a common depth axis. As has already been mentioned, because of the two sided nature of refractive convergent devices, it is not necessary to otherwise bend the light within the lens because the light can easily be redirected 5005, FIG. 50, to a symmetric approach to any and every lens 5025 (similar to 4605). The light path can be redirected 5005 prior to the refractive converging device 5025 by the use of reflection plates 5005 angled midway between the original path and the desired path.

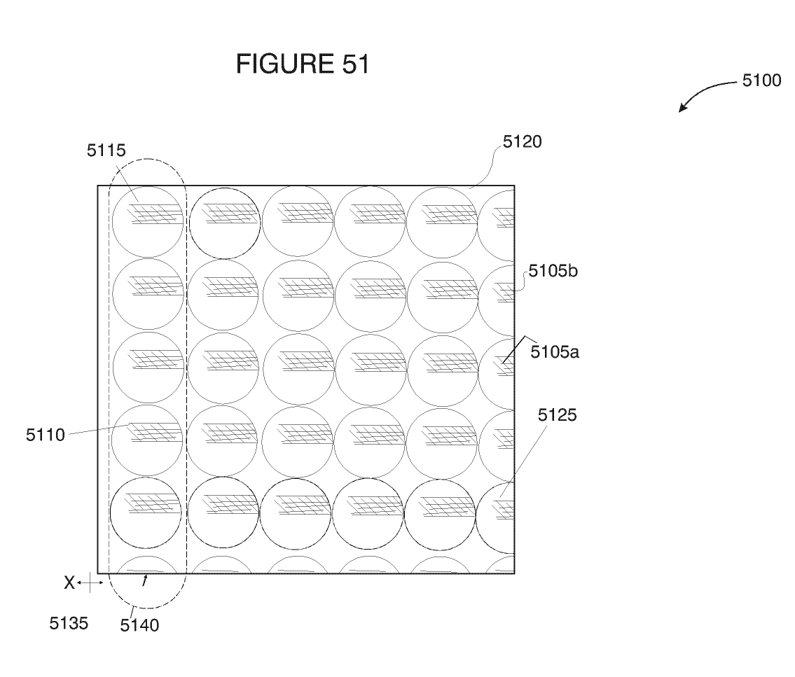

FIG. 51, symmetric double convex oblate spheroid lenses 5125 (similar to 4605) on a plane 5120 (similar to 5015) with correcting plates (many sources), illustrates the vertical component of variation in the redirecting plates, in the image it is assumed that each column 5130 has an X axis 5135 symmetrically approaching light source. Plates 5105 redirecting paths towards very high devices 5115 will be more angled against the horizontal than the plates 5105a-b (similar to 5005), redirecting paths towards lower devices 5110. Plates towards the bottom 5140 will be rotated almost parallel with the floor. The plates are positioned to reflect the light into the converging apparatus, here being the double convex oblate spheroid lens 5125 (similar to 4605). A screen 5120 would be composed of the multiple lenses with reflecting plates angled to reflect the source into the lens.

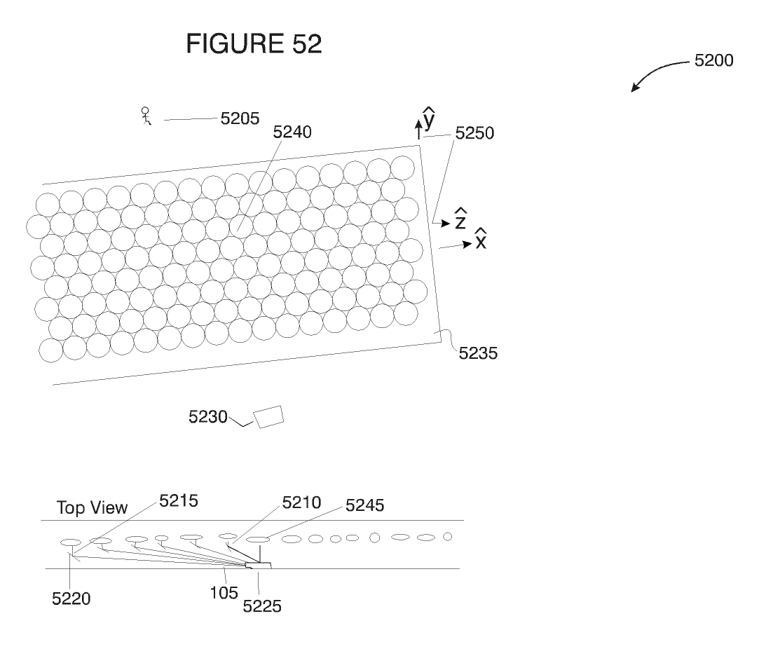

If there is one centrally located source 5230 (similar to 5010) (at the bottom from behind prospective images as shown in FIG. 52, where the vertical path redirection has already been accounted for above), the centered devices 5245 will not need to be accommodated for horizontally. Beyond that the plates progress from nearly parallel 5210 to more severely angled 5215 against the Y-Z plane 5250, we move from the center 5225. The light source first aims at the plates 5220 or whatever will shift them, before the converging device 5240 (similar to 4605). The viewer is on the opposite side of the screen of lenses 5235 (similar to 5015) from the source 5205. Multiple sources can be harbored 5225 (similar to 5010) together.

There are many ways to share light sources, like the use of a beam splitter, but generally such devices can cause a loss of intensity, so care and knowledge of these effects can be considered.

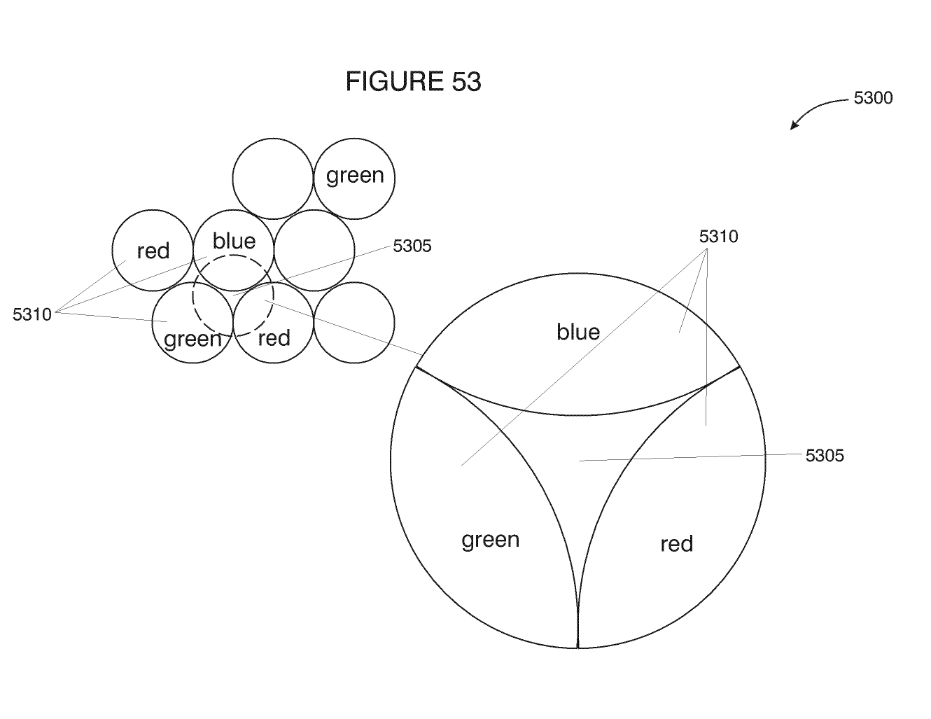

In any case, all frequencies required to form a color at specific point (xyz), need to be available to the device that is causing convergence to that point. Depending on how the light is eventually made visible, the “colors” produced will be formed either directly or can be the result of some atomic reaction. First consider the direct case. If at a point a color blend of red, blue and green is needed from a device, then in one way or another, red, blue, and greed light are made available to the device producing that point, either separately, or already in their combination. The color in color televisions is created by an illusion of a light mixture 5305 (blended by the eye) in the region of space between local colors 5310, demonstrated in FIG. 53.

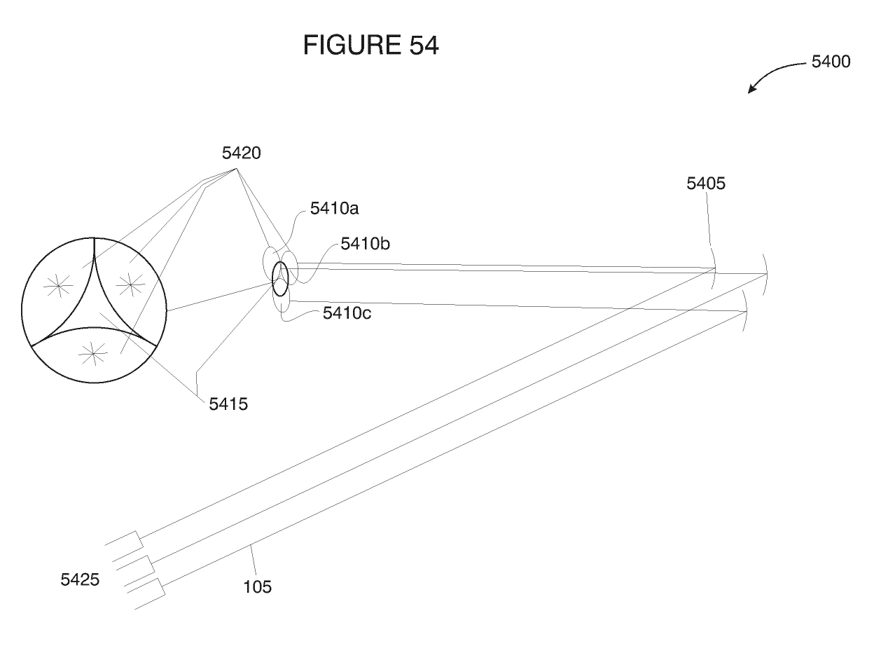

FIG. 54 shows how a similar concept can be carried out in three dimensions, using ellipsoidal reflecting mirrors 5405 (similar to 610) to reflect the oncoming light 105 (harbored in a source 5425 similar to 5010) to focal points 5410a-c (similar to 120), blending 5415 the light (essentially because the eye cannot distinguish colors 5420 (similar to 5310) from an apparent mixture 5415 (similar to 5305) at that size).

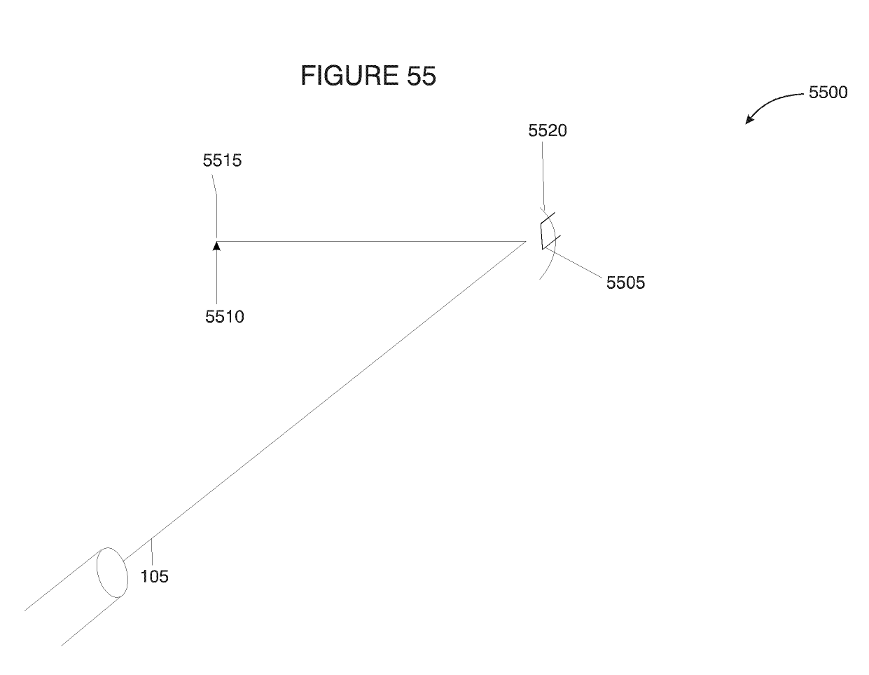

A potential improvement, and possibly even a cheaper alternative as it could require fewer devices for one point of color, would be to allow the color to combine on 5505 the converging surface, shown in FIG. 55. With a source like a laser triplet reflected off of an ellipsoidal converging mirror 5520 (similar to 610), the angle of difference to the point of convergence on the face should be almost unintelligible; correcting plates could make it perfect. If the color is combined on the converging device 5505, an illuminated convergence point 5510 (similar to 120) will be the color 5515 (similar to 5310) rather than a blended illusion.

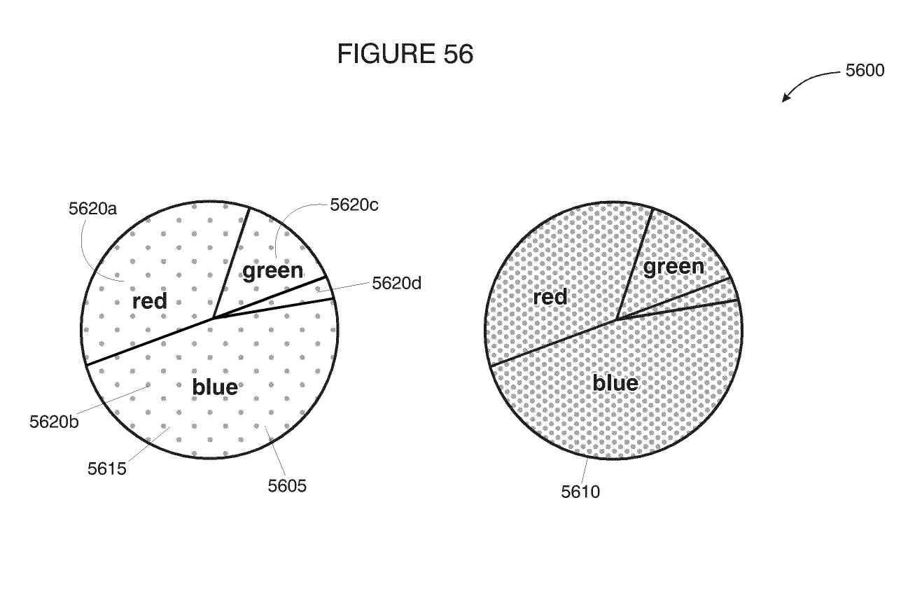

The ratio (of red 5620a, blue 5620b, green 5620c, other 5620d) will produce the color 5615 (similar to 5310) and from there the volume of light emitted (flux, intensity) 5605 can be amplified 5610 for brightness (illustrated in FIG. 56). (Intensity×color=brightness.)

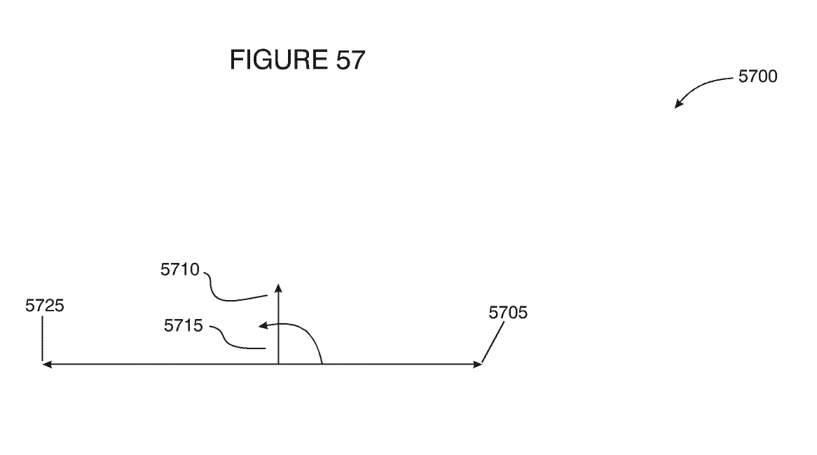

White 5725 is the ratio of equal parts of red, green, and blue, or magenta, teal, yellow, or permutations of these frequencies as represented by the color circle. Black 5705 is the absence of light, represented in FIG. 57. Intensity increases 5710 (similar to 5610) and decreases 5715 (similar to 5605) along the axis 5720 (similar to 5310) between white 5725 (similar to 2130) and black 5705,

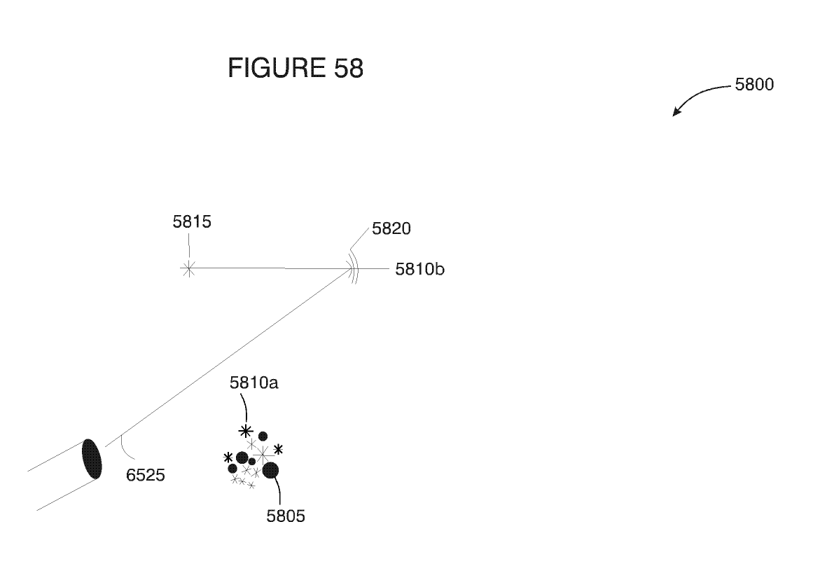

In FIG. 58, black 5805 and white 5810 pictures can be composed by combining colors in this manner, at relative intensities, or by a separate source whose entire function is to produce white light 5810a-b (similar to 2130). Laser light 5525 is reflected from an ellipsoidal converging mirror 5820 (similar to 610) to a focal point 5815 (similar to 120).

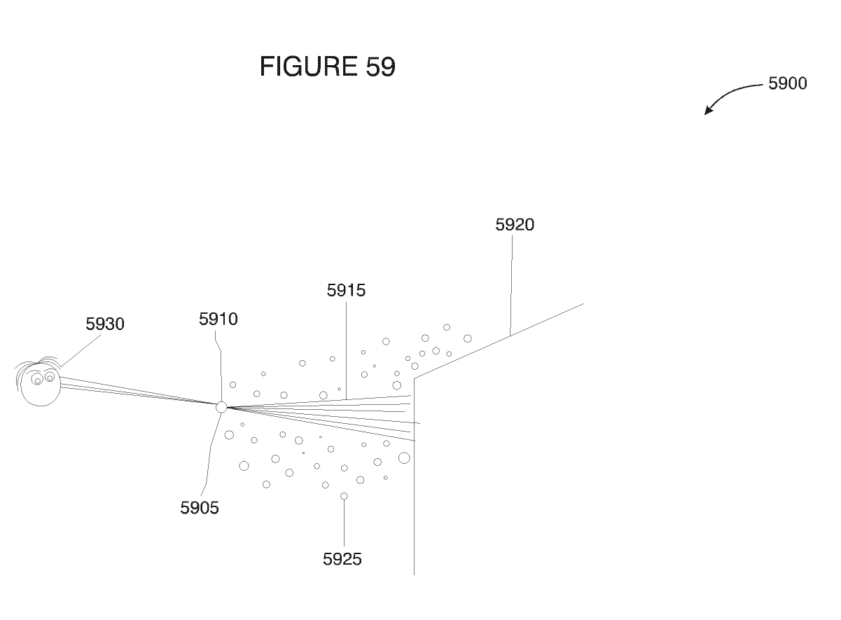

A point of convergence in a medium such as a vacuum would not be visible, but there are several ways the converged light could get to our eyes. One way could be reflection 5905, as shown in FIG. 59. If visible light were to conically converge 5915 (similar to 1205) to a point on a piece of paper, the convergence point would be seen on the piece of paper. Using this property, the point of convergence 5910 (similar to 120) created by a screen of optical devices 5920 (similar to 5015) could also be seen though a field of particles (on the order of or greater than an angstrom so the colors are reflected without bias) like concert haze 5925, which is known to illuminate a light beam by causing reflection 5905 into the eyes of its spectators 5930.

FIG. 60 shows that the light from convergence devices 6020 (similar to 5015) (displaying conic convergence 6010—similar to 1205) will also illuminate through a transparent solid, littered with small reflective aspects. Bubbles of a separate medium 6030 throughout the solid will reflect 6035 at the interface with high enough indices between the two mediums. The solid may take the form of a transparent gelatinous body as well, where simple gas bubbles might compose the second medium 6030. Another alternative is if the second medium 6030 were more sensitive to the converging wave, and can be heated 6005, red, blue, green, and white hot at the point of convergence 6015 (similar to 120) depending on the frequency of the light converging, the intensity and also of what material 6030 is being ‘heated’. Specific points in the material can be made color dependent as well. A small cluster might be composed of bubbles of gases that will each turn a signature color, one red, one yellow, and one green, when exposed to that photon intensity. Close enough clusters would still produce a very continuous image.

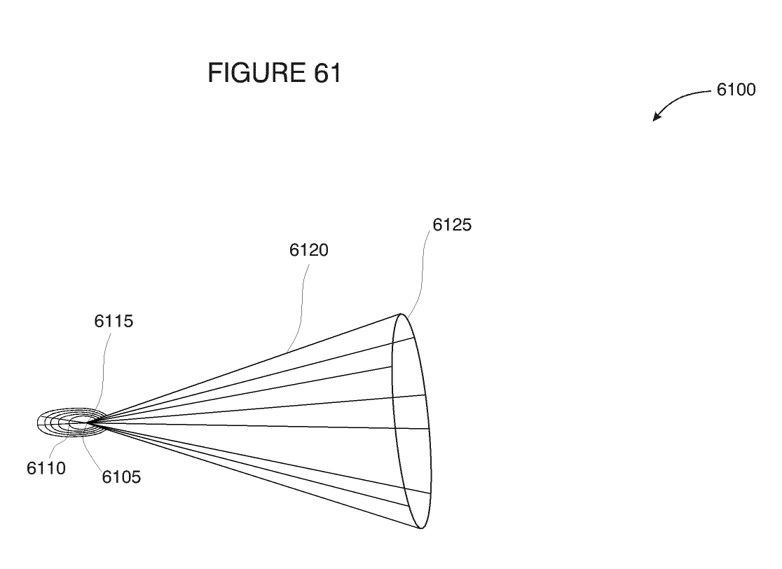

FIG. 61 shows the idea that because there is a strong conical convergence 6120 (similar to 1205); the density of the photons at a point will be raised at a point 6115. Another method to cause us to see the point of convergence 6115 is one where our process knocks free electrons to higher states 6110 in their molecules. As they fall they emit light 6105. The state it can rise to and fall from, and/or the molecules interacted with, will be frequency dependent and in this way color as a final product of a reaction, can be created indirectly by the initial frequencies being converged.

The haze 5925 has been tested safe to be free to float in the room and will dissipate quickly after use without harm. Other methods may be contained in a case or in a solid.

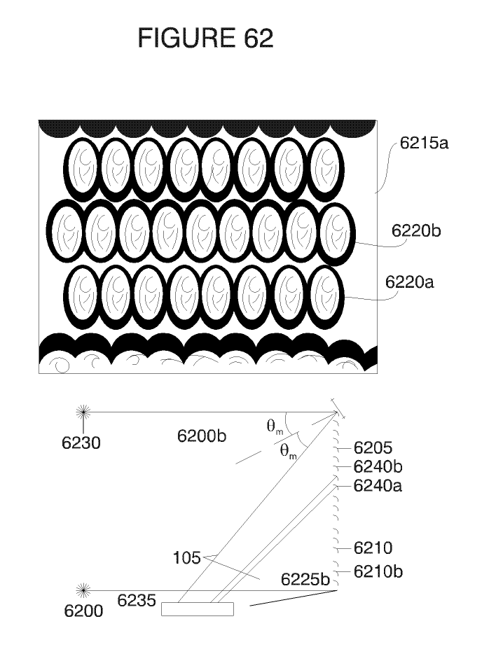

FIG. 62 shows a possible screen formation (oval faced, non-corrected light path). A screen 6215a-b (similar to 5015) of converging devices can be placed anywhere communicable with the light source 6235, which could be inclined. The screen could comprise ellipsoidal mirrors 6220a-b as reflective converging devices 6240a-b (similar to 610) that are more 6205 or less 6210 angled (theta m 6225, similar to 805) to create a given focal point 6230 (similar to 120). Two obvious positions would be vertical (FIG. 62), nearly perpendicular to the source/sources, and behind or in front of the medium, depending on the device, or on approximately the same plane as the source/sources, or in front of for refractive convergence, but beneath the medium, like in FIG. 60. There are many other likely formations. Methods like the polarization or prism obstructions can isolate multiple equipotential ring segments for convergence at one time. If the devices are forming the three dimensional picture from beneath, it is obvious where there might be two points on the same line of convergence. Either a rapid succession of like convergences, or a method of producing multiple points of convergence along one line, can produce this result. The screen beneath the medium opens a more full picture than a back screen resting on the floor because the viewer is free to view a new view all the way around and above, from profile back to front and such assuming the information is there to create the image. It will provide a different image to the person standing and looking down on some aspects, than the person sitting. Virtual images do not innately have the freedom to walk around to a new profile beyond certain boundaries of the screen containing the virtual image. This freedom in viewing would be of great help to the promotion, scientific, medical, architectural, and teaching communities.

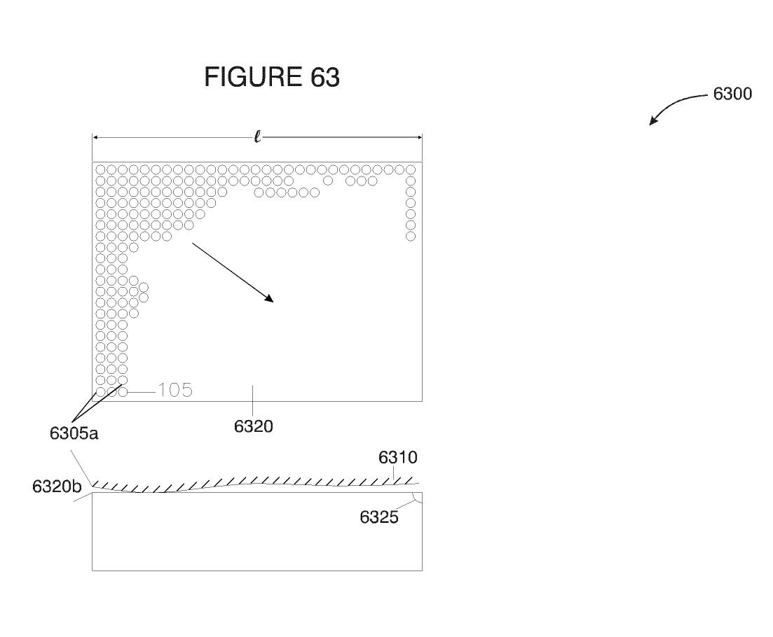

FIG. 63 shows laser triplets as potential source and source formation. If there are many sources, like the laser triplets 6305a-b arranged in a bed 6320a-b (similar to 5010), they can be sloped to keep them from interrupting each other and if aiming at a vertical screen of devices, they can be angled towards their device or reflecting plate. The sources 6310 intended for the lowest devices 6210, possibly nearest to the device for lack of collisions sake, will be the least angled from the horizontal, while those sources 6315 intended for the top devices 6205 will be angled furthest from the horizontal, either at the source, or the reflecting plates if available. The sources can be kept in a container incorporating an incline angle 6325. This will lessen the necessary degree of rotation each source will have to individually undergo. If the reflecting plates are in use they will direct the light right into a frontally symmetric device. Because of the plates the devices no longer need to slant downwards towards their midpoint between their source and projection, as the final line of source is direct.

To prevent obstructions, the horizontal device formation can be positioned such that they are faced to produce an upright line of convergence, but graduate in an inclined slope like on stairs, so they can communicate uninterrupted with the source/sources.

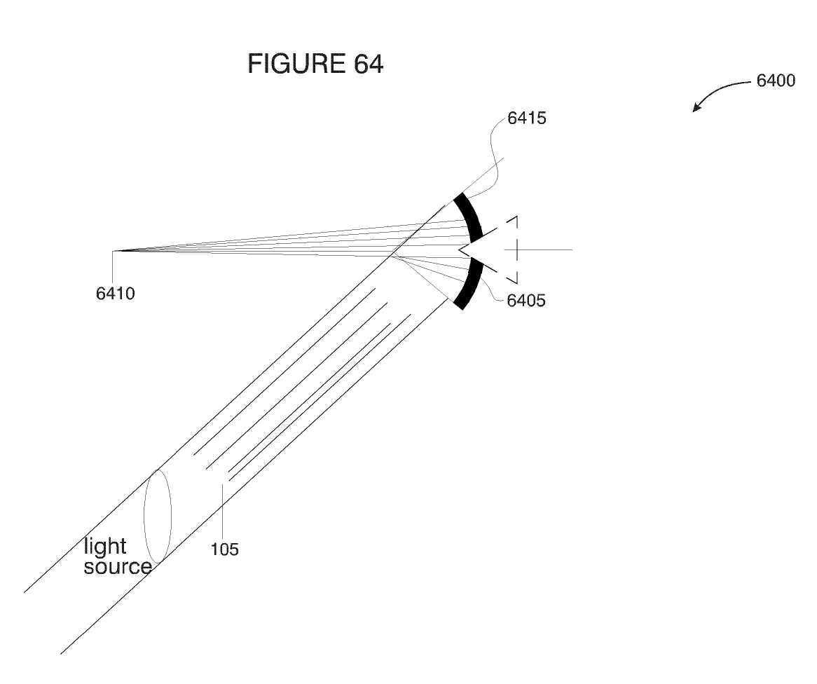

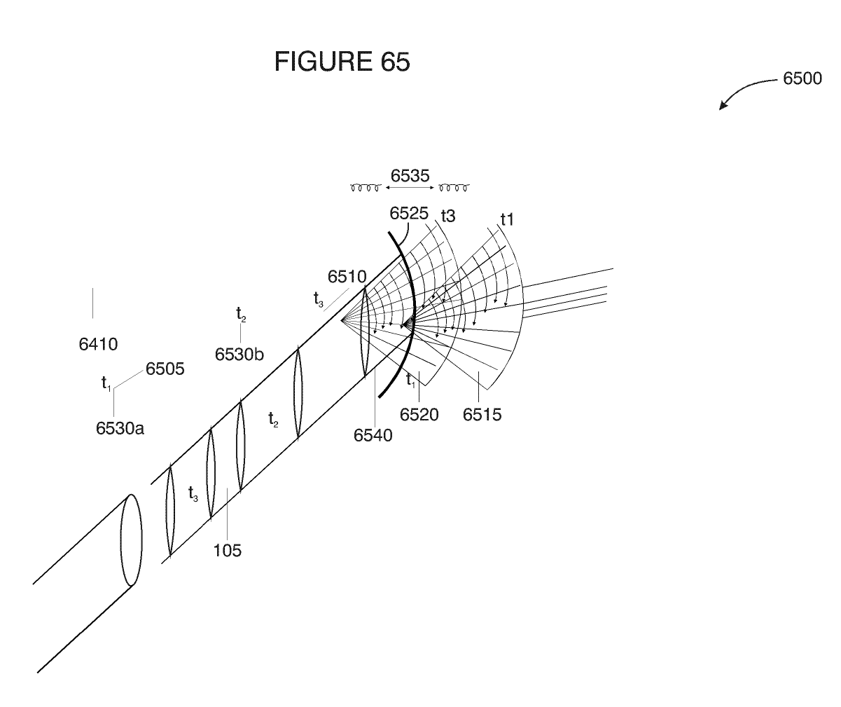

There is then a choice to focus the light 105 by the devices at certain specified points for some time, as shown in FIG. 64 (light 105 is reflected from an ellipsoidal converging mirror 6415 (similar to 610) to a focal point 6410 (similar to 120) determined by the position of the absorption cone 6405), or to let the device augmentators run cycles 6535, emitting the source 6540 at the part of the cycle 6515 when it would converge at the desired point 6530a (similar to 120) as shown in FIG. 65. At time “t1”, the absorption cone is positioned 6515 in the ellipsoidal converging mirror 6525 (similar to 610) so that light emitted at time t1 6540 will converge at focal point 6505. At time “t3,” the absorption cone is positioned 6515 in the ellipsoidal converging mirror 6525 to create focal point 6510. At time “t2,” midway between times t1 and t3, light 105 will converge at focal point 6530b.

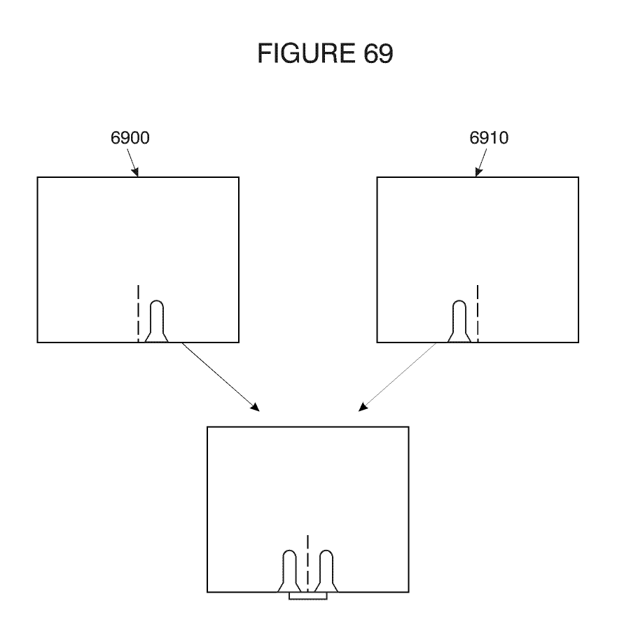

FIG. 69. We know the fraction of the surface rotated to perpendicular polarization omission, or prism discontinuity, or aperture opening or absorption insertion (and other such methods of isolating particular points of convergence) will produce a point of convergence at a given depth by equation. These points can either be programmed to have information in three dimensions or a dual or tri-image subtracting camera will give these points information which includes a particular point's depth. The distance between a point on a picture taken by a lens at one position 6905 verses another 6910 dictates the level of depth, again by parallax. So from the subtraction of the images 6915 from the cameras optimally positioned in a triangle for ease and completeness, it can be known how to alter which devices. Sound can be added to the moving images by traditional methods. Sound could also be added at a point if the idea of isolating a continuous line of convergence is carried over to sound waves. The reflective medium would need to reflect sound waves, and the absorption, that which absorbs sound. It can be applied to any point if its source and convergent device rotate together, swinging the line of convergence, but not altering the angle between the source and the device, thereby not necessitating any change in the shape of the device.

In general, to build the reflecting surface, a curved surface produces a clearer image but a nearly perfect image can be constructed by organizing flat reflecting segments along the equipotential rings and letting the central point of each flat segment angle itself towards that equipotential ring's particular convergence. A continuous line of convergence that can be manipulated to focus at specified points can be used in industries from entertainment to medical. Convergent devices that cause continuous convergence, and by methods of augmenting that continuity, the information for depth can be carried out with real visible images. This allows for the creation of such devices as three-dimensional theatres. This technology could also be used to create toys like light sabers. It could be used for architecture programs, allowing the builder to see what the product would actually look and fit together like. In the toy industry, toys like light sabers could easily be constructed by manipulating either an oblate ellipsoid reflective device or a double convex oblate lens, so that reflected light would stop at a length. Such toys would produce visible beams of light with the help of some final medium like a small quantity of haze 5925. Parallel or non-parallel light could be made parallel, and then reflected or refracted through the convergent device to produce the specified domains of a saber's light rod. Fountains, made of light converging to various heights from various points could make for a pleasant decorative element. Again, there would be some way to visualize the convergence points, likely depending somewhat on the aesthetics. The lens could be used in ovens to heat at various depths, or to rotate heat throughout cooking. As a communication tool, it could be used for a short range code. Say perhaps that the receiver knows ‘a’ is some specified depth; ‘b’ is at another specified point and so on. This code would be very difficult to intercept and understand from anywhere other than where it converges to, offering a very unusual protection. In the medical industry, such as the manipulatable, continuous converging lens, would be more precise for laser surgery. Current tactics generally involve lining up four lasers to cross at some desired depth, neither ensuring the proper depth, nor offering a strong convergence considering the number of lasers.

It could also be used for a measuring device. The convergent points could be set to say, six, each one foot apart, so a carpenter or a yard designer would be able to know and dictate proper spacing. As a measuring tool, it is not even necessarily the case that the convergence would need to be in a final medium, if the user decides to use the material he is working as the surface for final convergence. Utilizing strong enough lasers, it could be used as a precision cutting tool, carving out shapes in three dimensions. Multi-focus eye wear could be created out of this viably convergent lens, potentially helping people blinded by cataracts. As a learning tool, letters in words, and numbers in equations, could have shape to help children visualize the problem. It could be used to check the shape of something like a tooth by setting a series of convergences outlining the shape. Then, if the tooth or object obstructs the convergent point, making it visible, that visible point might be out of alignment. For quick construction, demo-models. As a safe and accurate pole- vaulting/high jump bar. Non-destructive depth sculptor, carve of the center of semi transparent objects, allowing them to float, or be hollow candy.

A multi-focal apparatus is a lens or mirror that can cause a parallel source to converge to more than one point. For a static multi-focal lens, this is possible because certain portions of the lens are stronger or than other portions. When the source passes through the strong portion of the lens, it can converge right away to a focal point near the lens. When the source passes through a weaker portion of the lens it can converge more slowly to a point much further from the lens. By choosing through which portion (or portions) of the lens the source will pass, the focal point(s) can effectively be determined.

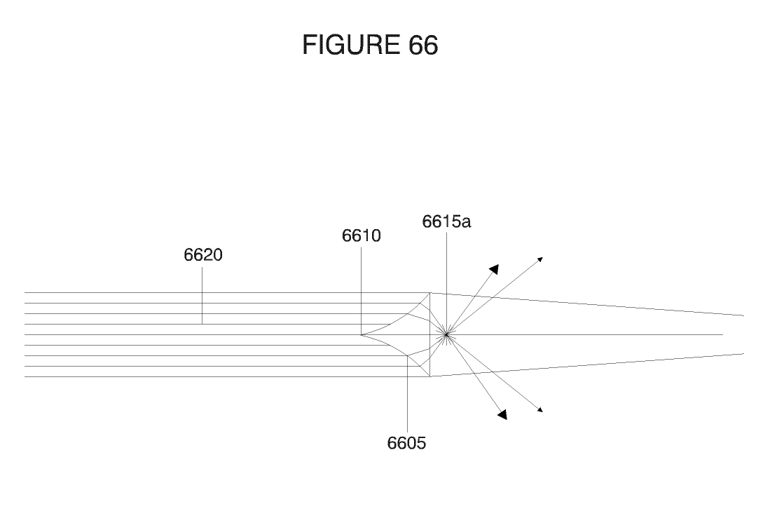

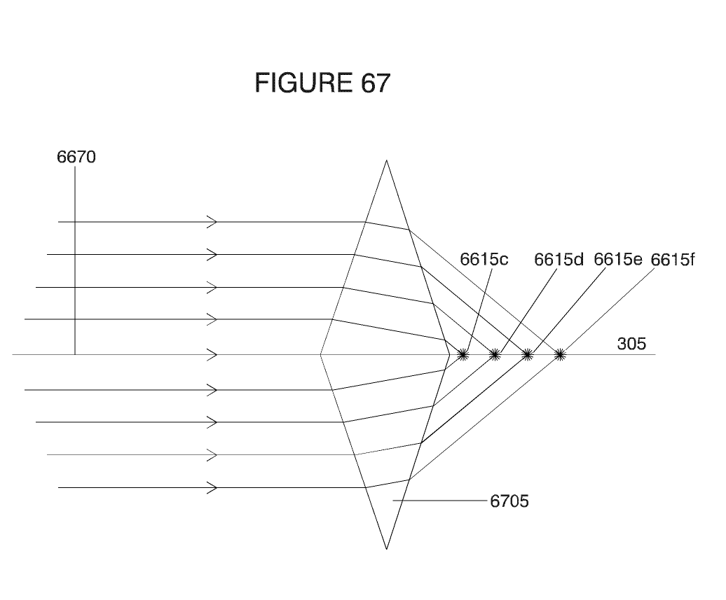

Multi-focal lenses are any continuous or discontinuous medium that causes the refraction of a parallel electromagnetic source to more than one focal point. Multi-focal optical tools can be used singularly or in combination with other devices. FIGS. 66-67 describe two such lenses. The Double Convex Oblate Spheroid 4605, the Eiffel Planar 6605, and the Double Cone 6705 are examples of lens shapes that refract a light source 6620 cause a continuous line segment of focal points 6615a-f along the convergence horizon 305. Note that the region 6610 at the tip of the Eiffel Planar 6605 will probably cause reflection due to its steep angle.

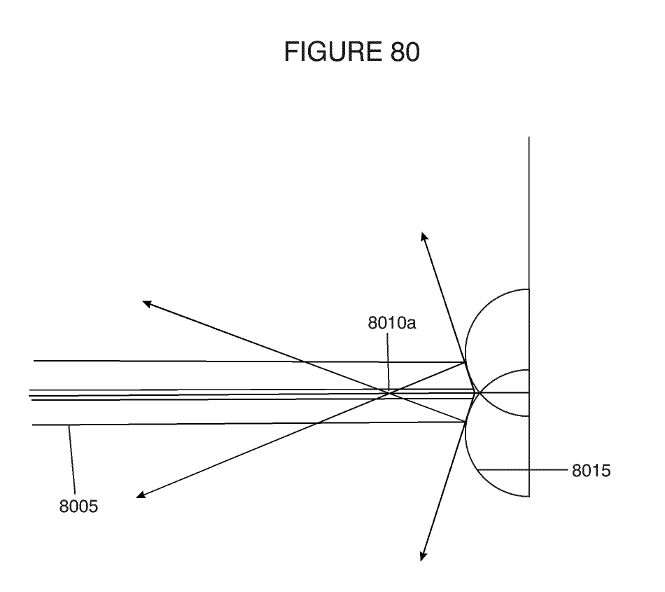

Multi-focal mirrors are any continuous or discontinuous surface of reflection that causes parallel light 105 or other EM wave to converge to more than one focal point 120. Reflection from the inside of an Oblate Ellipsoid 605, from the inside of an Isosceles Cone 7005, and from the face of a Convex Closed Funnel 8015 in FIG. 80 are examples of mirrors that cause a continuous line segment of focal points 120 along the convergence horizon 305.

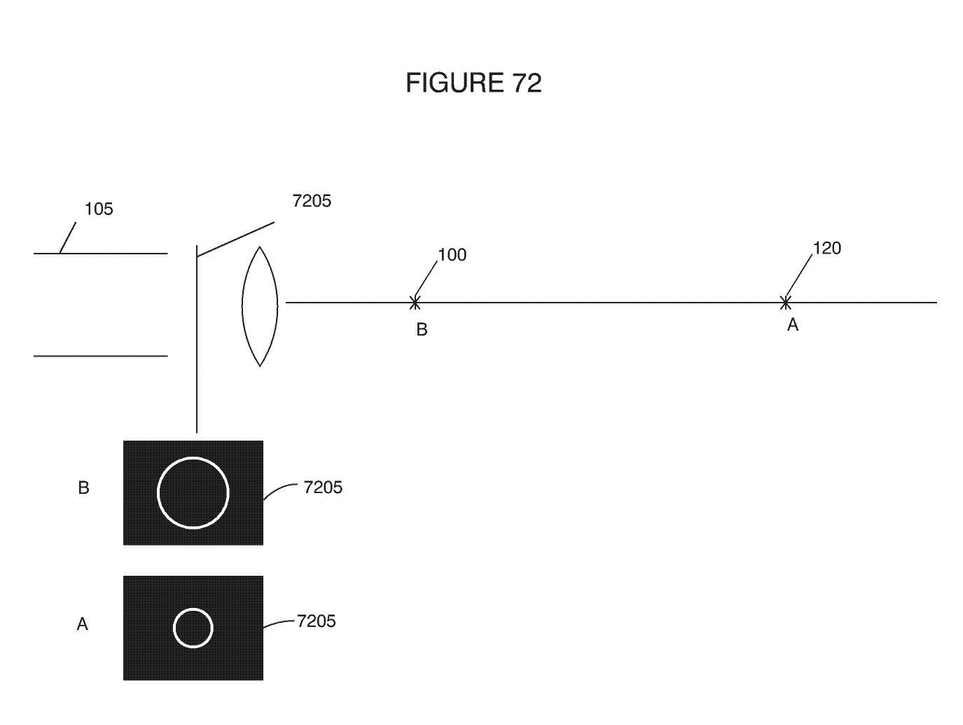

FIG. 72. The various portions of the converging apparatus 6820 can be isolated for use through various methods from regulating the source 105 itself, to obstructing the converging apparatus 6820 with such as a concentric pixeled black and clear LCD 7205. Obstructing appropriate portions of the source cylinder 105 can exactly correlate to the effects produced by obstructing the converging apparatus directly. Any other possible method to distinguish portions of the converging apparatus in order to decide and/or vary focal points 120 is considered a focal point arbitrator 6805. The arbitrator can be placed after the convergence apparatus 6820 so long as the effects of convergence are taken into account.

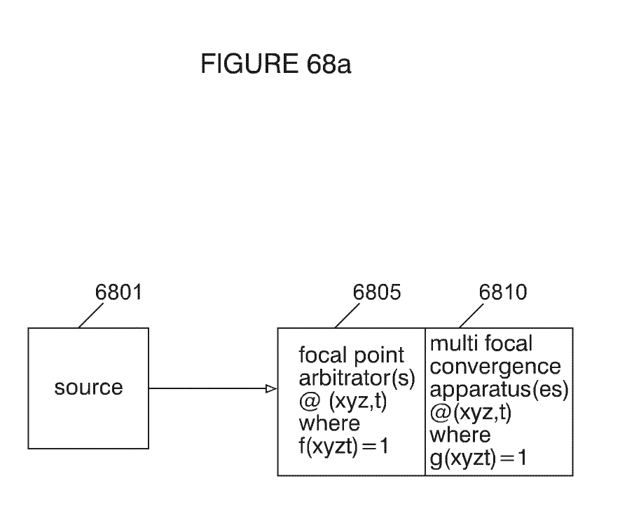

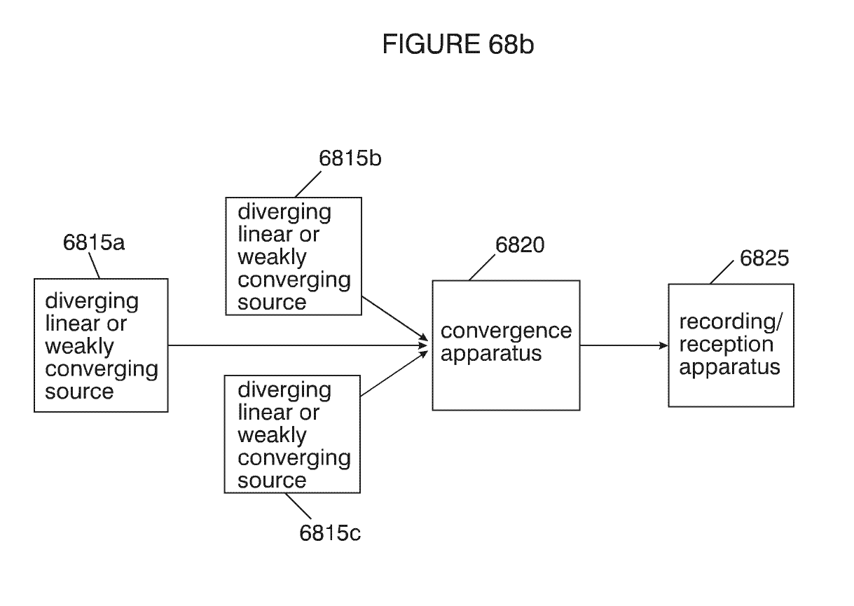

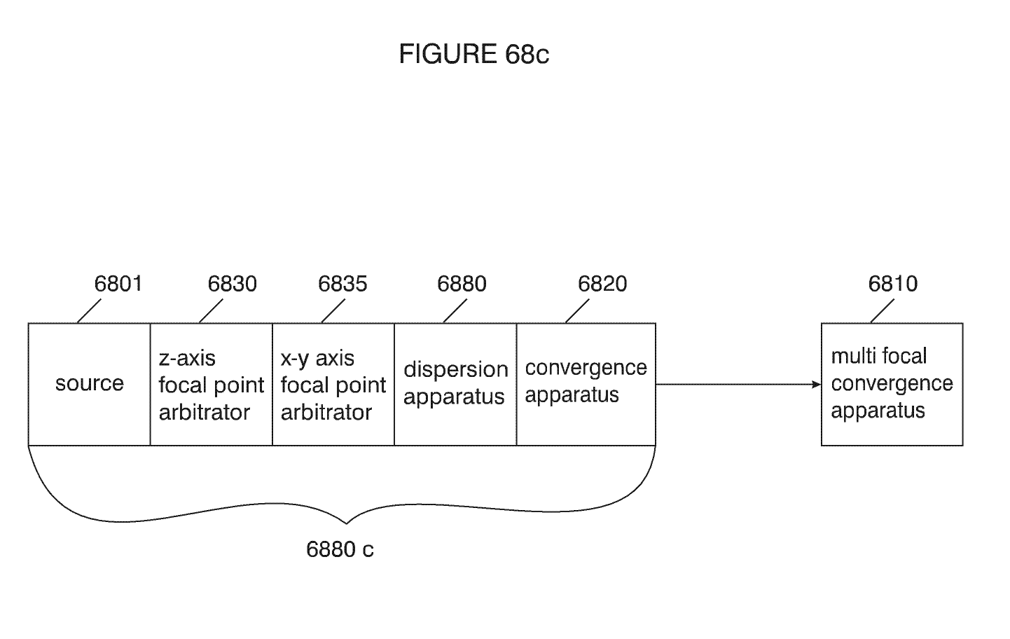

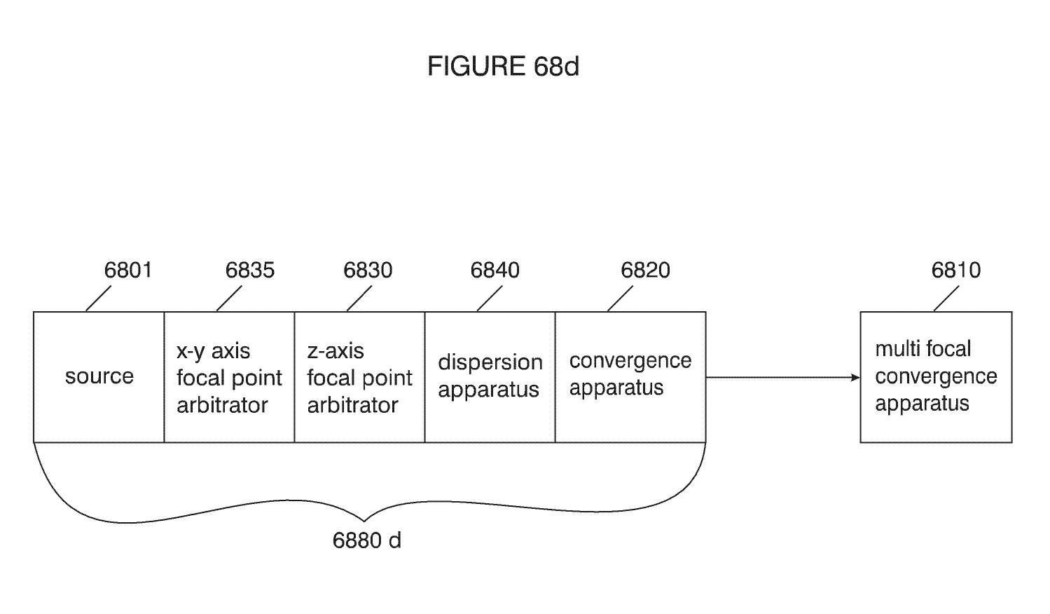

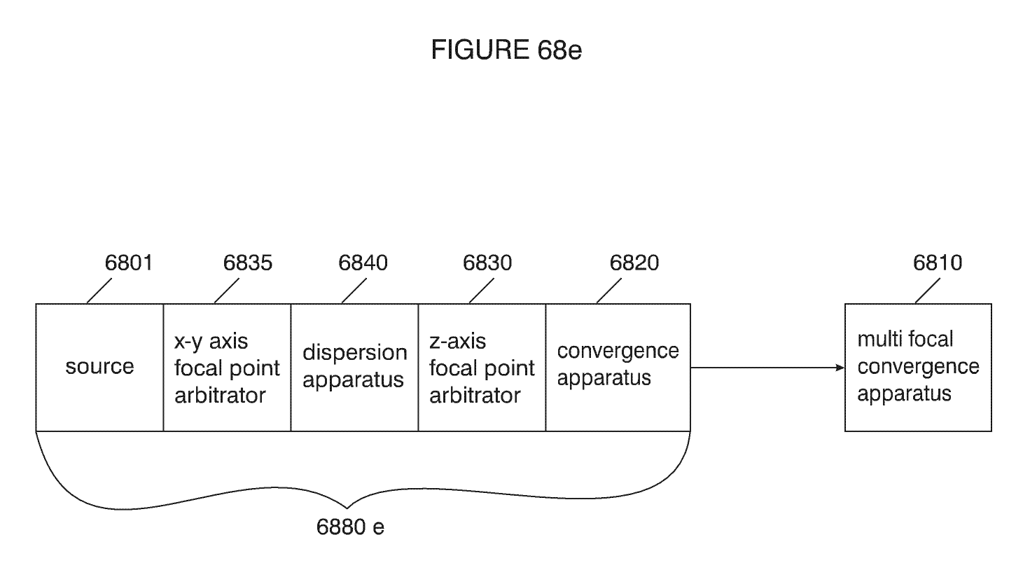

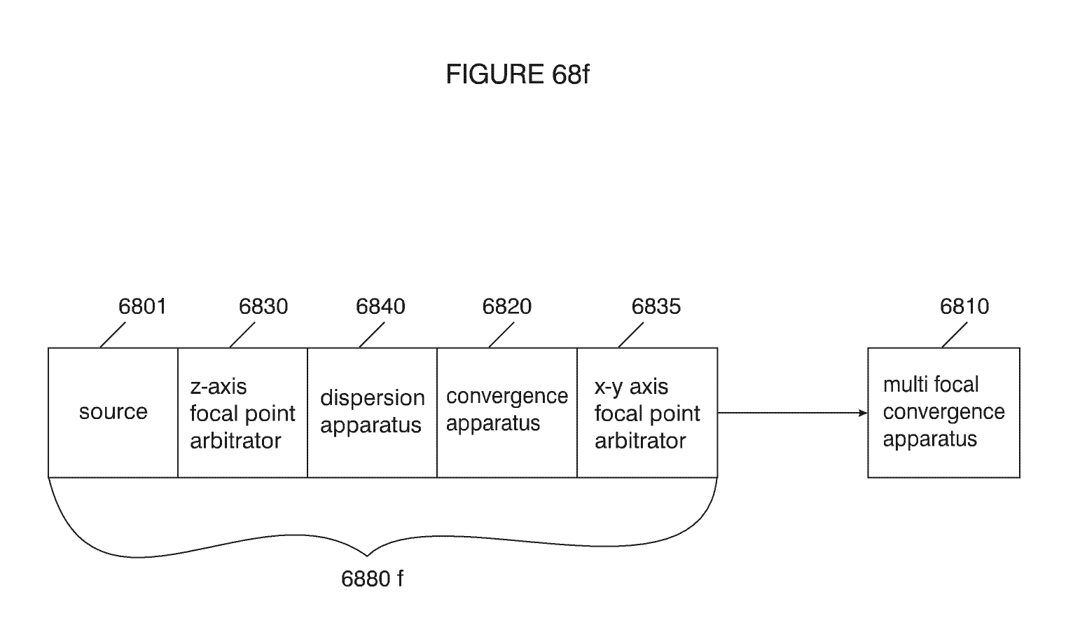

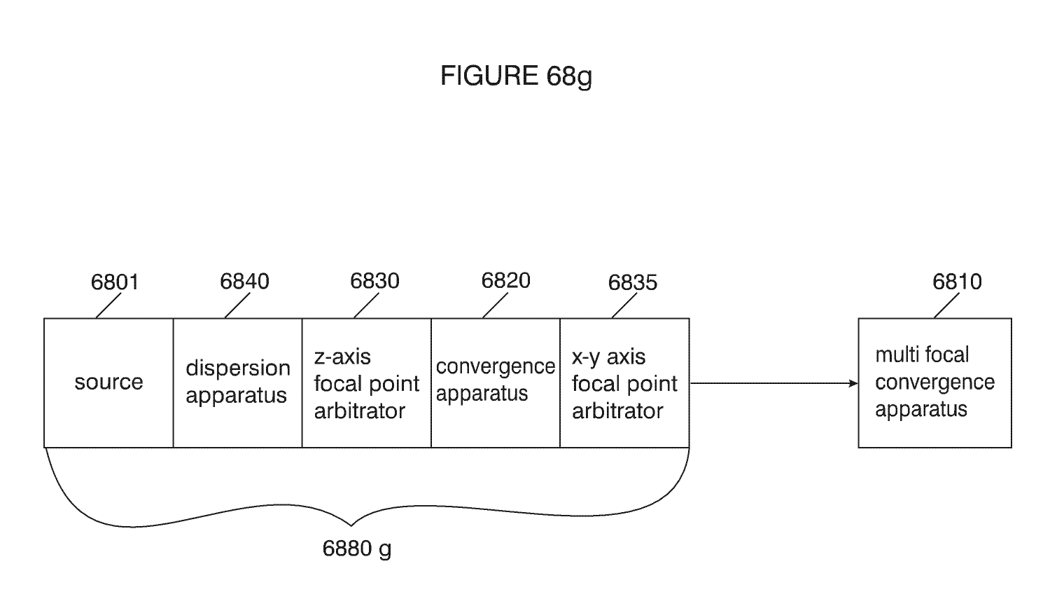

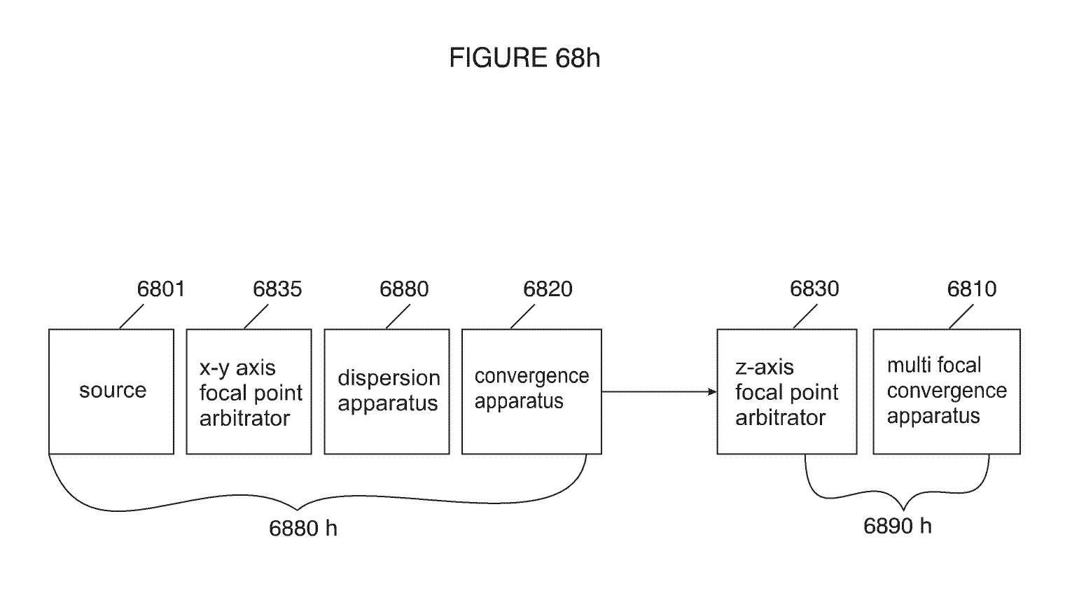

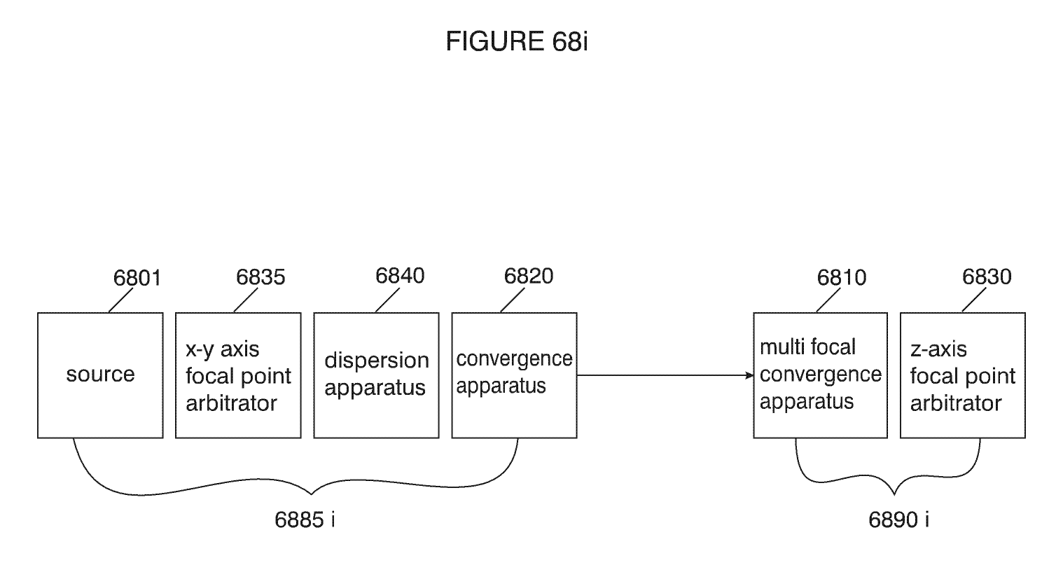

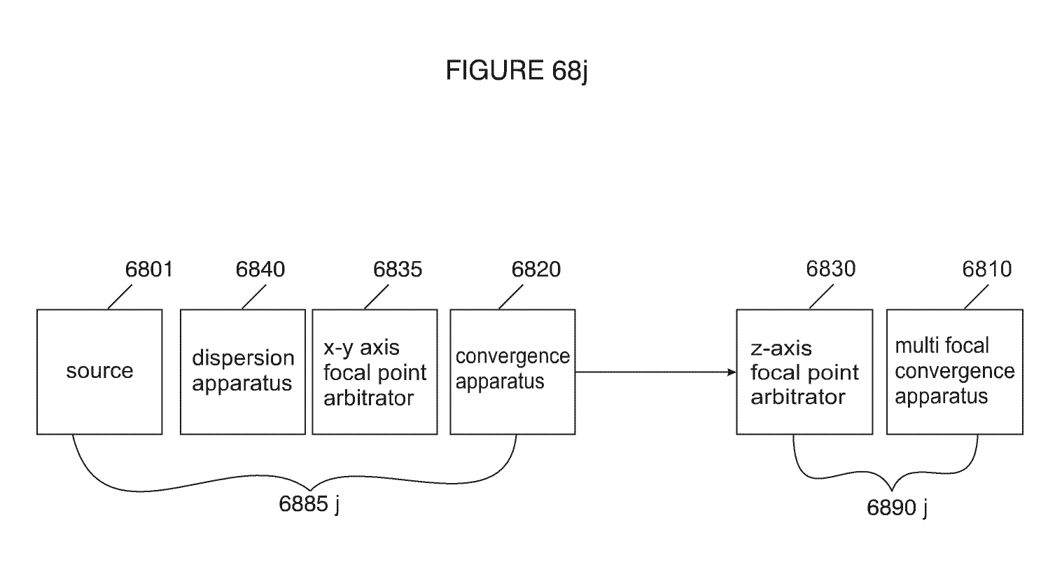

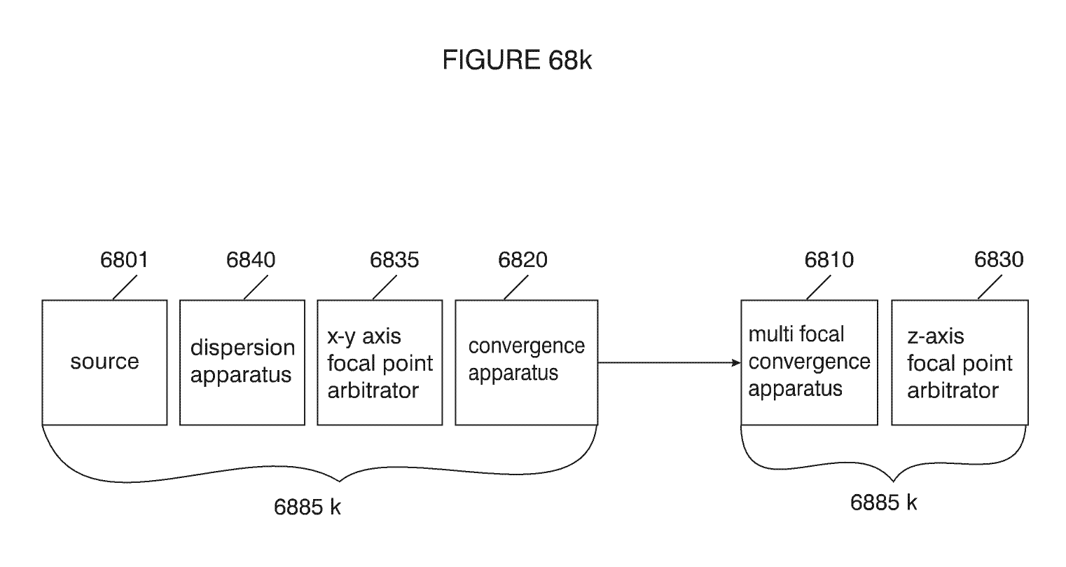

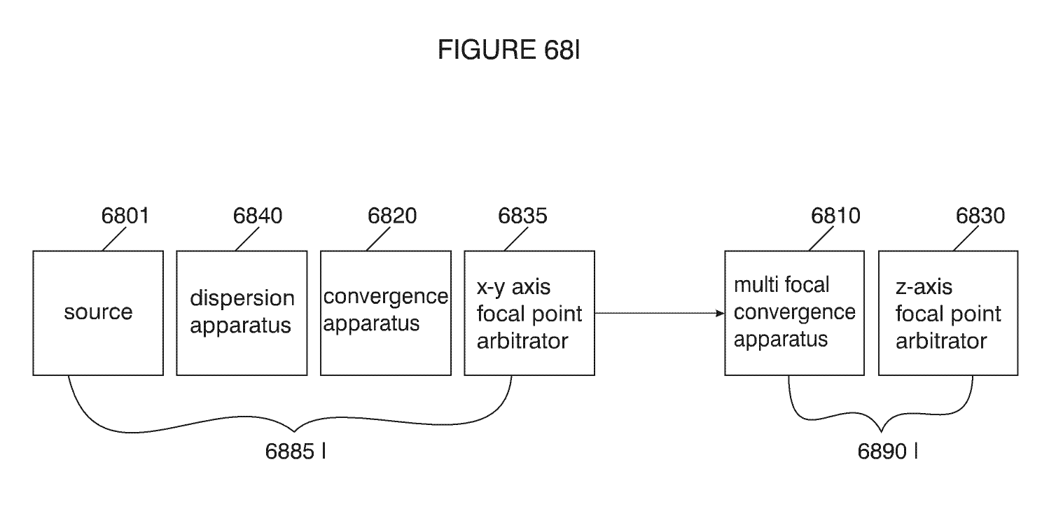

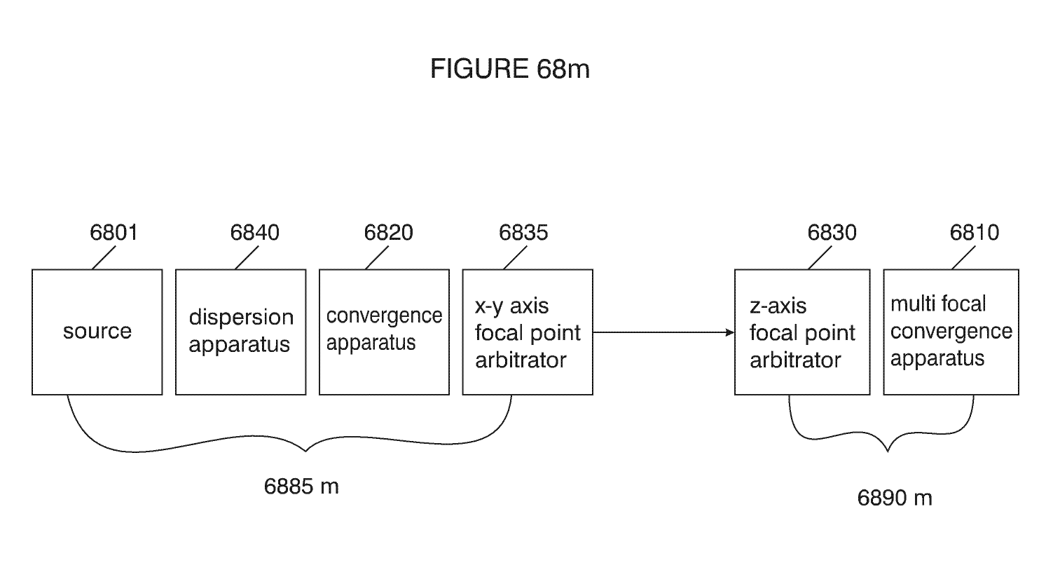

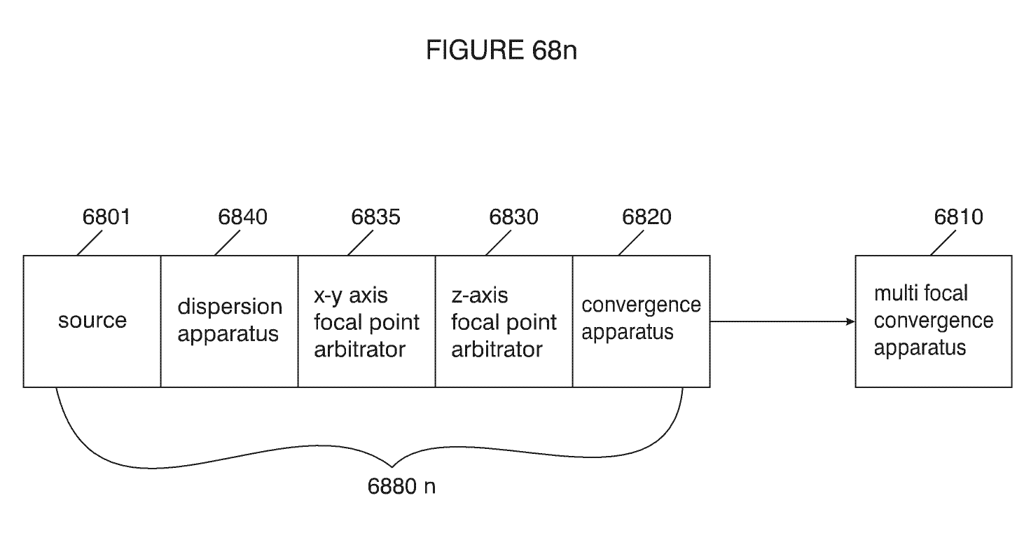

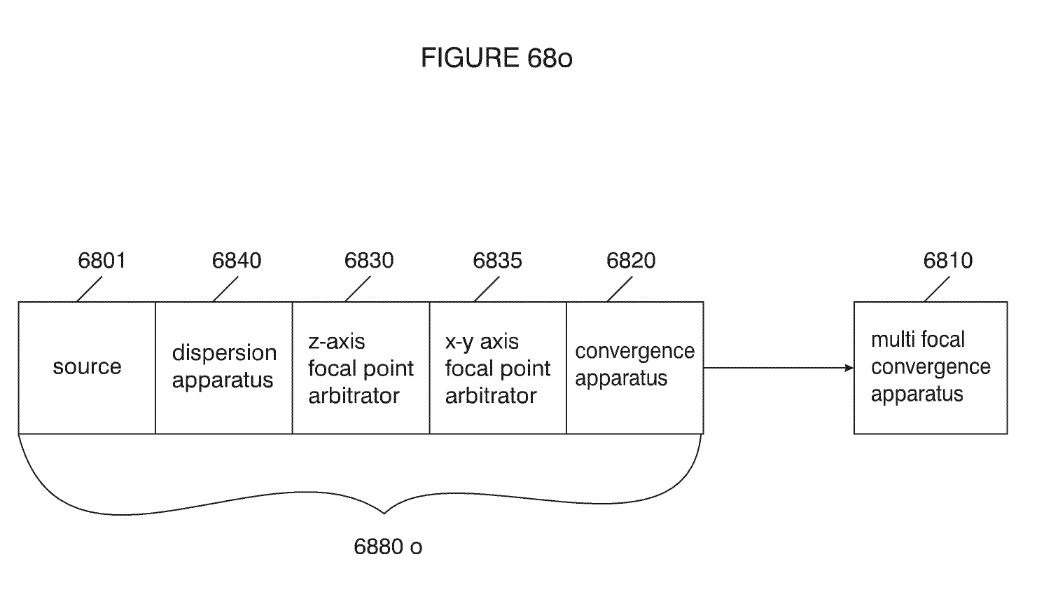

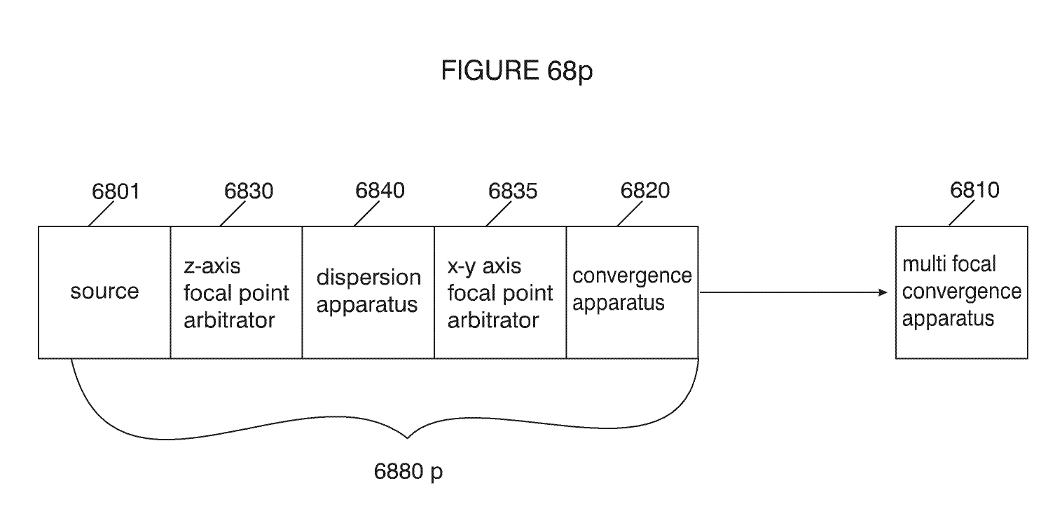

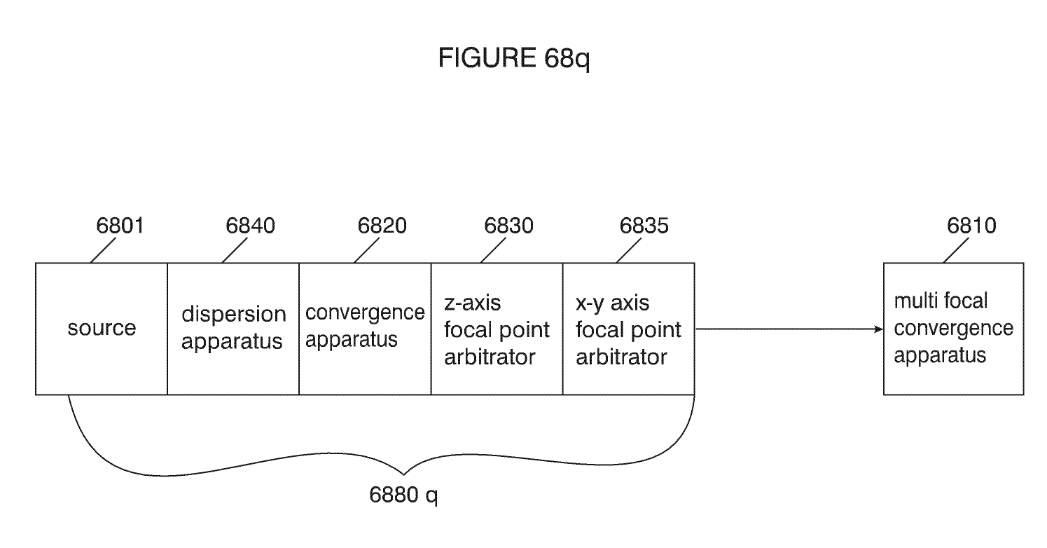

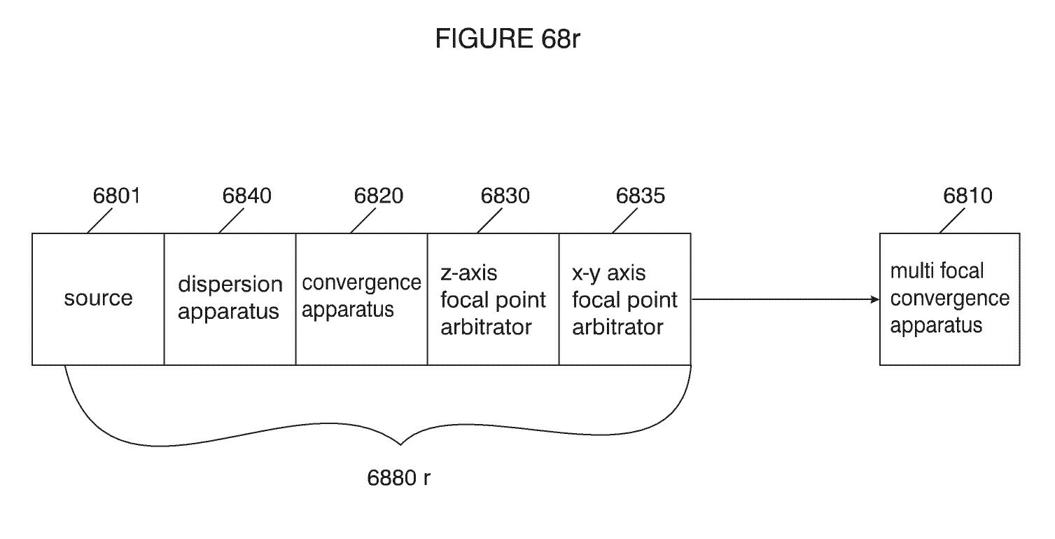

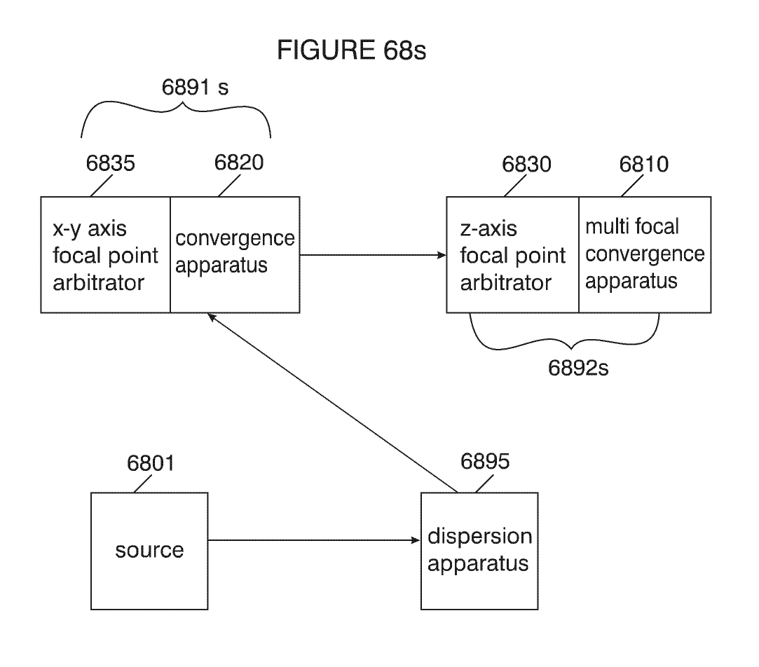

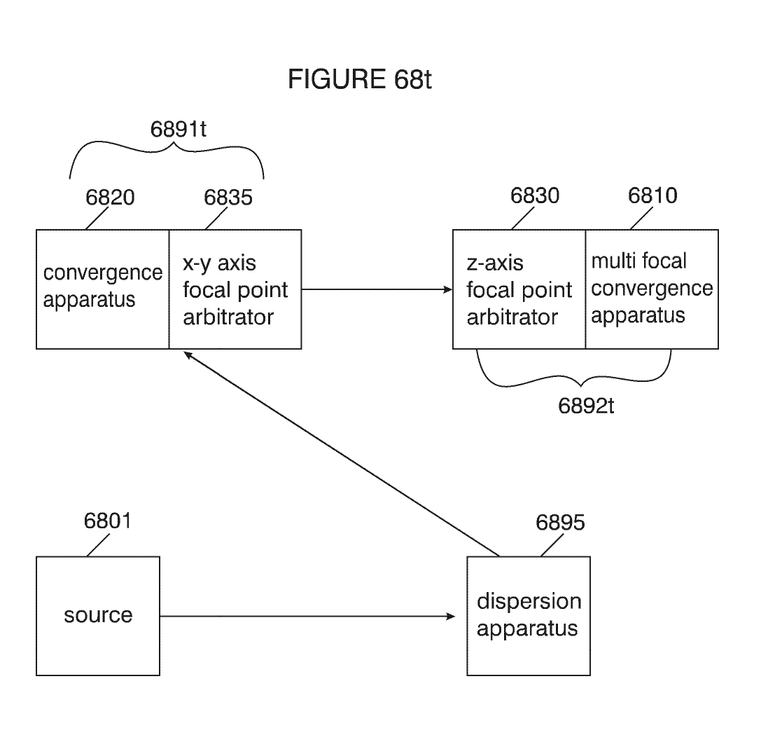

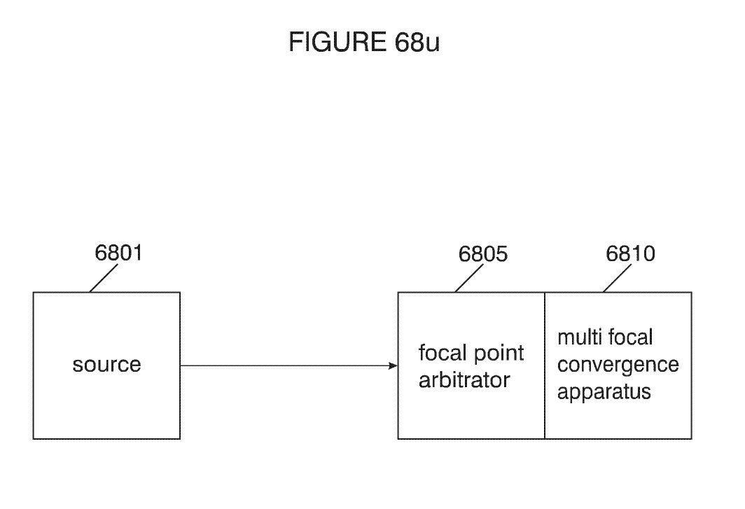

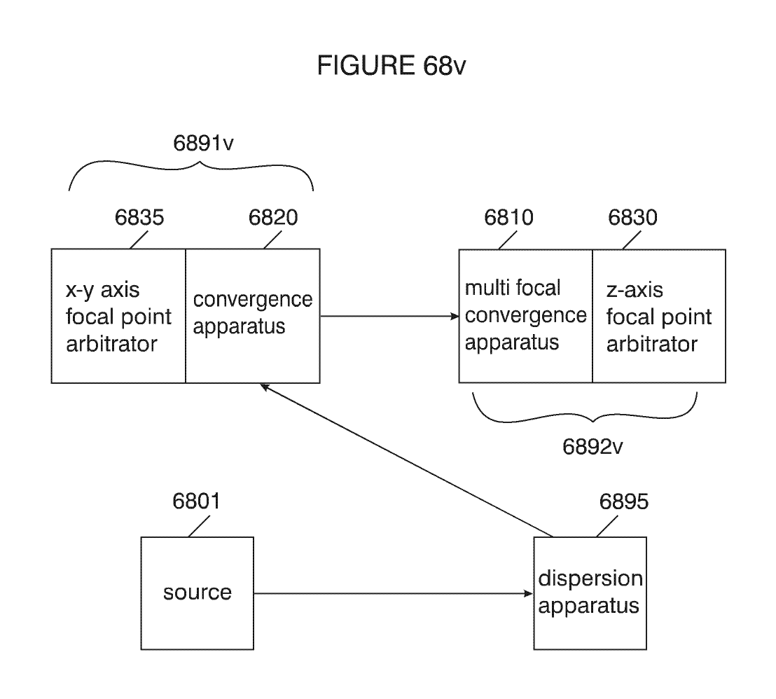

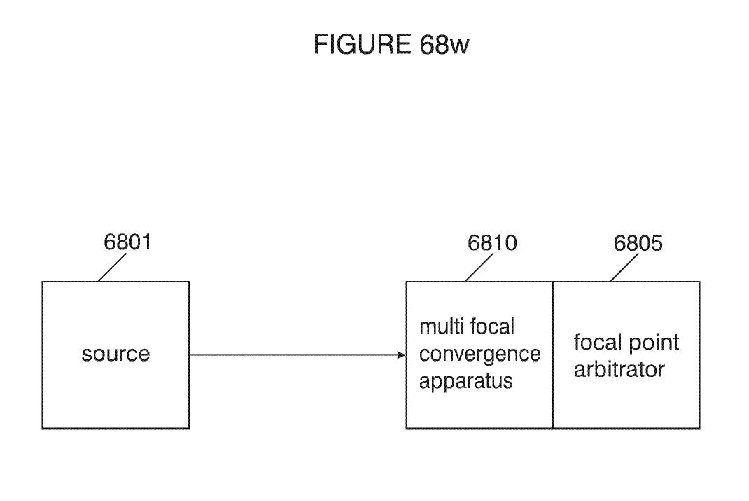

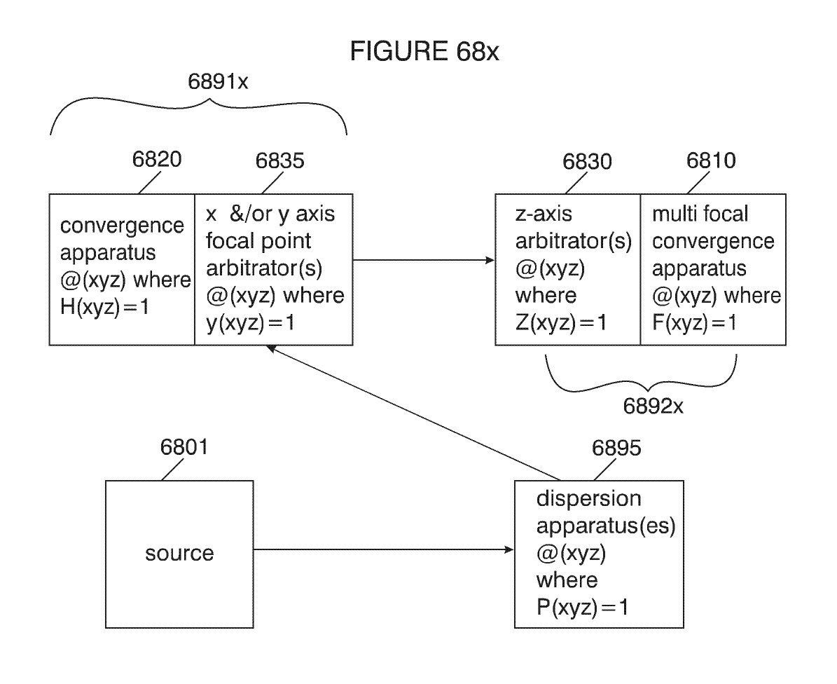

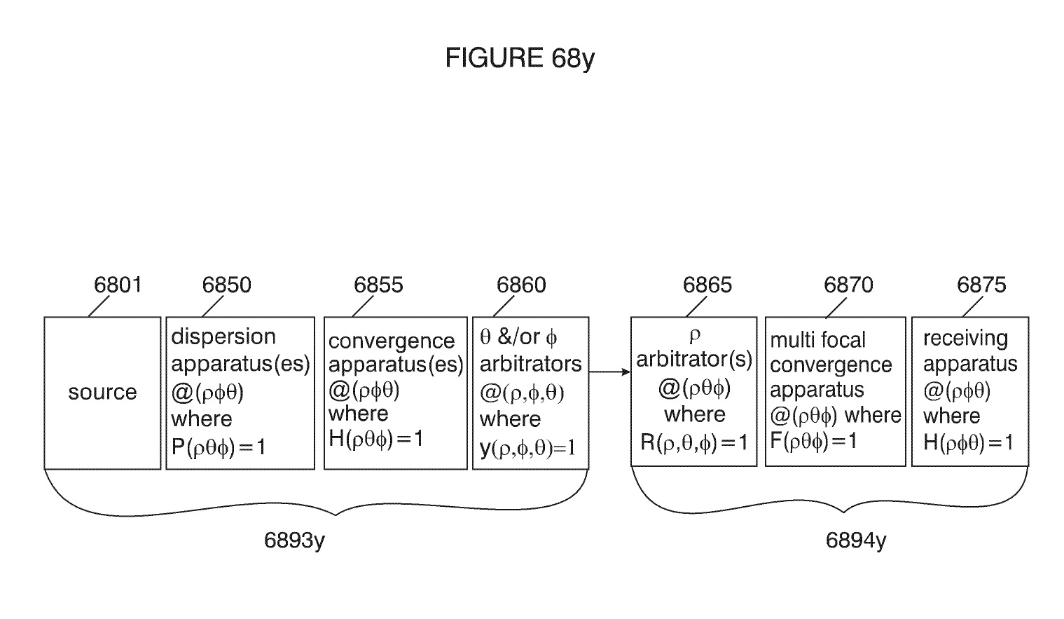

FIGS. 68a-z show that multiple sources 6815 6801, converging apparatuses 6820, arbitrators 6830, 6835, dispersion apparatuses 6840 and other tools can be used in combination at the engineers' discretion as these different combinations are found more suitable to achieving their end(s). A dispersion apparatus is a lens 6840 or mirror 6895 that causes dispersion of the light source to the various X-Y positions. The entire source can be dispersed simultaneously through reflection from a convex mirror 6895, transmission through a concave lens 6840 or specific reflection of the source to dissimilar positions on the X-Y plane. In these figures, arrows represent light traveling between combinations of tools. The order of these parts can be determined by the operations they are being used for.

FIG. 68a shows a source 6801 transmitting light to a combination of two tools: focal point arbitrators existing anywhere in the (X, Y, Z, T) continuum 6805 and multi-focal convergence apparatus existing anywhere in the (X, Y, Z, T) continuum 6810.

FIG. 68u is similar to FIG. 68a, but with the components, focal point arbitrator 6805 and multi-focal convergence apparatus 6810, which can exist at a fixed spot.

FIG. 68w is similar to FIG. 68u, but with the multi-focal convergence apparatus 6810 and focal point arbitrator 6805 in reverse order.

FIG.S 68c-68e, 68n-68r show light transmitted from a combination of five tools to a multi-focal convergence apparatus 6810.

FIG. 68c shows the combination of tools 6880c in the following order: source 6801; Z-axis focal point arbitrator 6830; X-Y axis focal point arbitrator 6835; refracting dispersion apparatus 6840; convergence apparatus 6820.

FIG. 68d is similar to FIG. 68c, but shows the combination of tools 6880d in the following order: source 6801; X-Y axis focal point arbitrator 6835; Z-axis focal point arbitrator 6830; refracting dispersion apparatus 6840; convergence apparatus 6820.

FIG. 68e is similar to FIG. 68c, but shows the combination of tools 6880e in the following order: source 6801; X-Y axis focal point arbitrator 6835; refracting dispersion apparatus 6840; Z-axis focal point arbitrator 6830; convergence apparatus 6820.

FIG. 68f is similar to FIG. 68c, but shows the combination of tools 6880f in the following order: source 6801; Z-axis focal point arbitrator 6830; refracting dispersion apparatus 6840; convergence apparatus 6820; X-Y axis focal point arbitrator 6835.

FIG. 68g is similar to FIG. 68c, but shows the combination of tools 6880g in the following order: source 6801; refracting dispersion apparatus 6840; Z-axis focal point arbitrator 6830; convergence apparatus 6820; X-Y axis focal point arbitrator 6835.

FIG. 68n is similar to FIG. 68c, but shows the combination of tools 6880n in the following order: source 6801; refracting dispersion apparatus 6840; X-Y axis focal point arbitrator 6835; Z-axis focal point arbitrator 6830; convergence apparatus 6820.

FIG. 68o is similar to FIG. 68c, but shows the combination of tools 6880o in the following order: source 6801; refracting dispersion apparatus 6840; Z-axis focal point arbitrator 6830; X-Y axis focal point arbitrator 6835; convergence apparatus 6820.

FIG. 68p is similar to FIG. 68c, but shows the combination of tools 6880p in the following order: source 6801; Z-axis focal point arbitrator 6830; refracting dispersion apparatus 6840; X-Y axis focal point arbitrator 6835; convergence apparatus 6820.

FIG. 68q is similar to FIG. 68c, but shows the combination of tools 6880q in the following order: source 6801; refracting dispersion apparatus 6840; convergence apparatus 6820; Z-axis focal point arbitrator 6830; X-Y axis focal point arbitrator 6835.

FIG. 68r is similar to FIG. 68c, but shows the combination of tools 6880r in the following order: source 6801; refracting dispersion apparatus 6840; convergence apparatus 6820; X-Y axis focal point arbitrator 6835; Z-axis focal point arbitrator 6830.

FIG. 68b shows three diverging linear or weakly converging sources 6815a, 6815b, 6815c, transmitting light to a convergence apparatus 6820, and transmitting light to a recording/reception apparatus 6825. While FIG. 68b shows as an example three sources 6815a, 6815b, 6815c, any number of sources may be used.

FIGS. 68h-68m show a combination of four tools transmitting light to a combination of two tools.

FIG. 68h shows the first combination of tools 6885h in the following order: source 6801; X-Y axis focal point arbitrator 6835; refracting dispersion apparatus 6840; convergence apparatus 6820. FIG. 68h shows the second combination of tools 6890h in the following order: Z-axis focal point arbitrator 6830; multi-focal convergence apparatus 6810.

FIG. 68i is similar to FIG. 68h; but reverses the order of the tools in the second combination 6890i.

FIG. 68j is like FIG. 68h, but shows the first combination of tools 6885j in the following order: source 6801; refracting dispersion apparatus 6840; X-Y axis focal point arbitrator 6835; convergence apparatus 6820.

FIG. 68k is similar to FIG. 68j; but reverses the order of the tools in the second combination 6890k.

FIG. 68l is like FIG. 68h, but shows the first combination of tools 68851 in the following order: source 6801; refracting dispersion apparatus 6840; convergence apparatus 6820; X-Y axis focal point arbitrator 6835.

FIG. 68m is similar to FIG. 681; but reverses the order of the tools in the second combination 6890m.

FIGS. 68s, 68t, 68v, 68x show a source 6801 transmitting light to a reflecting dispersion apparatus 6895, and two combinations of two tools.

FIG. 68s shows a source 6801 and a reflecting dispersion apparatus 6895. The first combination of two tools 6891s is in the following order: X-Y axis focal point arbitrator 6835, convergence apparatus 6820. The second combination of two tools 6892s is in the following order: Z-axis focal point arbitrator 6830, multi- focal convergence apparatus 6810.

FIG. 68t is like FIG. 68s, but reverses the order of the tools in the first combination of two tools 6891t.

FIG. 68v is like FIG. 68s, but reverses the order of the tools in the second combination of two tools 6892t.

FIG. 68x is like FIG. 68t, but all tools except the source 6801 are generalized to be located anywhere in (X, Y, Z) space.

FIG. 68y shows two combinations of tools generalized to any three dimensional space. The first combination of tools 6893y is in the following order: source 6801; dispersion apparatus 6850; convergence apparatus 6855; “θ” and/or “φ” arbitrators 6860. The second combination of tools 6894y is in the following order: “ζ” arbitrator(s) 6865; multi-focal convergence apparatus 6870; receiving apparatus 6875.

Common tools used in conjunction with the optical device may include computers, medical equipment, and receiving instrumentation. The uses of the optical device are not limited to application and additional instrumentation discussed herein.

A variety of methods can be used to decide and vary focal points in three-dimensional space. The first of these methods is the multiplicity of optical devices spanning the X-Y space. The second option is the multiplicity of sources spanning the X-Y space. When a parallel source enters a lens at an angle it converges to a point on a line drawn through the center of the lens from the source. So from a variety of source positions comes a variety of convergence points in X, Y, and Z. Thirdly, a mobile source can act as though it is coming from many different locations. Fourthly, the source can be dispersed 7305, through reflection or refraction, to a variety points on the X-Y plane 73 10. From their new location, they can be reflected or refracted back to the optical device, but each point from a different angle 7315. In order then, to isolate various X-Y points for convergence, an X-Y arbitrator 7320 can be used. Fifthly, in the stead of a stationary method of dispersing the source, such as a rotating reflector can serve to move a stationary source to seem as though it is coming from different locations in the X-Y plane. Sixthly, the converging apparatuses can be made to cause convergence of the light to points in three dimensions by destroying the -X-Y symmetry of the converging apparatuses. For such an apparatus, to create focal points in three dimensions, instead of a concentric pixeled LCD, a many pixeled LCD whose radial position might determine depth, but whose theta location would determine the -X-Y coordinate of the focal point, could be used. These focal points would have a much weaker convergence because they are not created using an equipotential ring but instead a series of equipotential points. Methods of creating points of convergence in three dimensions are not limited to those examples listed here.

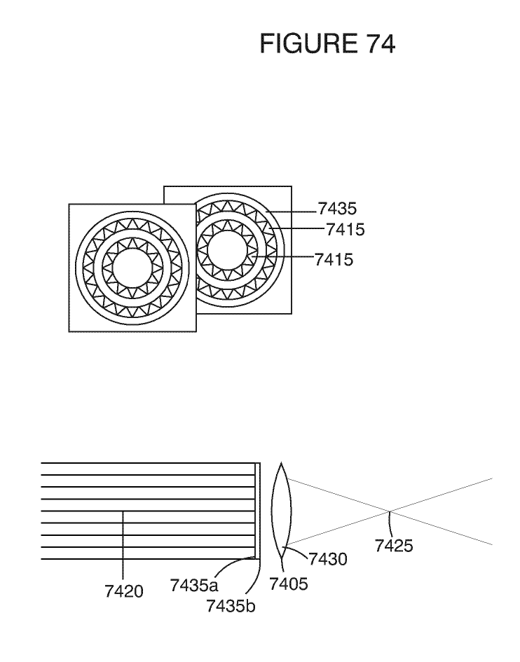

Various measures can be taken to help the optical device handle waves of higher or lower energies. FIG. 74 shows one such method. For high energy waves 7420 the converging apparatus (in this case, a multi-focal lens 7430) can be outfitted with small, closely spaced holes 7405. Additionally, for high energy waves the focal point arbitrators 7435 can be made with high-density materials or with superconducting materials 7410, 7415, among other things. An alternate way to move the focal point 7425 can be achieved through the lens itself. Increasing the temperature of a liquid lens causes an increase in the apparent density of the material. The more dense the material, the closer the focal point 7425 to the lens. An alternate way to block the radiation with high density liquid would be to heat rings of the liquid to increase the objects opacity, while cooling the object as a whole. The arbitrator would be designed thin enough such that when the rings are cool, they are semi-transparent to the radiation.

A magnetic field of varying strength can be used to cause and alter the convergence of charged particles. This can be as an alternative to high-energy radiation for such medical purposes as radiation therapy, allowing surgeons to converge with damaging intensity at the cancerous depth, preserving to a much greater degree all of the healthy cells.

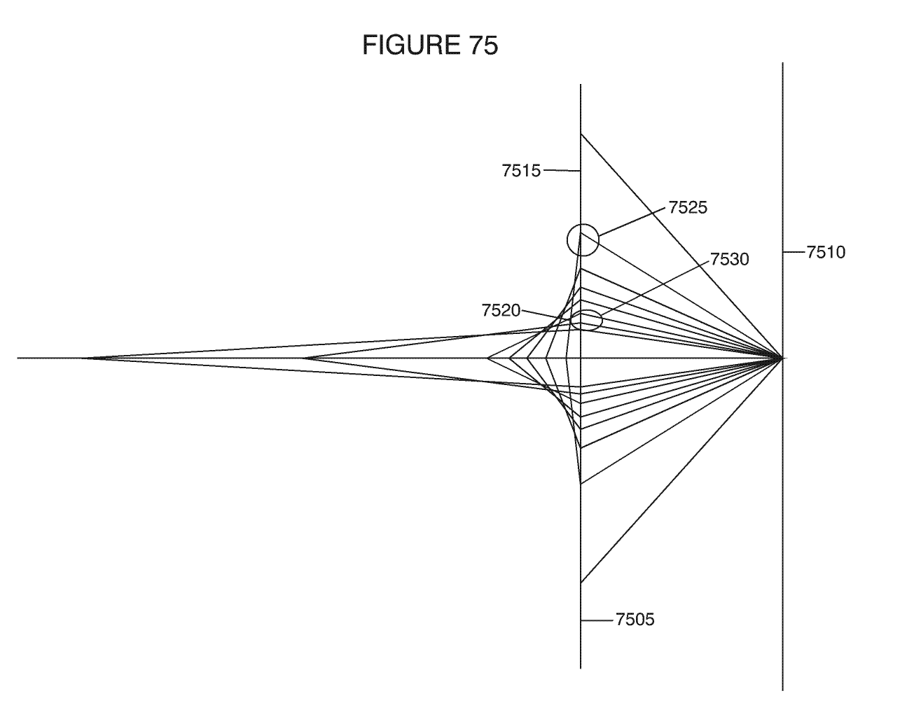

FIG. 75 shows that the multi-focal converging apparatuses 7505 can be used to converge sources from various depths to the same plane 7510, as if it were a camera lens that wouldn't need to focus because it can clearly record the near and the distant simultaneously.

Light from a near object has a high negative vergence 7515 meaning that the light between some segment A and B is going in a radically different direction if it is closer to A than if it were closer to B.

Light from a distant object has a low negative vergence 7520 meaning the light between some segment A and B is almost parallel.

When the light from the near object enters a multi-focal converging device, aspects of the device will cause the light to converge to different points so long as the convergence is the stronger factor. For example the divergence of the near object is −5 diopters (“−5Ds”) when it reaches a lens made out of many different vergences. The light that passes through the portion of the lens that is +6Ds will end up with a +1D vergence 7525. (A diopter “D” is a unit of measurement of the optical power of a lens or curved mirror, which is equal to the reciprocal of the focal length measured in meters (that is, 1/metres). For example, a 3 diopter lens brings parallel rays of light to focus at ⅓ meter. The same unit is also sometimes used for other reciprocals of distance, particularly the vergence of optical beams.)

The distant object, with, for example, a −1D vergence can enter the portion of that same lens that has a +2D vergence to also end up with a +1D 7530 vergence leaving the lens. This means the near and the distant object can converge to the same plane 7510 through the use of the appropriate multi-focal converging apparatus 7505.

This can be used for recording multi-dimensional information among other things.

FIG. 69 illustrates that to record in three dimensions preserving the dimensional information recording can be done using more than one camera 6905 6910 and subsequently subtracting the images from each other 6915. The recording can also be done with a single camera in more than one location followed by a subtraction of the images.

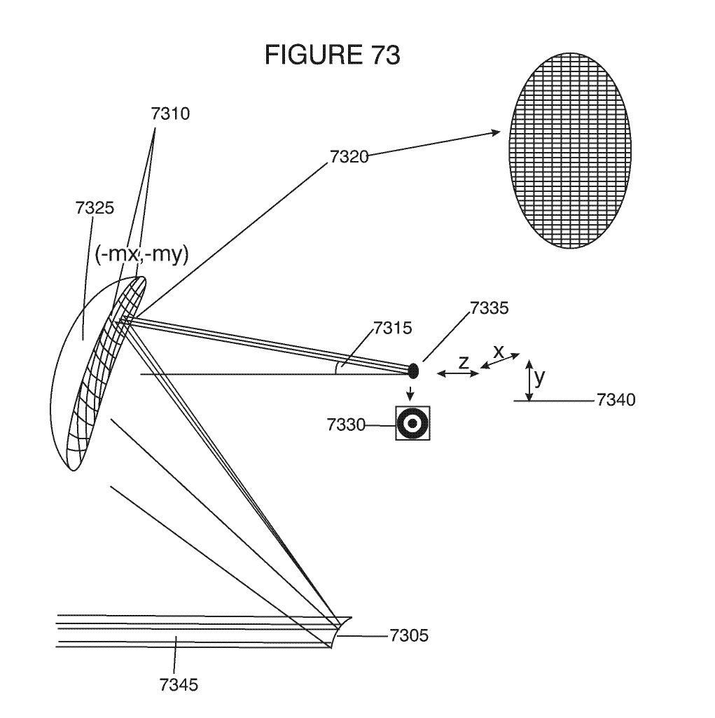

FIG. 73 demonstrates how the source can be reflected to enter the optical device from different angles to create convergence points throughout the -X-Y axis. A parallel source 7345 is dispersed, in the example by a convex mirror 7305. The dispersed source is reflected to a set 7310 of flat reflectors 7320 angled midway between the dispersed source and optical device 7335. These reflectors 7320 can be positioned simply by placing them on a large parabolic surface 7325 with the optical device 7335 as the focal point. The Reflectors 7320 can also be positioned any other way so long as they are angled to reflect the light into the optical device 7335 from various locations on the negative -X-Y plane. Each reflector 7320 can correlate to a pixel in the -X-Y plane. To isolate points in the -X-Y plane any number of isolating methods may be used. The angle of approach 7315 at which the source will enter the optical device results in various convergence locations in the X-Y plane.

An LCD layer 7330 is over the reflectors. When the LCD is black the source will be absorbed from that -X-Y location. When the LCD is clear, the source is free to reflect from that negative -X-Y pixel towards the optical device to be given a depth. Colored LCD's could be used to dictate color like a filter. At this current time using three lasers to control the color might be cheaper and simpler. The colored LCD's might offer more control and more motion picture continuity. Through using multiple lasers or a laser filter the ability to vary the intensity of the laser at each point might also be useful in surgical procedures.

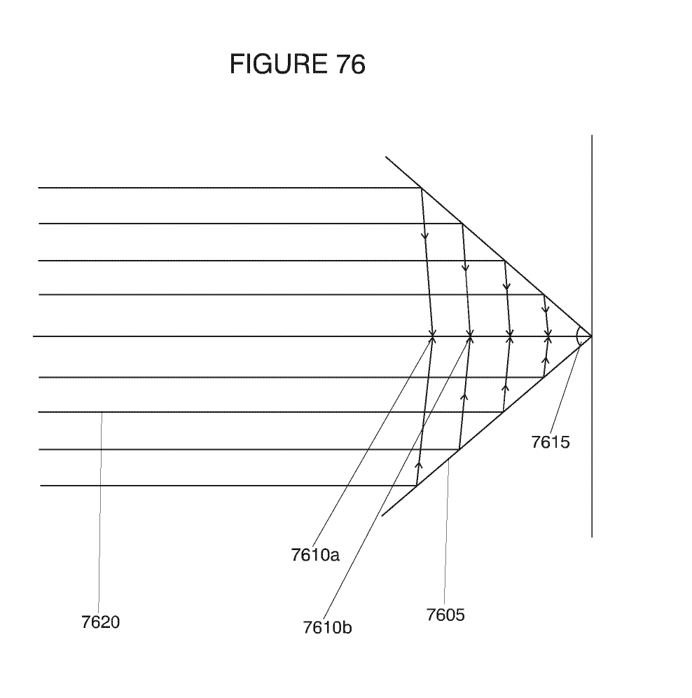

FIGS. 76-80 show other shapes that can cause multiple convergence points.

FIG. 76 shows a cone. Light 7620 is reflected off the cone 7605 to a series of focal points 7610a-b. The smaller the angle 7615 the nearer the focal points the smaller the spread in focal points 7610a-b.

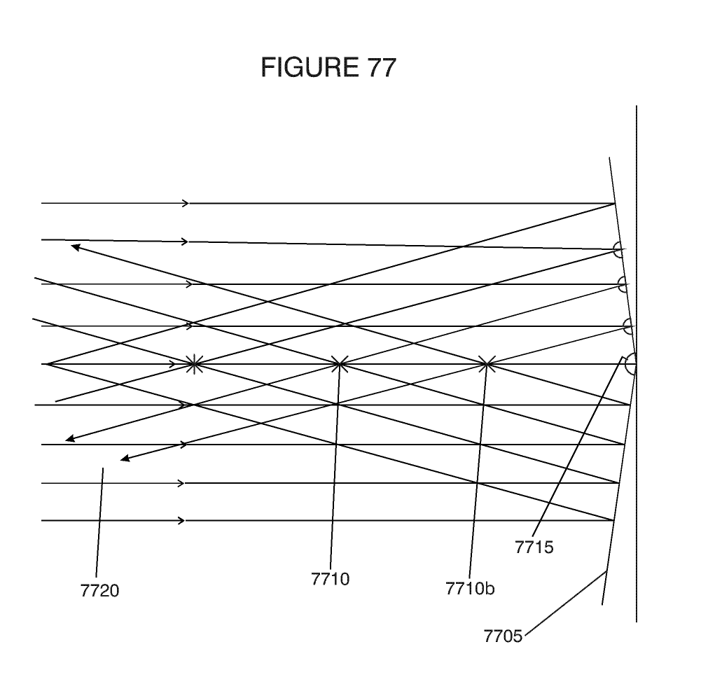

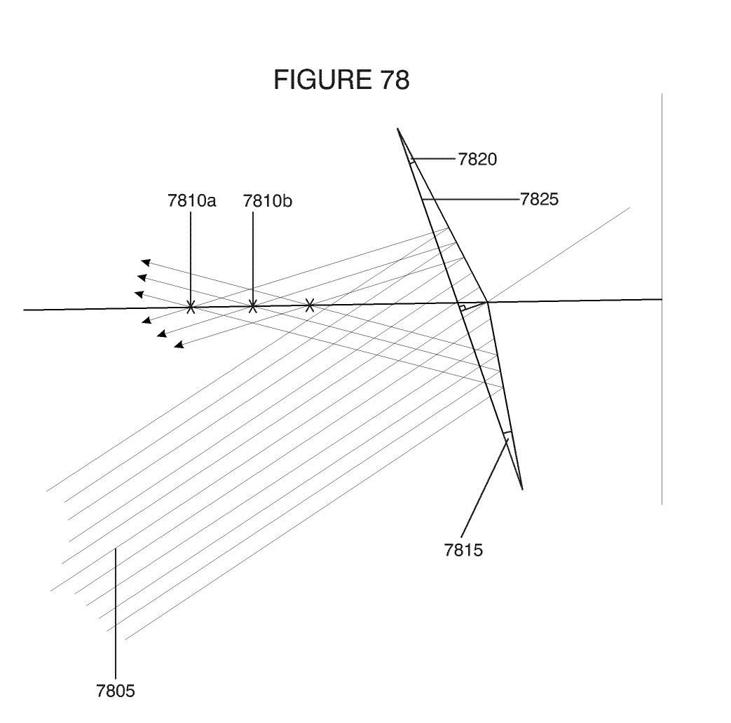

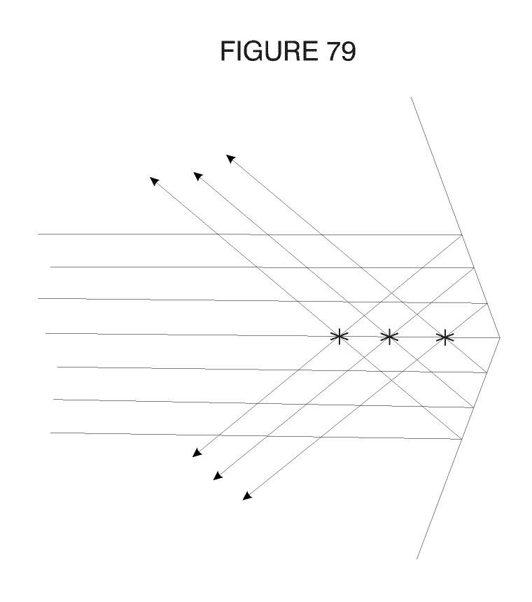

FIG. 77 shows how the focal points 7710a-b created by the reflected light 6720 move out when the cone 7705 is more opened. FIG. 78 shows how the cone 7815 is angled at theta m 7825 to reflect slant incoming light 7805, creating focal points 7810a-b. FIG. 79 is similar to 76 and 77. Reflection of light 7905 from a cone 7915 will produce a uniform distribution of the convergence points 7910a-b.

FIG. 80 shows a reflection from the inside of a convex closed funnel 8015. This produces the highest concentration of focal point possibilities 8010a, near to the device, and decreasing from it 8010b. All of these shapes 7605, 7705, 7815, 7915, 8015 are multi-focal reflective converging apparatuses.

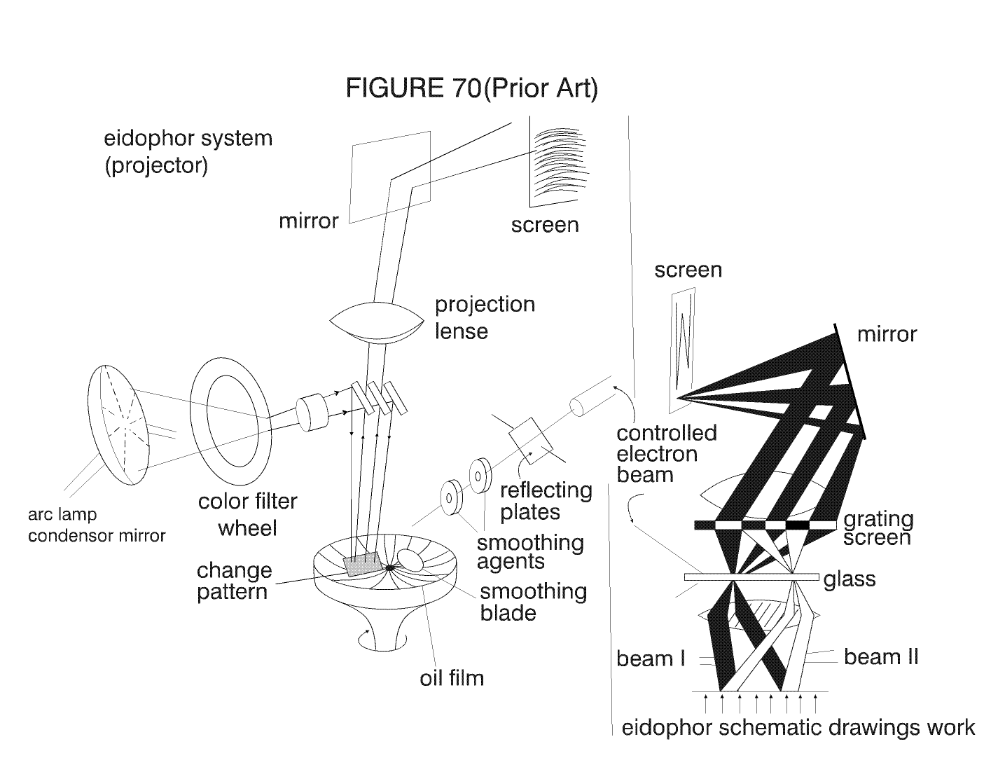

FIG. 70 illustrates prior art in the form of an Eidophor, a television projector used to create theatre-sized images. Its basic technology was the use of electrostatic charges to deform an oil surface. Eidophors used an optical system somewhat similar to a conventional movie projector but substituted a slowly- rotating mirrored disk or dish for the film. The disk was covered with a thick transparent oil and through the use of a scanned electron beam, electrostatic charges could be deposited onto the oil, causing the surface of the oil to deform. Light was shone on the disc via a striped mirror consisting of strips of reflective material alternated with transparent non-reflective areas. Areas of the oil unaffected by the electron beam would allow the light to be reflected directly back to the mirror and towards the light source, whereas light passing through deformed areas would be displaced and would pass through the adjacent transparent areas and onwards through the projection system. As the disk rotated, a doctor blade discharged and smoothed the ripples in the oil, readying it for re-use on another television frame. Simple Eidophors produced black-and-white images. More complex Eidophors produced sequential red, green, and blue fields, allowing the reproduction of a color image.

FIG. 72 shows an LCD 7205 being used to isolate convergence points 120. When the LCD 7205 is black the source is absorbed and cannot pass through to the converging apparatus. When an aspect of the LCD 7205 is clear that aspect of the source is free to pass through to the converging apparatus and converge to a particular depth or depths. While dividing the LCD 7205 into equipotential rings will allow for the strongest convergence from a single equipotential, the entire ring is not necessary to make a convergence, and hence the LCD 7205 can be broken into any number of shapes more suited to the product.

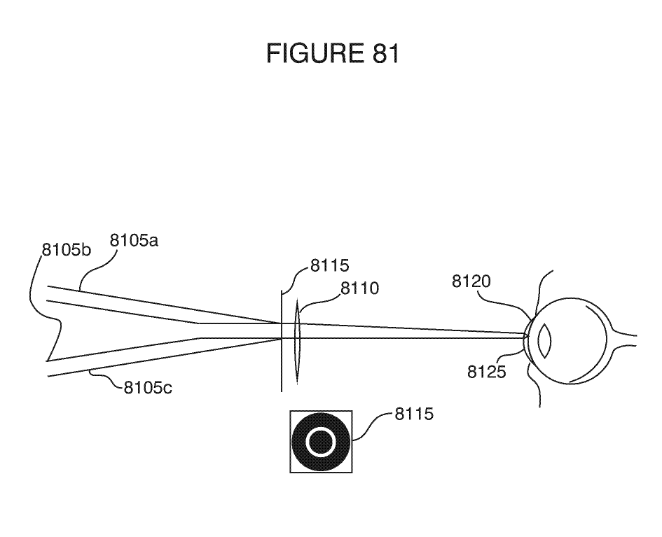

FIG. 81 illustrates an exemplary use of a controlled convergence laser apparatus as it might be used for refractive eye surgery. Various laser sources may be used in different embodiments, including infrared, visible, and UV lasers. UVA and visible light travel through the cornea 8120, but UVB, UVC and infrared light are absorbed by the cornea 8120, imparting energy through interaction. Completely absorbed frequencies have trouble traveling except at high intensities, short pulsations, or partial absorptions, but testing will show the best frequency for surgery. The lens 8110 material will be chosen to suit the ideal surgical frequency “v”.

Further, laser sources to be used with different embodiments may be continuous wave, Q-switched pulse, and mode-locked ultra short pulse lasers. The source v will be laser device dependent (pulse vs. continuous). Although not an exhaustive list, lasers of the foregoing type may be used in various embodiments.

In one embodiment, the convergence position 8125 is computed and controlled via software instructions preferably executable via a CPU. The software instructions may be contained on storage media such as CDs, hard drives, diskettes, or other electronic storage media devices. Additionally, the computer software (instruction sets) may be stored in ROM, RAM or other storage devices capable of computer storage instructions. The software program may be configured to provide various control of the convergence assembly. Based on this disclosure, other functions would be readily ascertainable to one of ordinary skill in the art.

In one embodiment, a controlled mobile laser source 8105 is used as a light source, but multiple lasers may also be used. A controlled LCD panel 8115 (similar to 7205) is used to isolate portions of the multi-focal apparatus, a rotated diamond lens 8110a with a small “α.” The multi-focal apparatus will direct the source towards the cornea 8120, which further converges the source to a convergence region 8125 inside the cornea 8120.

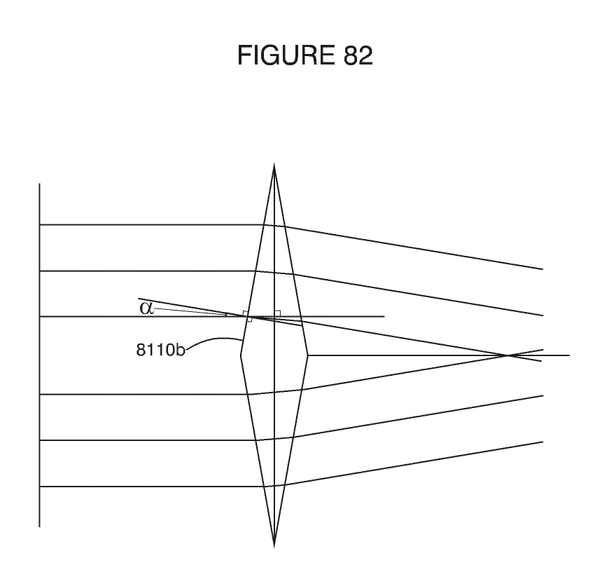

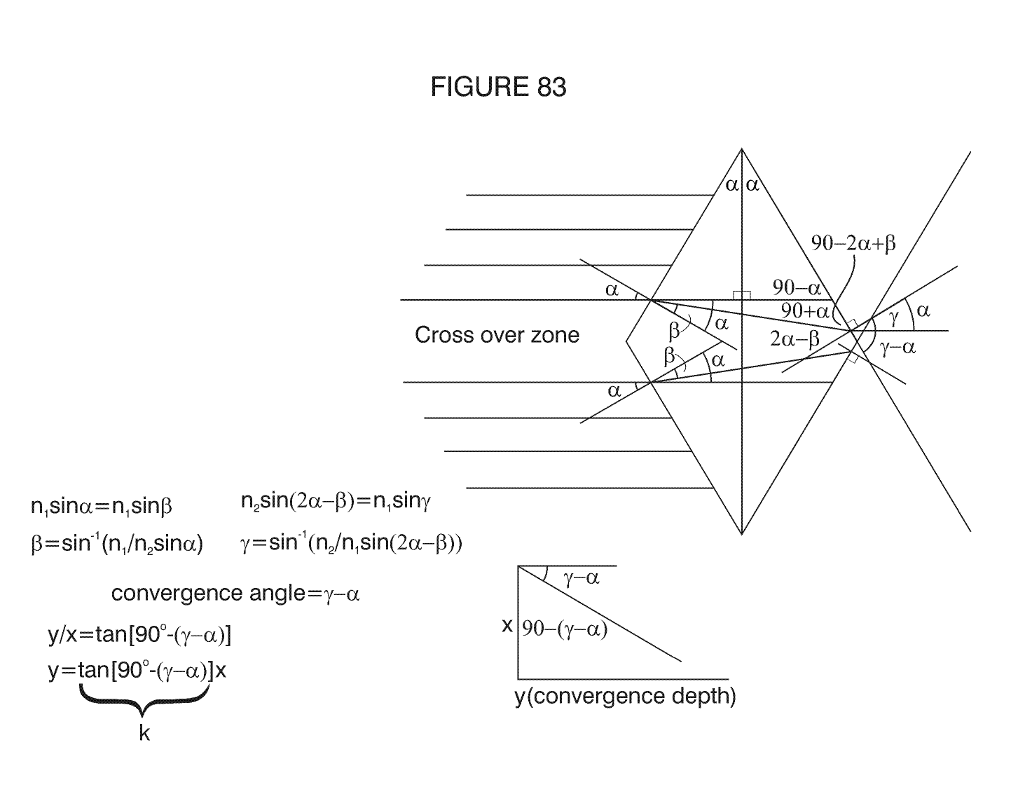

FIGS. 82-83 shows a more detailed view of the refraction that takes place in a rotated diamond lens 8110, 8210. A lens 8110 with a small a 8205 results in a long convergence range 8230. A lens 8310 with a large a 8305 results in a short convergence range 8330. Angles alpha 8205, 8305, beta 8320 and gamma 8325 are determined using Snell's law 8310 in combination with the materials specific index of refraction.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

What is claimed is:

1. An light converging apparatus as shown and described.
